(19) United States
(12) Patent Application Publication
(10) Pub. No.: US 2024/0361994 A1
(43) Pub. Date: Oct. 31, 2024

(54) System and Method for Real-Time, Dynamic Creation, Delivery, and Use of Customizable Web Applications

(71) Applicant: APPWARD LLC, Valencia, CA (US)

(72) Inventors: Dave Mason, Valencia, CA (US); Raffi D. Khorenian, Valencia, CA (US)

(21) Appl. No.: 18/766,943

(22) Filed: Jul. 9, 2024

Related U.S. Application Data
(63) Continuation of application No. 17/915,011, filed on Sep. 27, 2022.

(51) Int. Cl. G06F 8/34; G06F 8/30; G06F 8/60

(52) U.S. Cl. CPC G06F 8/34; G06F 8/315; G06F 8/60

(57) ABSTRACT

A computer-based system with a software platform that may provide organizations and users an ecosystem for real-time creation, manipulation, delivery, and use of server-side and client-side custom web applications utilizing a novel object-oriented system for configuration, storage, retrieval, rendering and continuous bi-directional communication of information between a web server (1000) and multiple web clients (1200). There may be a client-side system with a single page application with an architecture to communicate back and render multiple applications, multiple dynamic pages, all at the same time. All such apps, living under one platform, may be built in real-time using rapid customization tools such as design editors, a scripting engine (4300) utilizing a unique object-oriented system, and a secure sandbox containment and linking system.

### CROSS-REFERENCE TO RELATED APPLICATION

This application is a continuation of parent application U.S. Ser. No. 17/915,011 filed on Sep. 27, 2022, which is a national phase application under 35 U.S.C. § 371 of International Patent Application No. PCT/US2021/063909 filed on Dec. 16, 2021, which claims the benefit of U.S. Provisional Patent Application Ser. No. 63/131,271 filed Dec. 28, 2020, titled “SYSTEM AND METHOD FOR REAL-TIME AUTOMATED CREATION OF CUSTOMIZABLE WEB APPLICATIONS,” which national phase application and provisional patent application in their entireties are hereby incorporated by reference herein for all purposes.

### TECHNICAL FIELD

This invention relates to a system for dynamically creating, delivering, and using web applications in real time, its method of production, and its method of use.

### BACKGROUND

Every business today requires some level of software solutions to manage various operations of the business. Typical software solutions for businesses, however, typically fall short of covering all of the functionalities that a business may need, including the oftentimes differing needs of each division within an organization, and even the differing needs of individuals within an organization. To create a solution that may broadly cover the needs of an entire organization, its divisions, and the individuals within the organization, such a software solution would have to be customized and customizable. Even with a customized solution, however, it is challenging to meet all of the needs of an organization, and its people, when implementing software on a company- or even division-wide scale.

With that said, creating custom software for any business is cumbersome, requires significant investment, and requires skilled programmers to create and develop all of the functionality necessary for a complete solution. Additionally, each time any process changes within the organization, or a division thereof, it would require further customization to modify the software for such additional or modified processes. This can become a very expensive, challenging, and often unrealized goal.

Accordingly, there is a need for an enterprise software solution that is easily customizable, and that can be integrated at any level within the organization, even down to an individual within the organization. Organizations need the ability to create software solutions that meet the needs of individuals, teams, divisions, and companywide cross-divisional operations. Additionally, there is a need for customizable development of software, without the need for specialized programmers. There is also a need for such a customizable solution to execute and run in real-time so as to not cause stoppage in business processes. The invention described herein meets this need.

### DISCLOSURE OF INVENTION

The present invention is directed to a system and method that facilitates the dynamic, real-time creation, delivery, and use of web applications that may be created by any user regardless of technical education or background.

In some embodiments, the present invention may be a computer-based system, software platform as a service, or web application, that may provide users, clients, over the internet or on a local network, a web-based interface to create, manipulate, store all in real-time custom dynamic object-oriented applications, both client side and server side. These applications may all be rendered for usage, customizing, configuring, reporting, storing and retrieval all via a web browser. In some embodiments the present invention may comprise an object-oriented server platform that scales in real-time with building block objects, with their respective class definitions on-the-fly, without any need for interruption of service.

The delivery of these applications to web clients, including rendering of web pages, may be accomplished through an improved web server and client-side architecture framework. In some embodiments, the real-time customization and configuration of such applications and associated web Pages (Interfaces) may be accomplished through a set of four editors (OE, SE, CE). The storage and retrieval of said custom applications (that scale by anyone to cover new areas, business operations, topics, etc.) may be accomplished by integrating a unique database architecture that may not be exclusive to one database (“DB”) engine or one storage engine. Connectivity of different objects, group of objects, and applications may be accomplished by a with a unique data binding mechanism utilizing an intuitive path based on said object-oriented structure of the platform. Applications, and user workspaces within their respective organizations, may all be encapsulated by a unique sandbox mechanism that contains and secures said parent object structures within itself and may restrict outside navigation.

In some embodiments, sandboxes in turn may make said built applications, self-sufficient and possible to share with other individual workspaces, users, and organizations via linking mechanism. Users can login to the said platform, to their unique workspaces within their organizations, via a unique routing mechanism leveraging said sandboxes. Finally, said platform has a scripting language that can be used to write custom scripts at the client end, to further enrich said applications and organizations, which gets compiled and executed based on a scripting engine at the server-side. This scripting engine may use the platform's object-oriented structure and leverage the unique data binding mechanism to connect objects to each other, make changes within them, run various calculations, and send updates to target clients that triggered the execution of such scripts. Also, said scripts may be written within any object, at different containing properties of said object, or they may be standalone objects, like self-sufficient functions that get called from a variety of objects' events.

In some embodiments, the preferred embodiment of the invention features a dynamic, real-time, creation of custom web applications means operable in a computer readable medium with a server-side system interconnected with a client-side system and a database. The dynamic, real-time, creation of custom web applications means comprises: web server means in the server-side system for creation, storage, maintenance, and delivery of a structured hierarchy of at least one software object; customizable class means in the server-side system for definition of class properties, methods, and events of the at least one software object; object-identification and data binding means in the server-side system for identification of objects with absolute and relative path translations to platform objects; containment system means in the server-side system for grouping of structured children objects within a sandbox object; linking system means in the server-side system for copying of the sandbox objects as linked references; a scripting engine with parallel-processed business logic means in the server-side system interconnected with the object-identification and data binding means for manipulation and interaction with the software object properties; a multi-threaded processing system with configurable tasker objects in the server-side system for performance of time-interval and sequenced execution of the methods of the at least one software object; a routing system with router objects means in the server-side system for direction to a user-area sandbox; server-side and client-side communication system means in the client-side system for bi-directional transfer of the at least one software object between the web server and a client browser for dynamic rendering; rendering system means in the client-side system for dynamic rendering and re-rendering a persistent web page; configuration editor means interconnected with the persistent web page in the client-side system for performance of on-the-fly creation and modification of the at least one software object, the structured hierarchy, contents and features of the persistent web page, and the scripting engine means; and an object storage and retrieval system in the database system for loading of class definitions and the at least one software object.

In some embodiments, the preferred embodiment of the invention features a system for dynamic, real-time, creation of custom web applications. The system comprises a server-side system; a client-side system interconnected with the server-side system through a communication system that performs bi-directional transfers of one or more software objects between a server and a client browser; a web server in the server-side system for creation, storage, maintenance, and delivery of a structured hierarchy of at least one software object; a customizable class system in the server-side system configured to define class properties, methods, and events of the at least one software object; an object identification and data binding system configured to utilize a structured path to identify a software object through parent-child organization based on absolute and relative path translations; a containment system in the server-side system configured to group structured children objects within sandbox objects; a linking system in the server-side system configured to copy the sandbox objects as linked references; a scripting system in the server-side system configured to run parallel-processed business logic with the object identification and data binding system to manipulate the software object; a multi-threaded processing system configured to perform time-interval and sequence execution; a routing system in the server-side system configured utilize at least one router object to direct a user to a sandbox; and an object storage and retrieval system in the server-side system interconnected with a database.

### BRIEF DESCRIPTION OF DRAWINGS

FIG. 1 shows a web-based environment for creation, usage and storage of custom applications;

FIG. 2A shows an object-oriented base class model and their relationship;

FIG. 2B shows two base class models for class and class property instances;

FIG. 2C shows the three different class property instance types;

FIG. 2D shows a class editor with a class instance;

FIG. 2E shows a class editor with a class property instance of one type;

FIG. 2F shows class editor with a class property instance of another type;

FIG. 3A shows two base class models for object and object property instances;

FIG. 3B shows building blocks of an application comprised of object instances and a partial rendering view of its user interface;

FIG. 3C shows object instances within a hierarchical tree relative to its immediate sandbox;

FIG. 3D shows a linked sandbox shared within another user's sandbox workspace;

FIG. 3E shows paths used within an object instance for data binding;

FIG. 3F shows path syntax and data binding process flow;

FIG. 3G shows the different types of data binding using paths;

FIG. 3H shows details of an object editor user interface;

FIG. 3I shows a router mechanism for an object instance's dynamic calls to its respective shared class's business logics;

FIG. 3J shows the sync lock server-side mechanism for handling multithreaded multiclient connections accessing the same resources (object instances);

FIG. 4A shows an object property event type with its script in a script editor user interface;

FIG. 4B shows the scripting language syntax;

FIG. 4C shows a general scripting engine process flow;

FIG. 4D shows tasker structure and functionality;

FIG. 5A shows database communication structure and process;

FIG. 5B shows database tables and relationships;

FIG. 6A shows an SQL thread;

FIG. 6B shows a stored procedure;

FIG. 7 shows a list of stored procedures;

FIG. 8A shows client specific object property values;

FIG. 8B shows custom data from client specific object property values;

FIG. 8C shows subsequent custom data from client specific object property values;

FIG. 8D shows an SQL client only thread;

FIG. 9 shows an organization and routing structure;

FIG. 10A shows a webserver communication structure and components;

FIG. 10B shows a webserver data structure model;

FIG. 11A shows a webclient connection process;

FIG. 11B shows an RPC messaging lifecycle;

FIG. 11C shows commonly used remote procedure calls (RPCS);

FIG. 11D shows web socket protocol;

FIG. 11E shows by-directional communication through web socket;

FIG. 12A shows an initial client-side loading process;

FIG. 12B shows an https webserver loading initial files for client;

FIG. 12C shows client communication through web socket after an initial connection;

FIG. 12D shows mapping between a client user interface and associated server objects;

FIG. 12E shows a web client browser DOM configuration;

FIG. 12F shows javascript classes;

FIG. 13A shows RPC response sending data back to webclient;

FIG. 13B a shows client-side routing structure;

FIG. 14A shows base class definitions for fields within client side;

FIG. 15A shows a data model for screennormal or screenpopup UIS;

FIG. 15B shows sample screen data sent to client in JSON format;

FIG. 15C shows how objects may be rendered as interactive awpages and awui for clients;

FIG. 16A shows client-side data binding structures;

FIG. 16B shows a client-side data binding process;

FIG. 16C shows a client-side data binding user interface;

FIG. 17A shows a screen editor interface;

FIG. 17B shows a screen editor interface with icon selection; and

FIG. 18 shows a screen context menu.

### MODES FOR CARRYING OUT THE INVENTION

The detailed description set forth below in connection with the appended drawings is intended as a description of presently-preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

### The Overall System:

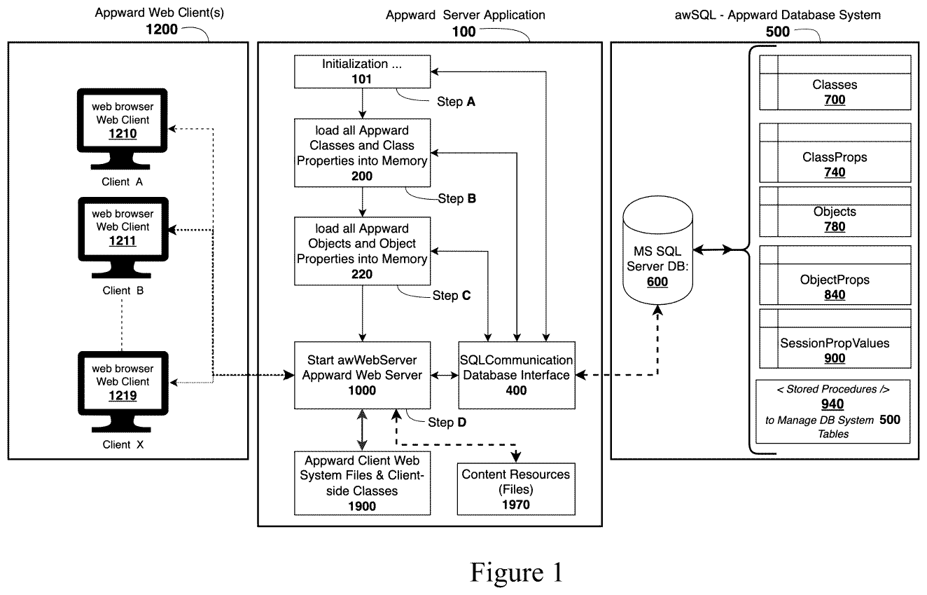

In some embodiments, the computer-based system, as shown in FIG. 1, may be a software platform as a service 100, providing multiple concurrent users or clients 1200, over the internet or on a local network, within a browser, a web-based user interface 1210, 1211, and 1219 to create, manipulate, and store, all in real-time, custom dynamic object-oriented applications, both client side and server side. These applications are all primarily rendered for usage, all within a web browser at Clients' terminals 1210, 1211, and 1219.

These said applications may be stored in a unique relational SQL Database structure 500, that stores all the object structures, and their class definitions, within certain set of tables 700, 740, 780, 840 and 900 to preserve everything that the Server System 100 needs to operate its configured custom applications using the object-oriented structure of the overall system with all its data connections and client communication features.

In some embodiments, upon launch of the main platform server 100, the system may go through an initialization process 101 to check an SQL database's 500 integrity by first using the 100 system's SQL communication object 400 that all subsequent communications between server 100 and its database system 500 may go through this said object 400. Once this first step (A) is completed successfully, it may move on to requesting (step B) all of the Class definitions as part of the launch process 200, with their respective properties, from the system Database 500. The server system 100 using one of the specific stored procedures 940 in the database system, may call to receive the necessary Class related records to instantiate all the Class definition objects in the server system 100 into run time memory. In some embodiments, after this step, in the sequence, comes the loading of all the Object instances 220 into run time memory, with their respective Object Property instances, to the Server 100 system. Consequently, next in sequence the Server 100 may utilize another specific stored procedure call 940 within the SQL Database 500 system that may retrieve all the Objects and respective Property records and may instantiate them within the Server 100 and in turn completing step (C) 220. After this, the Server system 100 is ready to spin off, at step D, within a new thread, a novel web server mechanism 1000 that will allow multiple concurrent external Web Clients 1200 to connect to components within the Server 100 via this said WebServer 1000. The Classes and Objects that were instantiated, through steps 200 and 220 respectively, may be a foundational element of the object-oriented hierarchical structure that all of the system platform 100 uses to create, manipulate, store, and serve to Web Clients 1210, 1211 and 1219, through said webserver 1000, in order to be used as custom rich applications, inside workspaces and organizations for web clients. Once the web server 1000 is active and listening to any incoming Web Client connection 1200, the entire Server 100 launch process may be complete and the system 100 may be ready to operate fully to meet all of the above features mentioned in this invention.

As seen in FIG. 1 there may be three major system components that make up this new computer system platform to operate in a unique way that has improvements to others in the market. In some embodiments, these three system components may be: (1) the server system 100 with all of its internal components, including Objects and their respective Class definitions, and a unique multi-client, multi-threaded, Web Server 1000; (2) the client side application with its unique delivery and bi-directional communication methods and many other editors and tools in its framework to empower Web Clients 1200 to make necessary on-the-fly changes to their applications or, as importantly, operate the applications they need for their day-to-day businesses to run in an efficient manner; and (3) a Database 500 System that may work tightly with the Server 100 system to store all Object changes, creations, deletions pertaining to applications and user customs settings, immediately and synchronously.

### Breakdown of Classes:

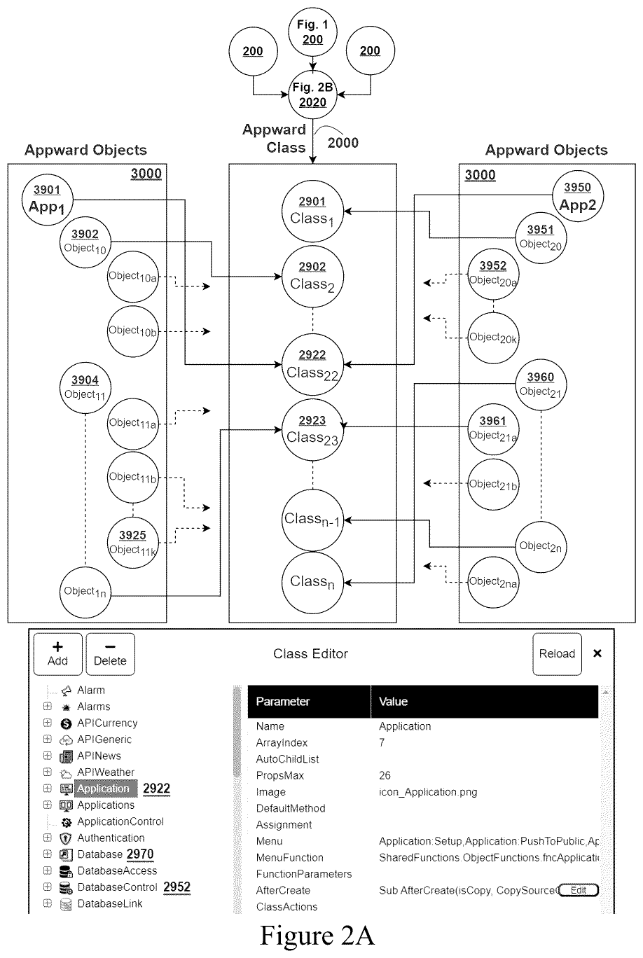

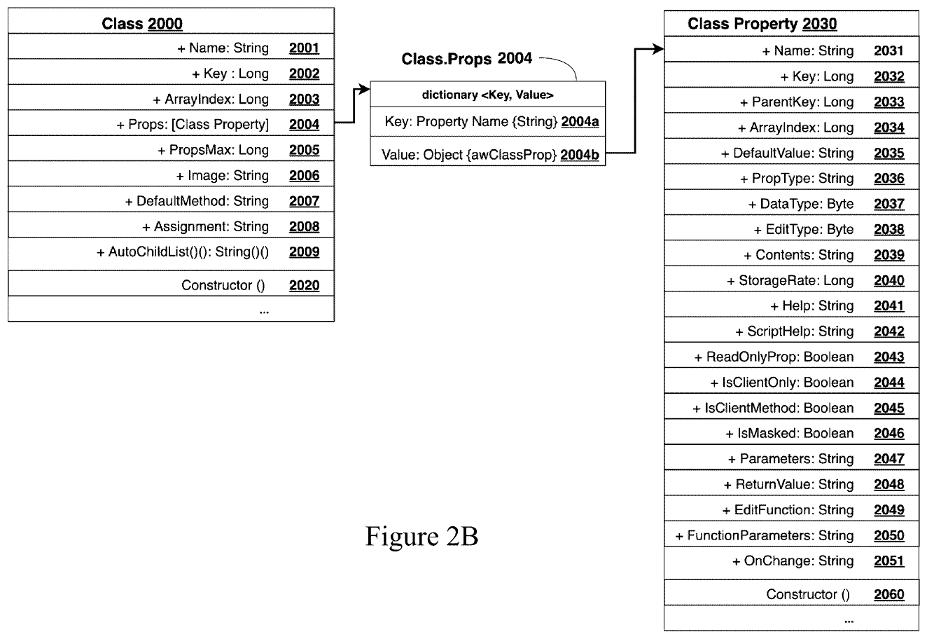

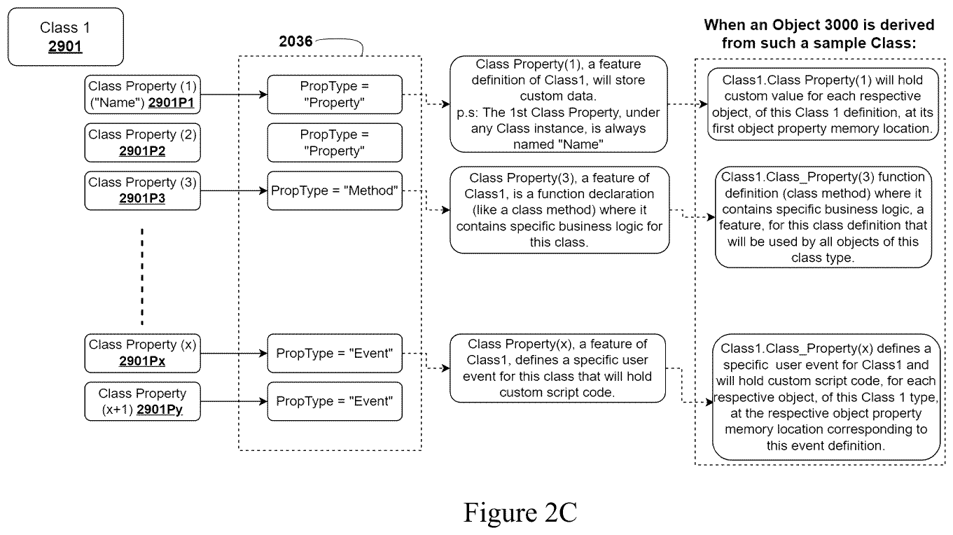

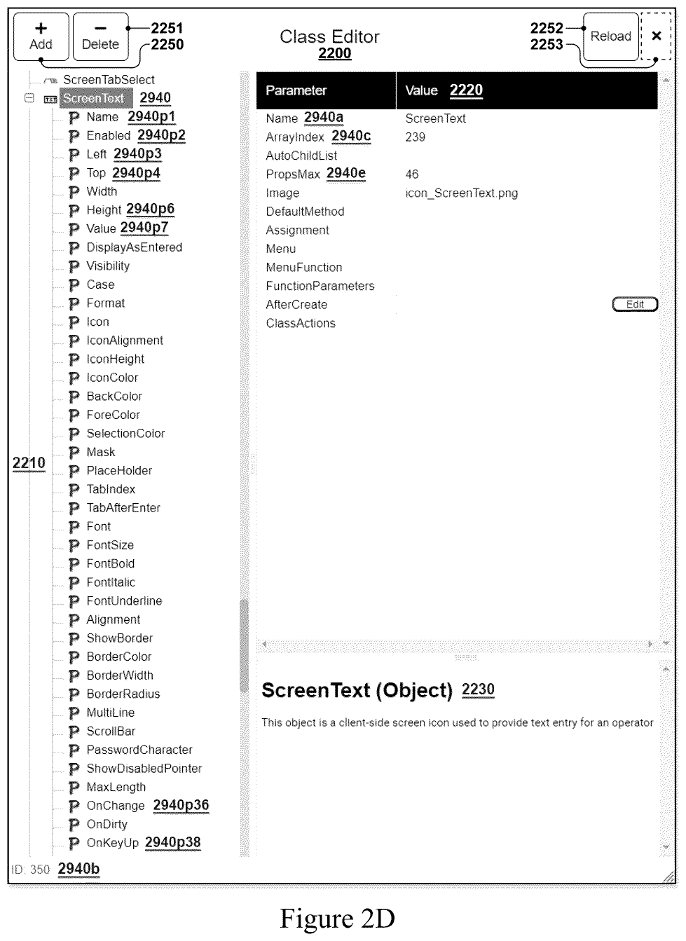

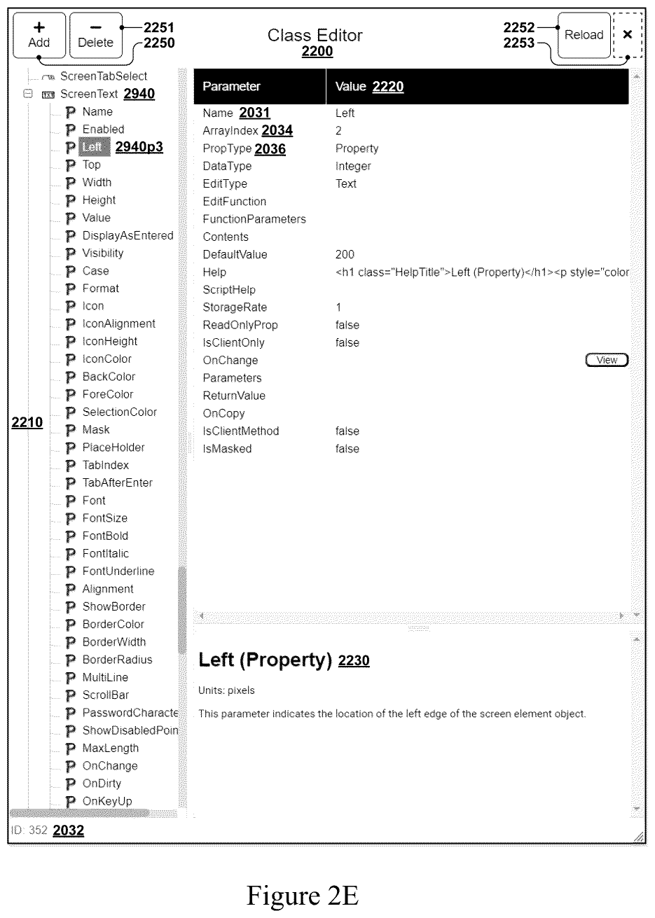

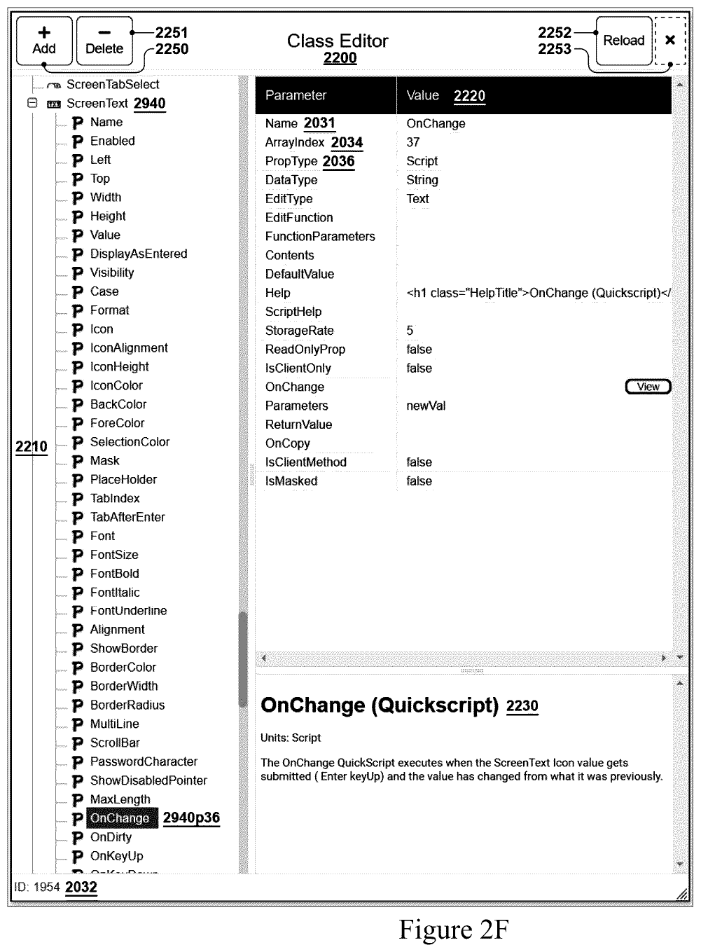

Referring to FIG. 2A, which displays, in some embodiments, how each application may be made up of a different number of object-oriented, parent-child, hierarchical Object 3000 instances each configured in a unique way to meet a unique purpose and need. Each of these Object 3000 instances in turn may be defined by each referencing a specific type of runtime Class object 2000 instance definition (example from FIG. 2A, App1 Object 3901 references Class 2922 so does App2 3950 because they are of the same class type. Other Objects 3902 and 3951 are referencing other types of Classes, 2922 and 2901 respectively). All Object 3000 instances, including ‘Application’ Objects 3901 and 3950, get their characteristic features, styling and logic from their respective Class 2000 instance objects' references. Any Object 3000 instance referencing said Class 2000 instance gives that Object access to that respective Class's business logic and characteristics via an underlying routing mechanism within Server 100 system that will be covered in subsequent sections. But here, we'll get into the details of Appward's Server system 100 Class 2000 design and architecture with all of its internal components and respective dependencies. Appward's Class 2000 instances are created, called to be instantiated, in more than one route. One was already mentioned above and that's during the Server's 100 system initial launch process, specifically at 200 (FIG. 1 step B). Actually, that's where the majority of Class 2000 instances are loaded into Server 100 memory, ready to be used by any Object 3000 instance, and in turn by any application at the Server 100 side or client side 1200.

These Class 2000 instances, in some embodiments, are the foundation that allows real-time independent and customizable classes to be used together, indirectly and on the fly, to serve a higher purpose within a user's ecosystem or within any one of the said custom applications. These Appward Classes, each containing its own unique business logic and user interface (for client-side classes), create a scalable set of smart modules accumulating to an overall rich environment for users and their application systems to be used efficiently and intuitively. This is possible because all Appward runtime Classes are instances, 2901 2902 2922 and 2933 as few examples from FIG. 2A, from the same template class 2000. See FIG. 2B for the base template class 2000 data model. The reason this model is flexible and scalable is because of the following features, comprising: 1) Base template Class 2000 gives the capability for each instance to have a unique Key 2002 and a unique Name 2001 in the entire Server system 100 to be identified directly and without any confusion by any other Object 3000 insta2Cnce that wants to use any such Class 2000 instance; 2) Base template Class 2000 has a dictionary (Key-Value list) called Props 2004 that holds instances of a group of Class Property 2030 class base type instances. In some embodiments, all Class Property 2030 instances always belong to some Class 2000 instance, meaning all Class Property 2030 instances are always contained under a Class 2000 instance, within said Props dictionary 2004. To understand better how each Class 2000 instance is unique not only in the server 100 in memory and location, but by its characteristics and its features, this brings the need to show the details of this (second) base template Class Property 2030 data model and what's unique about it. Note that these two base classes are defined within .NET framework, using Visual Basic language.

In some embodiments, as seen in FIG. 2B, each instance of template Class Property 2030 class has: 1) a Name 2031 to give it a semantic meaning within its parent Class 2000 instance context, 2) a unique Key 2032 to directly identify it within the entire Server 100 system, 3) a Parent Key 2033 to be able to know directly who is the parent Class 2000 instance of any Class Property 2030 instance, 4) and an index 2034 field to know the sorting order, and location, of any particular Class Property 2030 instance within a set of other Class Property 2030 instances belonging to the same parent Class 2000 instance contained under the said Props 2004 dictionary (Props 2004 is a Key-Value Ordered dictionary). The ordering within any Class 2000 Props' is indexed using the “ArrayIndex” field 2034, which are fields given from each of the contained Class Property 2030 instances within said Class Props 2004. The Key 2004a for each Props 2004 dictionary is a string data value that comes from Class Property 2030 Name field 2031. This allows the Class Property instances, under any Class 2000 instance, to be found either by Name or by index number, which makes it very flexible when it comes to Appward's Scripting engine, Client-side routing mechanism and more (to be covered in subsequent sections). Also seen in FIG. 2B that every Class 2000 instance can have a different number of Class Property 2030 instances under its Props 2004 dictionary field. This gives each Class 2000 instance to have different number of Properties, Class Property 2030 instances, in run time for maximum flexibility. This is a necessity because any new Class 2000 creation, or updating existing ones, should not be fixed (limited) in features or characteristics. This is yet another important reason where each Class 2000 instance is and looks unique in the entire Server 100 system. See FIG. 2A on few examples of different Class 2000 instances built and identified uniquely for different purposes. To clarify and expand on this idea further, there is one more very important field under Class Property 2030 that needs to be discussed: In some embodiments, the “PropType” 2036 field, from FIG. 2B. This field, for example, defines the property type of each Class Property 2030 instance under any Class 2000 instance. Borrowed from classical API terminology, a property type is the type of field for that class API. In Appward, every Class Property 2030 instance, can only be one of three types: 1) “Property”, 2) “Method”, or 3) “Event”.

See FIG. 2C for further details on the “PropType” 2036 fields of the Class Property 2030 class. The purpose of defining each Class Property type, via “PropType” field, in general, is to give at least one new feature to a specific Appward Class 2000 instance. In some embodiments, this new feature falls under one of three categories: 1) holding data for “Property” types, or 2) running specific shared (STATIC function) business logic for its Parent Class (“Method” type). These “Method” Class Property 2030 instance types are an indication that the respective Class 2000 instance has a STATIC function (syntax in JavaScript for Client-Side Class definitions), or SHARED function (syntax in Visual Basic .NET for 100 Server side Class definitions) that can be accessed and dynamically called by any Object 3000 instance referencing said Class Property 2030, via its Parent Class 2000, as it will be shown in subsequent sections, or 3) triggering an end-user event (“Event” type) that can execute a custom run-time code defined by end-users in general, and more specifically by application developers. This said 2036 field definition, which in itself defines the type of any Class Property 2030 instance, makes a huge difference in categorizing how a prospective Appward Class Property is going to be programmed to function, to style, to behave, and to give characteristic(s), in specific way(s), within any given Class 2000 instance definition due to its respective hardcoded business logic (VB.NET on the Server side or JavaScript on the Client side).

In some embodiments, to access, create or change any Class 2000 instances, with any of its respective Class Property 2030 instances, the platform serves a specific user interface (UI), a system-based UI as part of the client-side system, to its Web Clients 1200, called Class Editor 2200, see FIG. 2D. Using a Class Editor 2200, any Class 2000 and Class Property 2030 instance can be added or deleted from the Editor menu, 2250 and 2251, respectively. The Editor may display a tree section 2210, that shows all of the Class 2000 instances within any give server 100 platform. In FIG. 2D “ScreenText” 2940 is shown as a Class 2000 instance example. This 2940 Class would be a node in the tree that is comprised of Class Property 2030 children instances (44 in total based on Class 2000 instance's PropMax 2005 field), shown in this tree, for example, as 2940p1 2940p2 2940p3 to 2940p38. As mentioned before every Class 2000 instance has a unique Name and Key for direct and immediate identification in the entire server 100 platform system. And in “ScreenText” Class's case, “Name” 2001 value is “ScreenText” 2940a and the Class 2000 instance Key 2002 is 350 (2940b). Since “ScreenText” is a client-side Class 2000 instance, as its help text in 2230 describes, its business logic is fully written in JavaScript within the client-side system application (much more about this later). To illustrate, see FIG. 2E where the “Left” 2940p3 Class Property 2030 instance is shown in the Class Editor 2200 tree 2210 and it's the third property of this 2940 Class (Class Property field, zero based, “ArrayIndex” 2034 is 2) and its Name field 2031 in this instance, for example, may be “Left” for obvious semantic reasons. But more than that, in some embodiments, this Class Property defines, stores and sets the left position of any Textbox HTML element once it is rendered base off an Object 3000 instance of Class type “ScreenText” 2940. This is because, as shown in FIG. 2E, the “Left” 2940p3 Class Property 2030 instance has a “PropType” 2036 value of “Property” which enables is to store data, in this case HTML left styling pixel integer position value. FIG. 2F shows an embodiment of a Class Property 2030 instance 2940p36 that's named “OnChange” and that's because its “PropType” 2036 field is a “Script” (aka “Event”) that makes it an Event type for end-users to write, if they needed to, custom scripts in any Object 3000 instance of Class instance type “ScreenText” for a variety of custom reasons. “OnChange” script fires when a user changing, by data entry, the value within a displayed screen textbox at any given web client. In some embodiments, it is up to the users, and developers, within their applications on how to define each Object 3000 instance of Class instance of “ScreenText” 2940 type within any given application UI. The platform enables this flexibility for all the different Class Property 2030 instances of Class 2000 instance ScreenText 2940 to be configured differently at any associated Object 3000 instance referencing (more details on this later) this type of Class 2000 instance. These two Class Property instance examples, 2940p3 and 2940p36, may be a small subset of Class instance 2940 “ScreenText” and 2940 Class instance may be only ONE example of the many independent Class 2000 instances within the Server 100 already has and can have in the future.

In some embodiments, Appward's ability to define new Classes or change existing ones, in real-time, gives users ultimate flexibility within the platform to scale and be able to serve each user's ecosystem uniquely and in a personalized custom way. This is in significant contrast with mainstream software applications and existing platforms out there where class definitions are hardcoded and are not open for end users to make custom changes of their own.

In some embodiments, this real-time customization of Class 2000 instances and Class Property 2030 instances is one of the main founding principles of Appward ecosystem to empower personal customization starting from Classes and onwards (more on this below). And what's interesting about this reality is that all these Class 2000 instances, with their unique functionalities styling and behaviors, all emanate from the same base template Class 2000 and Class Property 2030. This gives the Platform efficiency advantages, scaling advantages in consistently leveraging any system-wide (Server 100 or client-side 1200) new mechanisms or upgrades to existing ones to be accessible and applicable to and all such custom, independent, Class 2000 instances. Rapidly, dynamically, and consistently scaling any Platform is a huge advantage, and with such base template class designs, 2000 and 2030, Appward is able to achieve that on creating or updating independent custom new Class instances, ready to be utilized on-the-fly by any applications and users in their respective workspaces and organization environments. We will cover in the next sections how this is true as we unpack the systems that enable the building block Object 3000 instances, referencing said Class 2000 instances, into configuring larger applications, which are served and interacted with via a Webserver 1000 to Web Clients 1200 all work together in a flexible way at any scale.

### Breakdown of the Objects

As mentioned in the Overview section, in some embodiments, Appward may be a new web-based platform that empowers customers, end-users, and citizen developers to use, build, and share their custom apps within public or private environments. These Apps can vary from simple to complex, from backend to frontend, or any combination there off, are all built in real-time by putting together highly configurable custom, building blocks, Object 3000 instances. The Appward environment, with all its apps, is there to serve customers with their specific needs wherever they are and in whatever field or industry. So, it is paramount to discuss the foundational basis on how these apps come about and that is through the detailed exposition of the Appward Object 3000 and its respective created instances, which we have mentioned so far only in general.

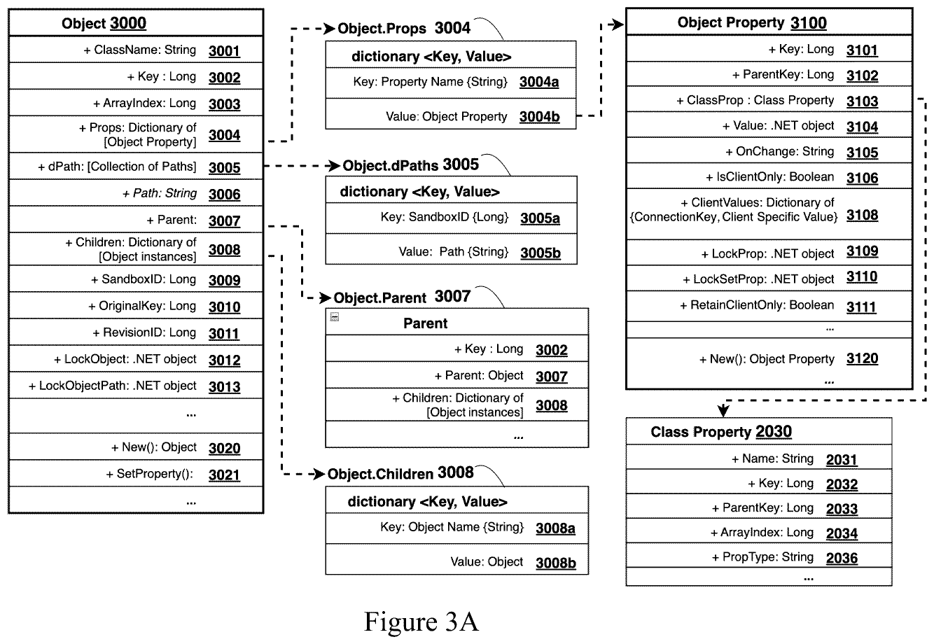

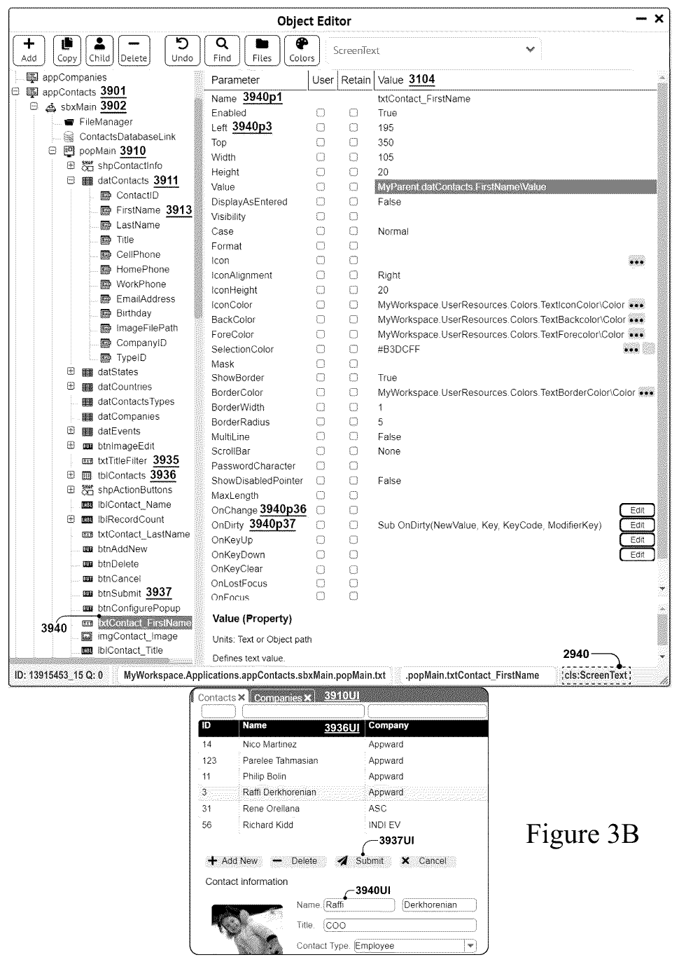

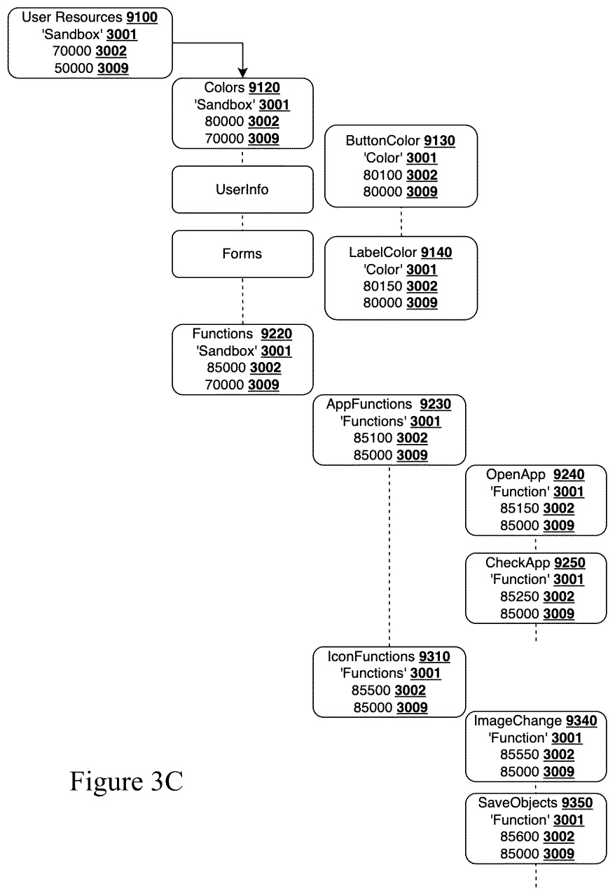

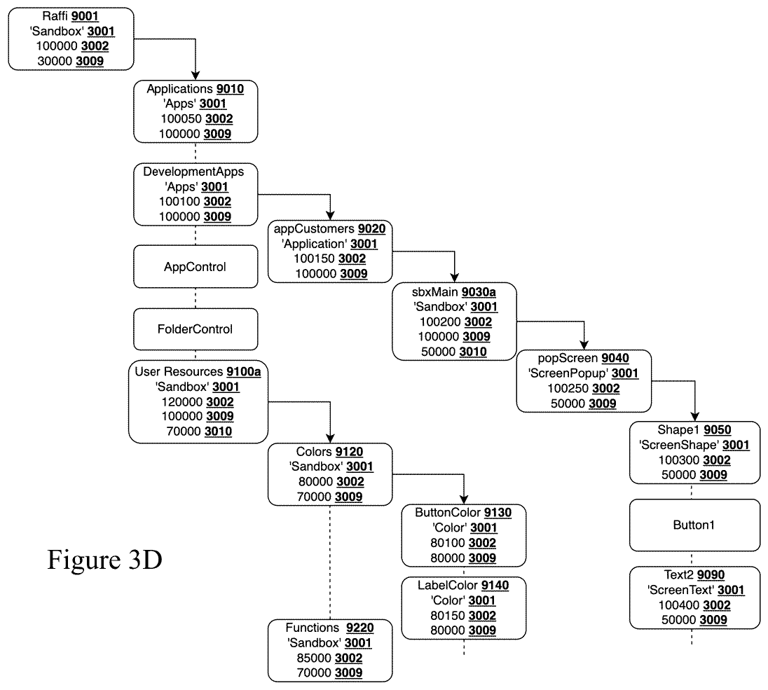

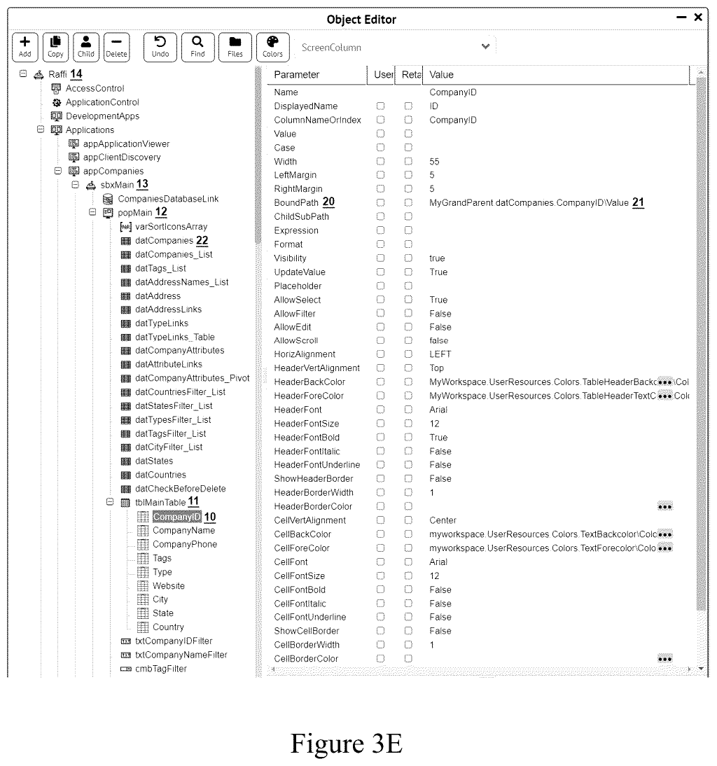

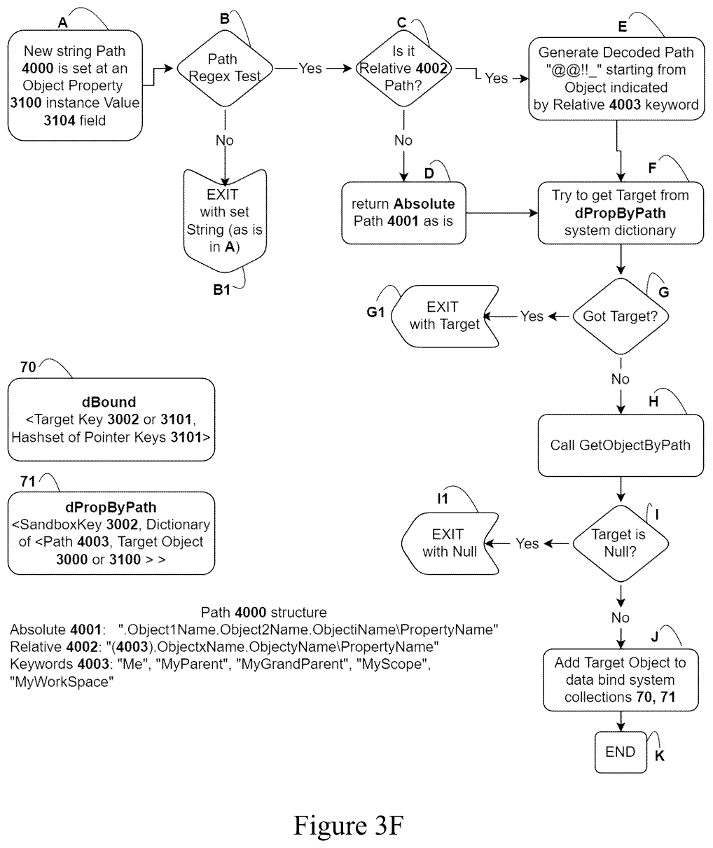

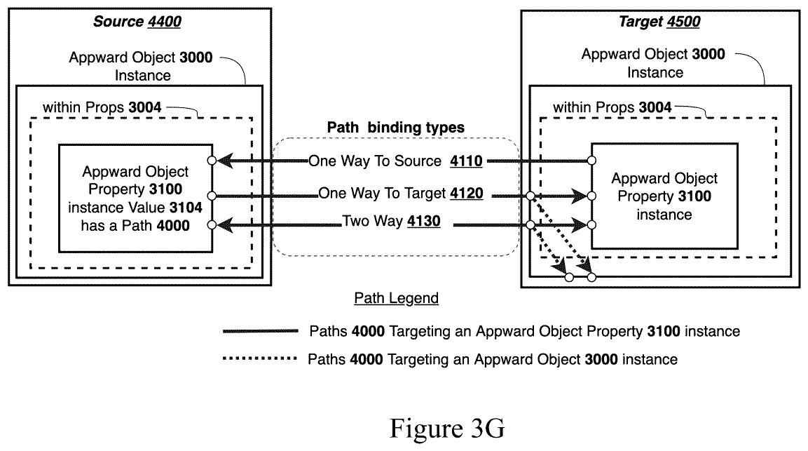

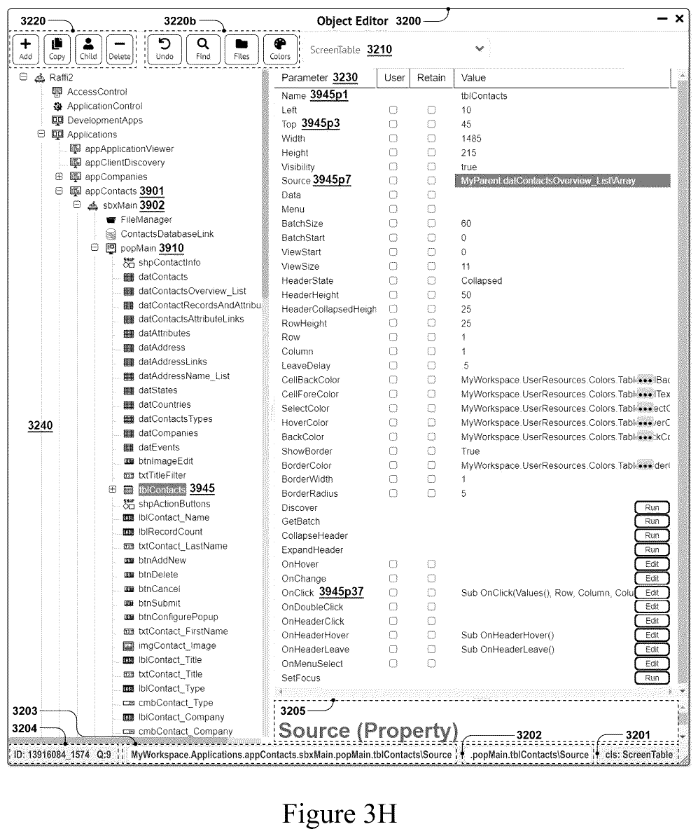

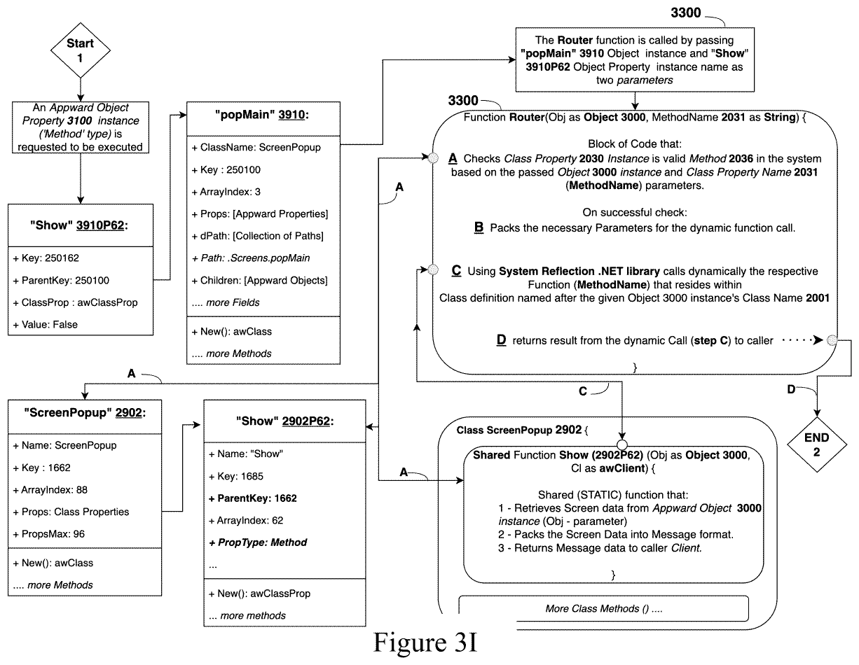

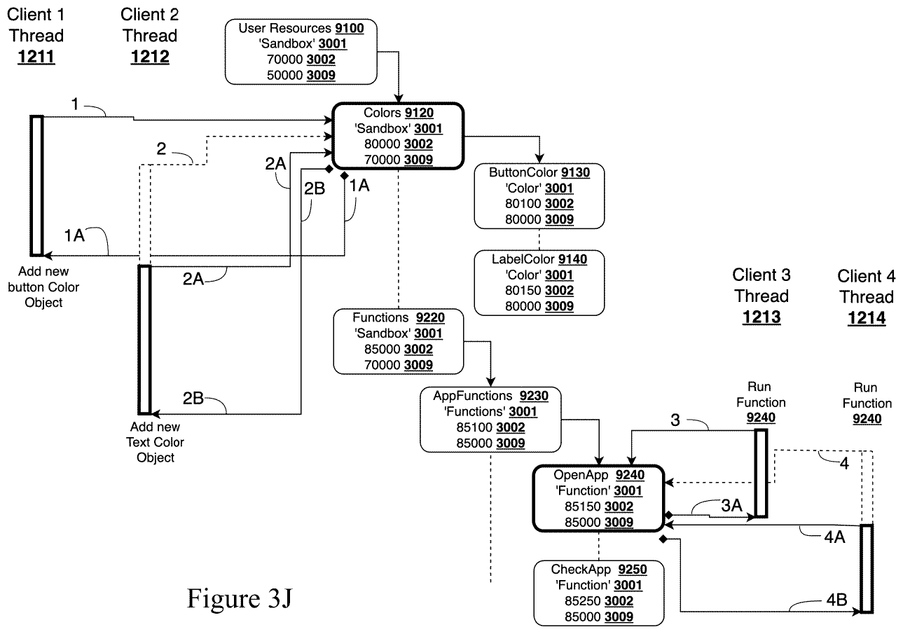

In some embodiments, for example, in FIG. 3A both data models for Object 3000 and Object Property 3100 classes are shown. These two base classes are defined within .NET framework, using Visual Basic language. And from these two base template classes all Appward Object 3000 instances are created to support, as it will be shown further below, all the high-level smarts, functionalities, stylings, and personalized applications built for end-users to experience within a web client 1200 environment. Just like every Class 2000 instance, all Object 3000 and Object Property 3100 instances may be uniquely identified by a unique Key (3002 within Object 3000 and 3101 within Object Properties 3100) in the entire server 100 and client 1200 systems. This Key, a Primary Key, is loaded initially from SQL Database (500) Objects (780) and ObjectProps (840) Tables, see step C in FIG. 1.

The relationship between Object Property 3100 instances and an Object 3000 instance is very similar to a Class 2000 instance and its Class Property 2030 instances. In fact, the number of Object Property 3100 instances contained, within any Object Props 3004 field dictionary instance, may be exactly the same as the number of Class Property 2030 instances contained under the respective Class 2000 instance that any particular Object 3000 instance may be referencing, via its ClassName 3001 field of that Object 3000 instance. In some embodiments, every Object 3000 instance may be reference one and only one Class 2000 instance. Similarly, every Object Property 3100 instance can reference one and only one Class Property 2030 instance. For example, an Object 3000 instance, 3940 in FIG. 3B, of class name (3001 field) “ScreenText” will contain 44 Object Property 3100 instances. As a “ScreenText” Object 3000 instance, for example, may be created, 3940 in FIG. 3B, it will instantiate all its respective Object Property 3100 instances in the order of their respective Class Property 2030 instances, 3940p1 then 3940p2 then 3940p3 till 3940p44 as it is ordered similarly in FIG. 2D and store them in the “Props” dictionary (3004) of the said Object 3000 instance 3940 for direct and immediate access. As each Object Property 3100 instance is being created its “ClassProp” 3103 field will point and reference to a respective Class Property 2030 instance in the same order of the Class Properties that are within the “Props” dictionary 2004 under the said Class 2000 instance 2940. These references between any Object instance, with its set of Object Property instances, and their Class and Class Property instances, respectively, is the foundation of how all Objects (3000) in Appward get their smarts, characteristics and stylings.

In some embodiments, as it will be shown further below, through these Class, and Class Property, instance references, all Objects get to access the various types of business logics that are contained and defined within these Class instances as mentioned before. Moreover, each Object Property 3100 instance, will inherit, through this said referencing, the types (Class Property “PropType” 2036) of its respective Class Property 2030 instance. This means that any Object 3000 instance, in some embodiments, may have any combination of only three types of Object Property 3100 instances: 1) one or more “Property” types that hold independent and custom data for that particular Object instance, 2) one or more “Methods” that can access the respective Class 2000 instance's business logic(s), 3) One or more “Events” that are defined within that referenced Class 2000 instance. Any Object Property instance of “Event” type may or may not hold a custom script (See Appward's scripting language and engine sections downstream), which will be executed when the trigger, defined by that Class Instance, occurs within the Platform (Server 100 side or at the client side 1200).

Based on the above description, in some embodiments, it may be shown that each and every Object 3000 instance, in the server 100 system, may be an independent object a) that may, for example, hold its own unique and custom data values (within its Object Property 3100 instances' Value fields 3104 when its PropType 2036 field is “Property”) that defines itself meaningfully based on the application or purpose it is serving, b) gets it characteristic functionalities, stylings and smarts by having access to its respective Class 2000 instance's business logic (in .NET framework and in JavaScript framework—more on this dynamic routing access further below), and is comprised of c) a set of defined events, when scripted, will execute said scripts, in said events, when the exact event triggers occur from the users, or the systems, that are interacting with said Object 3000 instance. All scripts may be, for example, stored within their respective Object Property 3100 instances Value 3104 fields.

In some embodiments, this described Object 3000 instance may be the building block in Appward for all workspaces and applications. But how do these building blocks inter, and intra, connect with each other in building in turn something bigger than just themselves? That's why it is important to also cover the following five topics that Object 3000 instances are comprised of: 1) All Object 3000 instances may be hierarchical in nature residing within a tree-like hierarchy, 2) all Object 3000 instances are contained within a Sandbox that defines the scope of its children, which in itself is a special Object 3000 instance referencing a Class 2000 instance named Sandbox, 3) Every Object 3000 instance can have each of its Object Property 3100 instances contain custom Values 3104 that are unique to each Client 1200 that is using them. These different versions of the Object Property 3100 Value 3104 are all maintained in the Object Property 3100 instance's “ClientValues” 3107 collection. This ultimately provides the functionality for each Client 1200 to be able to customize Object Property 3100 instance Values 3104 for themselves without affecting the Value 3104 that other Clients 1200 see and interact with on the same Object Property 3100 instance. 4) every Object 3000 instance has a unique Path (special string data format value) that tells its location within the hierarchy and it is this Path system that is used by the Server 100 system, and the client 1200 system, to bind Object instances together within workspaces and applications and across them too, and finally 5) every Object 3000 instance and its respective Object Property 3100 instances can handle working with multiple threads, which is a reality due to multithreaded multi-client communication nature of Server 100.

In some embodiments, as shown in FIG. 3A, for example, every Object 3000 instance may have two fields, Parent 3007 and Children 3008, that makes them either be contained within another Object 3000 instance or contain other Object 3000 instances as children underneath them in said tree structure. With this two object data fields we get to have all Object instances to be in a hierarchy. Every Object 3000 instance will belong to only one Parent at any given time. And it may, or may not, contain other Object 3000 instances as children within itself at the mentioned Children 3008 field, which is a dictionary a key-value list of other Object instances keyed by their Object names (the first Object Property 3100 instance always contains the “Name” value, 3104, for any Object instance because all Class 2000 instances must have their FIRST Class Property 2030 instance defined for “Name.” The Name field 2031 value for the FIRST Class Property 2030 instance for any Class 2000 instance may, in some embodiments, always be “Name”. Because in any dictionary data type, in NET framework or others too, no two keys can be the same, then no two children Object 3000 instances under any (parent) Object 3000 instance can have the same Object name. See FIG. 3B, there are no two siblings that have the same Object 3000 instance name in the tree. This is also by design because the Server 100 system, must be able to navigate the entire object-oriented tree structure, and get to any node by name (see significance of this in Paths further down) in traversing the tree. And this would be not possible if names were allowed to be duplicated. So, all sibling Object instance have unique name under their respective parents for accurate and fast identification and location of said Object instances within the tree.

Moreover, in some embodiments, there may be no limitations on the Class type (ClassName field 3001 value definition) within any Object 3000 instance within the tree hierarchy. Meaning all Object 3000 instances can have children for themselves from any other Object 3000 instance class type (it can be the same, or different, class type—aka referencing Class 2000 instance). The same goes true for the Parent 3007 field in any Object 3000 instance. Also, there may be no limitations on how many children can be contained under one Appward Object 3000 instance. In some embodiments, the Children field may be a crucial point in building the hierarchical nature of Appward Object 3000 instances in 100 server system. The Appward Object 3000 overall is a hierarchical tree structure. And this tree can be traversed recursively, or iteratively, downward by utilizing the children references between an Appward Object and its Children 3008 field. Moreover, the tree can be traversed upward using Parent 3007 field. Also, the Parent 3007 field cannot be the same Appward Object as itself (meaning no circular relationships), which means that every Parent 3007 Object 3000 instance is entirely an independent Appward Object that has said Appward Object as one of its children within Children 3008. Looking at from another way, every Appward Object 3000 instance is contained within its Parent's 3007 Children 3008 collection set. In fact, every time a new Appward Object 3000 instance is created, or loaded into memory, it adds itself to another Appward Object's Children 3008 field and in doing so declares its Parent 3007 while completing its instantiation process.

In some embodiments, Parent definitions or assignments may not necessarily be permanent, meaning any Appward Object 3000 instance can change its Parent 3007 if needed. In fact, this is the case when an Appward Object is moved (e.g., drag and drop capability within the Object Editor tree, FIG. 3A, when configuring a new app or via Scripting too) from one location to another in the Server 100 system's Object hierarchy.

In some embodiments, the Parent 3007 class field, with the Children 3008 field, empowers all Appward Object instances to be able to traverse the global tree structure bidirectionally for the purposes to fetch, connect, and communicate with other Appward Object 3000 instances. The only exception for no further upward traversal (using Parent) may be when an Appward Object is of Sandbox Class type (referencing a Class 2000 instance named Sandbox). This is due to the nature of how Sandboxes are defined, which brings us to the next major point (#2).

But first an important term to highlight here, at this stage of the description, is that all the current Object 3000 instances in discussions are termed “Original” Objects because they exist also in the Database 500 system as it was mentioned in the introduction section. In some embodiments, any interactions (Object 3000 instance additions, Object 3000 deletions, Object Property 3100 Value 3104 changes, etc.) with said Original Object instances within Server 100 system will have its exact corresponding action taken within the Database 500 system so that everything between the two systems (100 and 500) are in sync regarding Original Object instances at all times. There is another version of these Object 3000 instances (created from same exact class model 3000) called Orphans that exist within the Server 100 system that do NOT have corresponding records stored for said Orphans within the Database 500 system. The reason for this is in runtime when custom client applications are being used, it is more efficient to work with temporary copies of the Original applications, called Orphan copies, based off Original building block Object instances, that DO NOT need to be stored at all in system Database 500 because they are temporary in nature, serving end users only when they are using said applications. Once client usage has ceased of said applications, these Orphan Object 3000 instances are deleted and removed from Server 100 memory. This saves tremendous time, in Server 100 and Database 500 systems, in not performing any synchronizing SQL CRUD calls, for all the changes that said applications, including their respective Original Object instances, go through in runtime as they are being utilized by users within Web Clients 1200. So, it's important to briefly show how an Orphan is defined relative to an Original Object 3000 instance due to their relevance in all aspects of the system. Orphan Object 3000 instances have the following features to tag them as such within the Server 100 system: 1) Every Orphan's Key 3002 value is above the maximum threshold allowed for Original Object Key 3002 values (this threshold is a long integer, currently set at one billion 1,000,000,000). In some embodiments, this may be required to indicate that an Object is non-Original, an Orphan; 2) Because Orphans are mostly copied (exceptions are possible in Scripting to dynamically general an Orphan Object 3000 instance from nothing) from Original Object instances, their “RevisionID” 3011 field matches exactly and takes on the Original Object's Key 3002 value. This is yet another indication to know if an Orphan instance was spun off from an Original Object instance; 3) In some embodiments, when an Orphan Object 3000 instance, for example, is instantiated, spun off as a copy, from an Original Object 3000 instance, the Orphan copy is located and situated as a sibling of the Original Object instance under the same parent Object; 4) However, in some embodiments, any Orphan Object 3000 instance's Parent 3007 Object instance does not know about any of its Orphan children. Meaning an Original Object 3000 instance's Children 3008 field only carries a list of all of its Original children Object 3000 instances, excluding any Orphans. The reason for this is to break the limitation (mentioned above) applied to Original sibling Objects that each must have a distinct unique Object name (within the parent Children 3008 dictionary). Because Orphans are not part of Children 3008 field, then multiple Orphan Objects can be spun off from the same Original Object 3000 instance and reside as siblings next to one another. For example, in FIG. 3B, “popMain” 3910 is an Original Object instance that can have multiple Orphan copies spun off from it to serve multiple clients at the same time. These are the advantages of having Orphans: 1) No need for any CRUD operations with the system database 500, which in turn means much faster processing times, 2) multiple duplicates from the same Original Object instance to serve multi-client requests of the same application (or parts of the applications), which gives users to work independently from each other (no interference) when using, accessing, the same applications, 3) Screen Designer in designing new screens always works on-the-fly of Orphan Screen Object 3000 instances to not disrupt the operations of the Original Screen copy that might be in use by other Client users. More on this in the downstream sections when discussing about the Client System application.

### Sandbox Objects

In some embodiments, there may be an Appward Object 3000 instance that is a class type Sandbox (Appward Class 2000 instance called ‘Sandbox’). Sandbox Object 3000 instances are made to act like containers of apps or user ecosystems (being it an individual workspace or company organization). They may enable containment, by setting a boundary, to secure users' data, operations, and internal systems. It may also protect from unintentional data contamination from outside and may allow sharing of data and apps only if that was the intent of the user, or the app, by design (See below on Sandbox linking). In some embodiments, as seen in FIG. 3A, Sandbox may be the Object 3000 instance and may be used to fully encapsulate the operations and development of applications while not letting anything leak out. Another feature of Sandbox Object 3000 instances may be the Object 3000 instances that are contained within a Sandbox Object: A Sandbox Object 3000 may define the scope for all of its children Object 3000 instances that are contained within it, at any level within the tree. The conceptual idea of scope for Object 3000 instances is crucial because it clearly sets the definition for the starting point, within the vast tree structure, where a certain group, a subset group, of said Object 3000 instances may know where they are located based on a reference starting line (a reference Scope—their Sandbox Object container). This feature, or rule, may come in very handy when discussing the Path 3006 and dPaths 3005 fields of all Objects 3000. Without scope, without Sandbox Object 3000 instances, for example, Paths would not have any meaning and in turn would not function at all. This means not only that Sandboxes are crucial for secure containment of other Object 3000 instances, but they also are the bases for the data binding mechanism that, in some embodiments, allows Objects to connect with each other within a said Sandbox instance (one application) or across Sandbox instances (across applications).

In some embodiments, every Object 3000 instance has a ‘SandboxID’ 3009 field, a long integer value, that carries the Key 3002 value of its parent container Sandbox Object instance. A Sandbox parent instance Object may be directly above (direct parent) a contained child Object 3000 instance, or it can be many levels, within the tree structure, above an Object 3000 instance. In some embodiments, as long as there are no other Sandboxes between an Object, in the tree hierarchy, and its parent Sandbox Object, that said parent Sandbox Object may be defined as the immediate Sandbox. In FIG. 3B every Appward Object instance has “sbxMain” 3902 as an immediate Sandbox Appward Object that it is contained within. This is why field 3009 contains the Key field of that immediate Sandbox container above it. The emphasis is on immediate because, in some embodiments, as shown in FIG. 3C, a Sandbox Object instance may contain another Sandbox Object underneath it and so on. The Object 3000 class model shows how the system overall knows which Appward Objects are contained immediately within which Sandboxes. For example, from FIG. 3C, “UserResources” 9100 is a Sandbox 3001 Class 3000 Instance with a Key 3002 value of 70000. It has many children Object instances, like “Colors” 9120 and Functions 9220, contained within its Children 3007 dictionary. Now, for example, said “Colors” 9120 Object 3000 instance, which is a Sandbox 3001 Class 3000 instance too, has a Key 3002 value of 80000 and children of its own. Note how “Colors” 9120 children “ButtonColor” 9130 and “LabelColor” 9140, both of “Color” class type, have their “SandboxID” 3009 field values to be 80000. This is because their immediate container Sandbox is “Colors” 9120, as mentioned before, and not “UserResources” 9100, that has a Key 3002 value of 80000. In some embodiments, the reference starting point for the “ButtonColor” 9130 and “LabelColor” 9140 Object instances is “Colors” Sandbox, and not the “UserResouces” 9100. “Colors” 3009 field value is 70000, which matches the Key 3002 value of “UserResouces” Object instance confirming that its starting reference, Sandbox Object, is 9100. This is how, in some embodiments, the Server 100 system knows how individual, self-sufficient and stand-alone, applications that use Sandboxes, are contained and can operate to do their business functions for users that access them.

As mentioned above, in some embodiments, Sandboxes may also made with the capability of sharing or linking them at other locations within the Server 100 Object tree structure. The only way to share Sandboxes is by allowing them to be linked, using the “OriginalID” 3010 field of any Object instance, to other domains, granted the right permissions.

How this works, in some embodiments, is that the “OriginalID” 3010 field contains the Appward Object Key 3002 of the ORIGINAL Sandbox (Object 3000 instance) that has been linked. ONLY linked Object 3000 instances have this field containing a positive integer value. And ONLY Objects of Sandbox class type (“ClassName” 3001 field value of ‘Sandbox’) are allowed to be linked. So, for example, the reason for this said field may be to let the system know which Sandbox Objects are original ones (“OriginalID” 3010 value=0) versus linked ones (“OriginalID” 3010 value>0). Linking a Sandbox Object 3000 instance may be similar to creating a shortcut, where the linked Object 3000 instance (a shell Appward Object) only acts as a shortcut to the original Appward Object 3000 instance it may be linked from. A linked Appward Object may reuse the same Props 3004 field and Children 3008 field of the original Appward Object. This allows for easy sharing of Appward Object instances across the platform without the need to make separate full duplicate Object 3000 instances, saving the platform memory and performance (in avoiding doing the work of creating duplicates). In FIG. 3D, “UserResources” 9100a may be a Linked Sandbox of the Original “UserResouces” Sandbox Object 3000 instance 9100 that was shown in FIG. 3C. This is why even though 9100a has its own Object 3000 instance and its own Key 3002 value of 120000, it has “OriginalID” 3010 field value of 70000, which matches exactly the Key 3002 value of the original Sandbox 9100 Object (“UserResources”) from FIG. 3C. This also means that the 9100a values, the Objects contained, within both Props 3004 field and Children 3008 field are exactly the same as the original 9100 Object. They are not copies of the original, but references. So that if any change that occurs at the original (upgrades, improvements, etc.) are exactly reflected at the Linked Object 3000 instance 9100a and vice versa. For Example, “Colors” 9120 and “ButtonColor” 9130 Object instances that were mentioned in FIG. 3C are shown exactly and fully also in FIG. 3D under the linked “UserResources” 9100a Sandbox that itself may be contained within a new environment, in this case a User's workspace, “Raffi” 9001 Object 3000 instance (9100a “SandboxID” 3009 value is 100000 which matches the Key 3002 value of “Raffi” 9001 Object Instance). With this example, it may be demonstrated that a Resource, contained within a Sandbox Object, that may be comprised of valuable shared functions with smarts or styling Colors for different application user interfaces, can now be shared utilizing the Linking characteristics of a Sandbox Class 2000 instance that may be referenced by an Object 3000 instance. Similarly, as shown in FIG. 3D, a custom developed application 9020, called “appCustomers”, that immediately has a linked Sandbox Object 9030a, called “sbxMain” with a positive “OriginalID” 3010 value of 50000, shows how one application (say under one organization) can be shared multiple times within each employee's, user's, workspace (example “Raffi” 9001 Object instance) to be utilized for that organization's business operations without the need to duplicate the application multiple times (equal to the number of employees who need to use that said application). As mentioned before, because each Sandbox defines the scope for its children to operate in, this said application (e.g., “appCustomers”) will work exactly the same way, given its building block Object instances are configured self-sufficiently, irrespective the environment or domain, user's workspace, it may be linked under. Finally, because Appward supports on the-fly-way development, and sharing of applications, linking of Sandbox Class Object 3000 instances can occur programmatically because the Object 3000 class has a “Link” method that may be utilized by different component in the Server 100 system that allows the sharing (linking) of Original Sandbox Object instances within new environments.

Linking Sandboxes within the Appward ecosystem, in some embodiments, may be a foundational axiom that enables sharing of resources, data and applications among users and systems. For that reason, it may be important to know how to trace which Sandboxes are linked and how to identify them in the Object hierarchy, which brings us to the topic on Object Paths 3006 and how they are used within any building block Object, in making custom applications that work independently and self-sufficiently within many different environments.

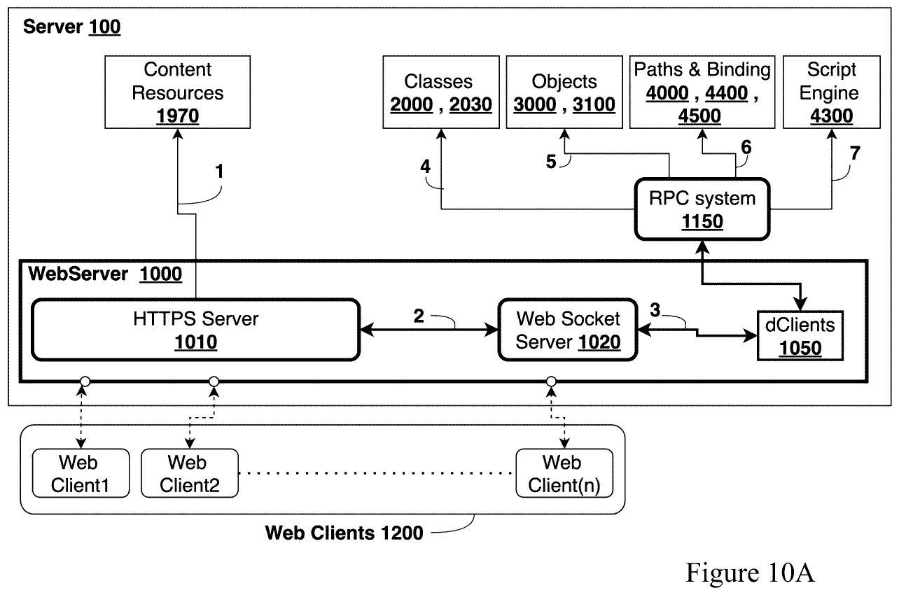

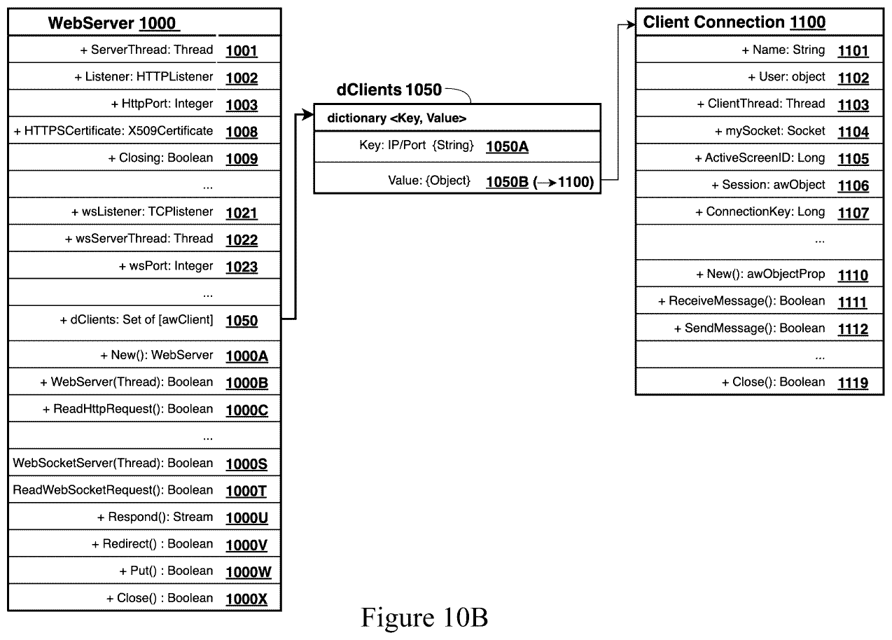

In some embodiments, every Object Property 3100 instance can contain custom versions of Values 3104 that are unique to each Client 1200 utilizing that Object Property 3100. If the IsClientOnly 3106 field for a given Object Property 3100 is marked as “True”, then each Client 1200 that may be utilizing that Object Property 3100 may be able to set and utilize their own specified Value 3104 for that Object Property 3100 instance without affecting how other Clients 1200 see and utilize that Object Property 3100 Value 3104. This functionality is possible through the ClientValues 3107 collection, See FIG. 3A. In some embodiments, this collection may store and maintains the different versions of the Value 3104 by the Client Connection Key 1107. The Connection Key 1107 may be a unique field within Server 100 that cannot have any duplicates and may be used as a way of identifying all the different Client 1100 Connection (see FIG. 10B) instances within Server 100 and their associated Web Client 1200 counterparts. Keying ClientValues 3107 at an Object Property 3100 instance by this Connection Key 1107 ensures that each Client Connection 1107, hence its respective, associated Web Client 1200 can read and write their own unique Values 3104 within ClientValues 3107 without affecting other Values 3104 (that are within that same ClientValues 3107 collection) for other Web Clients 1200. Hence, the described structure provides that functionality whenever a Client 1200 utilizes the Value 3104, they will see the representation of it that may be pulled from the ClientValues 3107 collection based on their own unique Client 1200 Connection Key 1107, which could represent a different Value 3104 than what other connected Clients 1200 see and interact with for that same Object Property 3100 instance. In contrast, Object Property 3100 instances that have their IsClientOnly 3106 as “False”, means that the given Object Property 3106 instance may be not IsClientOnly 3106, leading to all the connected Clients 1200 seeing and utilizing the same Value 3104 for the Object Property 3100 instance. In some embodiments, the IsClientOnly 3106 field ultimately allows Clients 1200 to customize data and styling for themselves through the same Object Property 3100 instances, giving each Client 1200 powerful, on-the-fly customization capabilities. Some real-life use cases of this feature, comprising: 1) A filter textbox that has IsClientOnly 3106 field as “True”, can show different filter values for different connected Clients 1200 at the same time when filtering the same data source displayed within a Screen Table Object 3000 instance at a user interface. 2) A variable Object 3000 instance Value 3104 that has IsClientOnly 3106 field as “True”, can store different number of Screen Column Object 3000 instances within the same Screen Table Object 3000 instance based on which Web Client 1200 may be viewing. The storage of the Client Specific Values 3104 will be discussed in more detail within the Database 500 system in latter sections as the topic of “Sessions” may be covered.

### Paths

In some embodiments, before we connect building block Object 3000 instances within the Server 100 system with each other to make custom applications on-the-fly, we need to be able to locate them first accurately. Having within the Object 3000 class model, “Path” 3006 fields, including “dPath” 3005 fields, for example, may allow the former to happen and then utilizing them to configure Objects, as building blocks, achieves the latter. So, what's a “Path” ?

In some embodiments, Path 3006 may be a field of String data type. The path of an Appward Object instance may represent its location in the system within a certain scope (relative to a particular Sandbox Object Instance). This, for example, uses the hierarchical nature of Appward Objects to indicate where an Appward Object may be located accurately within the overall tree structure comprised of all Appward Objects in the Server 100 system.

In some embodiments, an Appward Object Path may be constructed by concatenating together all the Parent Object 3000 instance names (String types), including its own, that exist in the said Appward Object's hierarchy until the reference Sandbox Object instance may be reached. All Appward Object instance names are separated from one another by “.” (Period Character) as shown in FIG. 3F. Before we demonstrate Paths in action and their benefits in data binding, it may be helpful to cover the two types of Path 4000 syntax that exist in Appward: 1) Absolute Paths 4001, 2) Relative Paths 4002. The difference between the two mainly has to do with the starting Object 3000 instance (See further down on Relative paths).

In some embodiments, Absolute Paths 4001 may always start from their immediate, or not immediate, Sandbox Object container denoted by the character “.”. For example, in FIG. 3C, “OpenApp” 9240 Object's Path 3006 value is “.AppFunctions.OpenApp” relative to its immediate Sandbox Object container “Functions” 9220. The first “.” Character in this absolute Path value example represents the Sandbox Object instance 9220 “Functions”. Now because “OpenApp” can be traced down the tree from any higher-level Sandbox container, in this example “UserResources” 9100, then any Object 3000 instance can have more than one possible Path to it, hence more than one representation for the same location definition in the tree. This is where the “dPaths” 3005 field comes in handy in holding multiple possible Path strings for a given Object Instance to be stored within in a key-value dictionary for quick retrieval and reusability for subsequent usages. “dPaths” 3005 may be an actual .NET dictionary object data type. The dictionary key of 3005 may be the Key 3002 field value of the Sandbox Object instance that is being used as a starting point, while the dictionary value stores the actual Path string data. From FIG. 3C, the “dPaths” 3005 dictionary for “OpenApp” 9240 would be as follows:
key value
85100 “.AppFunctions.OpenApp”
70000 “.Functions.AppFunctions.OpenApp”

In some embodiments, Paths may be generated based on needs in data binding between Object instances, which will be covered in next section. But for here, it is important to mention that once a Path string 4000 for an Appward Object instance, relative to any Sandbox container up the hierarchy, may be generated, it may be added to “dPaths” 3005 that maps the Sandbox Object instance, via its Key 3002 field, that may be used as the starting point to the respective Path definition for that given Object 3000 instance.

In some embodiments, dPaths may be managed and updated in Server 100 system in real time whenever a change occurs on any Appward Object instance that may have an effect on its Path. Actions like renaming, moving, or deleting of any Appward Object 3000 instance will dynamically update that Appward Object's and its Children's Path 3006 and “dPath” 3005 dictionaries to keep data relevant and accurate. For Example, in FIG. 3C if Object 9230 “AppFunctions” were to be renamed say “ApplicationFunctions”, then the Server 100 system will traverse the tree and update all Paths contained within Children 3008 that are children within 9230 Object. This means for Object 9240 “OpenApp” and its two fields, Path 3006 and “dPaths” 3005, will change to Path=“.ApplicationFunctions.OpenApp” and the above table for 3005 will now be:
key Value
85100 “.ApplicationFunctions.OpenApp”
70000 “.Functions.ApplicationFunctions.OpenApp”

Note that if say the topmost Sandbox Object “UserResources” 9100 got renamed, then it would have no effect on “OpenApp” Object's 9240 “dPath” field 3005 because, as a starting point it may be represented by “.” and not its Object name. This is not always true for Sandboxes because if Sandbox “Functions” 9220 were to be renamed, then it will make a change in “dPaths” 3005 second entry list.

In some embodiments, “dPaths” may be a crucial field for Server 100 system's performance because it makes getting Path 3006 values of any Object 3000 instance, that were generated once, to be reused over and over again in run time operations without having to parse something again repeatedly to find an Object 3000 instance's location. Object 3000 Path field class functionality uses this “dPaths” 3005 collection to return any Appward Object instance's location (Path 3006 value) to whatever system, or sub-system, is asking for that information.

In some embodiments, the most common two Absolute Path 4001 scenarios, of an Object 3000 instance, when designing a new app or reconfiguring an existing one may be: 1) Absolute Path of an Object 3000 instance with respect to the immediate Sandbox Object container, 2) Absolute Path of an Object 3000 instance with respect to the logged in Sandbox Object that the user landed upon successful login process, as mentioned before as the user's workspace (“Raffi” 9001 Object instance in FIG. 3D). This is the reason in an Object Editor 3200 UI, FIG. 3H, these two Paths are always displayed at the bottom of the UI window, 3202 and 3203 respectively. More on this said Object Editor 3200 user interface in subsequent sections.

In some embodiments, locating Object 3000 instances using Paths 4000, 4001 or 4002, is one part of the story. It does not stop there, the Server 100 system may extend using the Path design syntax to locate also, and in turn target, Object Property 3100 instances that belong to any given Object 3000 instance. The syntax to locate any Object Property 3100 instance may be to use the special “\” character to indicate the end of reaching an Object 3000 instance and the start of an Object Property 3100 section for any given Path 4000, as shown in FIG. 3F. For example, in FIG. 3D, “popScreen” 9040 may be one type of a Screen Class 2000 instance. And like every other visual widget or icon in the library of icons, it has Class Property 2030 instances defined under it to characterize its “Top”, “Left”, “Width”, Height”, “BackColor” settings and so on. In order to locate the “Top” Object Property 3100 instance of “popScreen” 9040, within the tree structure, the full (absolute) Path 4001 that may be needed is “.popScreen\Top” (starting from its immediate Sandbox parent “sbxMain” 9030) or it may be “.Raffi.Applications.appCustomers.sbxMain.popScreen\Top” (starting from a higher level Sandbox Object “Raffi” 9001). Most of the time when Paths are data binding Objects together to create a larger and richer capabilities within an application, it may be the Path referencing an Object Property 3100 instance that may be what usually may be required (as it will be demonstrated further down in examples).

Continuing further with Paths 4000, in some embodiments, and as mentioned above, the second style, or syntax, for Paths that exist in the Server 100 system may be called Relative Path, 4002 from FIG. 3F. This may be a Path string that identifies an Appward Object's (Target's) location relative to another Object 3000 instance, the Appward Object (Source) that may be using it. Again, in some embodiments, relative paths are mostly used in data binding building blocks within an application and are highly effective in binding different Objects around them dynamically on-the-fly. Relative Paths must always start with one of the following syntax keywords 4003 in FIG. 3F:
Me
MyParent
MyGrandparent
MySandbox
MyScope
MyWorkspace

See FIG. 3E for a sample explanation on the above relative keywords that can be used in a path within the context of one specific tree branch node. “Me” 10 would be the selected Object 3000 instance itself, the starting Object instance, in this case selected node in tree may be “CompanyID” (which may be a “ScreenColumn” Class Instance type). So, if the selected node, the Object 3000 instance “CompanyID”, ever used a relative Path containing “Me” then the Path would end up targeting either a Child of “CompanyID” or any one of its Object Property instances.

In some embodiments, “MyParent” 11, in turn, would refer to, the parent of “CompanyID” (the selected node—starting Object instance), which in this case may be a Screen Table Object instance called “tblMainTable” at 11. Following the same logic, “MyGrandParent” would refer to the “popMain” 12 Object instance in the tree. “MySandbox” would refer to the immediate sandbox belonging to “CompanyID”, which in this case would be “sbxMain” Object 3000 instance 13. Finally, the “MyScope” or “MyworkSpace” would refer to the sandbox Object 3000 instance that the user was logged into, which in this case may be “Raffi” 14. As an example, in FIG. 3E, the selected node “CompanID” has based on its associated Class 2000 instance “ScreenColumn” type a Class Property 2030 instance called “BoundPath” 20. The figure shows an example of how the “BoundPath” Object Property 3100 instance Value 21 may be a relative path (“MyGrandParent.datCompanies.CompanyID\Value”) that goes first to “popMain” screen Object instance using “MyGrandParent” keyword and relative to that from there on goes down its child Object instance “datCompanies” table, and accesses one of its Column Object instance's (called “CompanyID”) Property 3100 instance's Value 3104. On a high level this example shows how to binds, more on this next, the Screen table's “CompanyID” 10 “BoundPath” Property 20 with one of the data tables, “Companies” 22, Column's Object (“CompanyID”) Property Instance called “Value”.

Data Binding with Paths

In some embodiments, Appward Paths 4000, whether absolute Paths or Relative ones, are the means to data bind Appward Object 3000 instances to each other within the entire ecosystem. Data binding may be valuable tool in any programming environment: to connect Objects, Properties and data in general together. In Appward, we use this said Path 4000 approach, with its associated underlying mechanisms, to bind Object instances to each other in run time on-the-fly. Appward Object Property 3100 instances can use these Paths to point to another Appward Object Property 3100 instance (or even an Appward Object 3000 instance). So, when a target Path 4000 string value may be entered at any given Appward Object Property 3100 Value 3104, then the system will analyze and validate that path to make sure it does refer to a valid target Appward Object before it may be bound to it. FIG. 3F describes this process flow on how binding occurs within the Server 100 system.

In Appward, the Object Property instance Value 3104 that contains the Path string may be referred to as the Source Object Property 4400 from FIG. 3G. While in some embodiments, the Object 3000 instance or Object Property 3100 instance that the Path points to may be referred to as the Target object, 4500 from FIG. 3G. As said before, each Path may describe a location of where an Appward Object or Appward Object Property in the hierarchy resides. So, for example, by entering a valid Path string at a Source Property (for example, in Object Editor UI), a new Target 4500 Object (located by this same Path) may be bound to a Source 4400. Here's how, from FIG. 3F: Upon setting a new Path at a Source Property Value, the Server 100 may check in the system if the Path 4000 passes a Regex check B to see whether the entered string has the correct format that resembles an Appward Path. If not, then the process may terminate and exit B1 because it was determined early on that this was not a Path entry, with no additional changes within the overall system (except the fact that the Source Object Property Instance Value 3104 has this new string value in it). However, if the Path string may be of the correct format, then this Path will be checked C whether it may be an “Absolute” one or “Relative”. Both cases lead to step F, but if the entered Path may be a relative one, then there may be one extra action to be taken, E, and that's to decode the relative Path, within the Server 100, from its relative syntax to a more accurate translation that will make sense to the system. E converts only the first word, the relative keyword (“Me”, “MyScope” as covered above) within the Path string with the specific Object instance's Key 3002 value prefixed with a special “@@!!_” string to further indicate that this was a relative Path. The Key 3002 value may be the one from starting Object instance's that was referred by the relative keyword. Just to use FIG. 3E from a previous example: The entered Path 21 of “MyGrandParent.datCompanies.CompanylD\Value” at “BoundPath” 20, in some embodiments, would be converted to a decoded path of “@@!!_100900.datCompanies.CompanyID\Value” as it exits step E of FIG. 3F (given the Key 3002 value for “popMain” 12 is 100900). If the starting Path was initially absolute, then step D just feeds the initial Path as may be to step F, which may be where step E also brings us to after getting the Decoded Path. So, from this point on in the process, this Path would be termed “DecodedPath”. At F the Server 100 will try to get the target by checking within its global list “dPropByPath” 71 that contain decoded Paths that are mapped to targets (Object instances or Object Property instances) that were previously generated. If decoded Path exists already in the system, then step F will return the target object and exit the process G1 without any further work in the Server 100. However, if path was not found in the system list 71, then the entered path may be a new one and has not been used before within Server 100. Hence, the next step in process H may be to parse the entered Path by splitting them into an ordered list of individual words, across the “.” And “\” characters. In some embodiments, these words represent the Object instance names and the Object Class Property instance name (if “\” exists in the Path). The “GetObjectByPath” function then will use each of these words in order, to navigate the existing tree structure starting from the reference Object instance (“@@!!_Key” for relative path indicating the relative starting Object or the Sandbox Object of the Source Object instance for an absolute path). If this function call does not find the target Object instance, then this may mean that the entered path was not pointing to any valid actual object in the tree structure and therefore may exit the process by returning a null value. On the other hand, if a target is found (again this can be an Object 3000 instance or an Object Property 3100 instance), with a quick check I, then this newly bound target gets added into the appropriate Server 100 system collections (70 and 71). This may be to save time and work next time the same Path 4000 string value was requested to be processed again, returning a target at step F. These 70 and 71 collections are continuously utilized throughout the lifecycle of Server 100 for proper linking and management of Sources 4400 and Targets 4500 within Server 100 memory. In some embodiments, this is Appward's systematic binding mechanism that connects together different Appward Object instances, including their underlying complex structures, all in run time, by using a string Path values.

In some embodiments, there are three different types of definitions when data binding Object instances and Object Property instances in Appward, as shown in FIG. 3G. Before describing these definitions each with an example, it may be important to note that data binding mechanism itself in Appward may be agnostic of the context of the application. In some embodiments, it may succeed connecting any two Object 3000 instances, or any of their respective Object Property 3100 instances, within the Server 100 system, given valid Path format. It will succeed in linking the two sides or bringing in, sending out, data across. But that does not guarantee that the Source 4400 Object will understand the incoming (bound) data, or link, from the Target 4500 and be able to process properly, and vice versa from the Source 4400 to the Target 4500. Since every independent Object 3000 instance has a specific Class 2000 instance type. And these Class 2000 instances in turn have their own unique business logic and characteristics. It may be then upon proper configuration, setting of correct Paths, within said Object Property instances to make data binding work correctly for each individual Object 3000 Source 4400 and its respective Target 4500, whether they both have the same or different Class 2000 instances, in order both sides understand each other, and are able to work together to make an application.

The three types of definitions, as shown in FIG. 3G, are: 1) “One way to Source” 4110, 2) “One Way to Target” 4120, and 3) “Two Way” 4130. “One Way to Source” binding causes changes made at the Target 4500 Object 3000 instance, or mainly the Property 3100 instance, to automatically update the Source 4400 Object Property instance. On the other hand, “One Way To Source” may be the reverse mechanism, which updates the Target 4500 Object 3000 instance, or Property 3100 instance, when its respective Source 4400 Object Property changes, but NOT the other way around. This is useful when a Target's 4400 value can only get updated by some change at a user interface icon (ScreenText, ScreenTable Class 2000 instances, etc.). Finally, “Two Way” binding works, for example, by propagating changes made to EITHER the Source 4400 Object Property instance, or the Target 4500 Appward Object or one of its Property instances, to update the opposite end. It is basically the combination of the previous two types. See example in FIG. 3B where in the visual user interface rendering of the “appContacts” 3910UI application Object instance 3910, the “ScreenText” Object 3940 may be bound via its “Value” 3940p7 Object Property 3100 instance, having a Path 4000 string “MyParent.datContacts.FirstName\Value”, to the Data Table Column “FirstName” 3913 Object instance's “Value” Property 3100. As mentioned before, data bindings get their type definition within the context of the Object instances that they are used. In this case, a ‘ScreenText’ Class 2000 instance, “Value” Class Property 2030 instance, may be bound using “Two Way” definition. So, any text entry change at the user interface text box 3940UI (that updates 3940p7 Property instance's Value 3104) will automatically update its bound Target 4500, which may be the Column “FirstName” 3919 instance's “Value” Property. And the opposite may be also true, any changes at 3919 Data Table “FirstName” Column field “Value” will propagate back to the ‘ScreenText’ 3940 “Value” Property 3940p7 and be rendered at any web client (1200) accordingly as shown in FIG. 3B.

In some embodiments, as it is shown above what Appward Paths 4000 are and how they work in binding building block Object 3000 instances and any one of their Object Property 3100 instances within the Server 100 system, it may be important to note how this environment can scale the creation and usage of flexible applications. For example, most Applications (Appward Object 3000 instances of Class 2000 instance type ‘Application’) will need to run independently as stand-alone by utilizing self-contained logic and dynamically bind target data that are internal to themselves only. This means that when multiple instances of the same application are being used, these instances need to work accurately and independently without effecting the data validity and process operations of other active ones. This may be true whether an application, an Orphan Object 3000 instance copy for the user interface only may be being spun off (per each Client request) or much more than that (Data tables and Function Script logics too). If this reality cannot be made possible, then a lot of applications will cease to be useful and reliable within any shared ecosystem or organization for many users. Relative Paths, 4002 FIG. 3F, play a key role in ensuring the functionality of any application stays self-contained and self-sufficient no matter what user workspace or sandbox is running it. Having self-contained functionality and configuration makes single application sharing and running reliable and scalable to multiple users. And that's one of the advantages of Appward's data Class 2000 and Object 3000 structures, augmented with the above-mentioned Path 4000 definition and binding mechanisms.

As said prior, every Object 3000 instance may be contained within a certain Sandbox (Object 3000 instance of Class 2000 instance “Sandbox”) and one of the key features of a Sandbox Object 3000 instance may be defining the scope and access levels of the Children Object 3000 instances contained within it, at any level within the tree structure. Sandbox Object 3000 instances create a barrier that prevents any children Object 3000 or Object Property 3100 instances (including any scripts), from reaching outside of this parent Sandbox Object 3000 instance. In some embodiments, this containment may be ensured through the SandboxID 3009 field of any respective Object 3000 instance. As said prior, since Objects 3000 instances are limited to within the scope defined by their SandboxID 3009 field, this ensures that no Object 3000 or Object Property 3000 instance can utilize Paths 4000 in order to reach outside of their Sandbox or defined scope. To illustrate, take Absolute Paths 401, the syntax for Absolute Paths 4001 always starts with “.”, and the first “.” will always indicate the SandboxID 3009 that may be defined for the Object 3000 or Object Property 3000 instance on which the Absolute Path 4001 is being entered for. This means that the absolute highest starting point within the hierarchy that that Object 3000 instance can access, may be that Sandbox Object 3000 instance defined by SandboxID 3009. This will always be the very first starting point of the Absolute Path 4001 initiated data binding, so it is not possible to reach other areas outside of this starting point. Any other subsequent entries after the initial “.” will then begin searching under the Sandbox's Children Object 3000 instances and so on.

In some embodiments, there is one exception with the use of Relative Paths 4002 that allows for limited reach outside of an immediate Sandbox Object 3000 instance with the use of the keywords: “MyWorkspace” or “MyScope.” The use of these gives the Object 3000 instance that initiates the data binding to be able to access the Sandbox Object 3000 instance that the user was logged into (i.e., their workspace), hence they will then be able to view and modify the Children Object 3000 instances that are within the workspace Sandbox Object 3000. Expanding on the example from FIG. 3E, the “CompanyID” 10 Object 3000 instance can access its workspace “Raffi” 14 by utilizing the “MyWorkspace” or “MyScope” keywords, even though its immediate Sandbox Object 3000 is sbxMain 13. Hence, in some embodiments, the use of these special keywords “MyWorkspace” or “MyScope” allows access outside of the immediate Sandbox container that an Object 3000 instance belongs in only up until the workspace scope. This may be the highest access level that a given Object 3000 instance can access, they cannot reach other structures outside of the logged in workspace. Since the workspace may be per one specific user and may be self-contained, again, there is no data breach or contamination. Ultimately, these Sandbox Object 3000 instances, in some embodiments, play a crucial role in providing containment and security to individual applications and workspaces, keeping them free from outside interference by other applications, users, or scripts.

In summary, Appward's Path system may be a uniform and scalable data binding model that, in some embodiments, works for both Server-side and Client-side applications. One language, one format, that works in all stacks (fronts). And more important this Data binding is flexible to change and be configured on the fly. This may be where Scripts can add much value too, as it will be shown in next sections. In some embodiments, this platform may empower an efficient programmatic mechanism that allows predictable, dynamic, binding approach because its model (Absolute or Relative Paths) may be based off the same object-oriented hierarchical base data model that all Object (3000) instances are configured (on-the-fly too) and run on.

Multithreading and Concurrency Handling within Appward

As mentioned in the introduction section, in some embodiments, Server 100 by nature may be a multi-threaded server application. And because Object 3000 instances play a huge and critical role in running the Appward ecosystem in building applications, systems and respective dependency sub-systems, all said Object 3000 instances need to be able to work across multiple threads at any given time. For this to be possible, every Object 3000 instance has locking mechanism on different levels within itself to regulate multi-threaded traffic coming mostly from multiple clients 1200 that possibly might be accessing the same Object 3000 instances or any one of their respective Object Property 3100 instances at any given time. The Object 3000 class has couple of these locking fields to enable multi-threading as a foundational feature within the Appward platform as do their respective Object Property 3100 class model also. In FIG. 3A fields “LockObject” 3012 and “LockObjectPath” 3013 within Object 3000 class, and fields “LockProp” 3109” and “LockSetProp” 3110 within Object 3100 class exist for this reason. It is helpful to clarify, briefly here as it will be expanded on this topic when discussing about Web Clients 1200 and the system Web Server 1000, that the multi-threaded architecture of Appward allows for different Web Clients 1200 to interact with the same Appward Objects and Properties simultaneously without overwriting one another. This brings up the fact that each web Client 1200 runs on a separate independent thread within the Server 100 system in processing its communication back and forth with the said Server independently from other connected web clients. Here are the details on the locking mechanisms within the base class data structures 3000 and 3100.

In some embodiments, “LockObject” 3012 field may be used to prevent multiple Clients from modifying an Object 3000 instance's Children 3008 collection at the same time. It may implement the “Locking” concept in computer programming (SyncLock within .NET framework) to make multithreaded application processing a reality. So, whenever there's an action (such as to insert, delete, rename, or move) on a Child Object 3000 instance, the parent Object's “LockObject” 3012 may be used to allow the Children 3008 collection for one Client to complete its action, while hindering other Clients from modifying the same Object at the same time. Once the first Client is done, the next Client in queue may be given access to complete their independent actions and so on. This may safeguard Appward platform against concurrency issues at the building block level (Object 3000 instances) as seen in FIG. 3J where one Web Client 1211 is adding, step 1, a new button Object 3000 instance under “Colors” 9120 Object instance, while at the same time a second Web Client 1212 is trying to add another Object 3000 instance, step 2 with Text Color Object 3000, under the same parent. It is shown that 2 may have to wait for 1 to complete with the return of 1A response from Server 100 back to web Client1 1211. Only after this web Client2's 1212 actual action starts 2A taking place at the Server 100 side in adding another new Object 3000 instance under the same parent Object 3000 instance 9120 and finish 2B and return back its response to its web Client 1212.

In some embodiments, “LockObjectPath” 3013 may be similar to “LockObject” 3012 field, in safeguarding against any concurrency issues in Appward. This field may be a .NET object data type used to prevent multiple Clients from modifying an Object instance's dPaths 3005 collection at the same time. The Object 3000 instance's “LockObjectPath” 3013 may be used to only allow one Client at a time to modify the dPaths 3005 collection. Once first Client is done, the next one in the sequence may be given access to complete their modification and so on.

In some embodiments, “LockProp” 3109 field safeguards against any concurrency issues when dealing with an Object Property 3100 instance. This field allows only one Client at a time to modify a given Object Property 3100 instance in any way: accessing it, deleting it, executing its business logic (if “PropType” is Method), etc.

In some embodiments, “LockSetProp” 3110 field may be used for safeguarding against any concurrency issues in Appward when setting a value in any Object Property 3100 instance's ClientValues 3108 collection. This field may be used to prevent multiple Clients from modifying this collection at the same time. This allows only one Web Client 1200 at a time to modify the ClientValues collection. Once first Client is done, the next one in the sequence may be given access to complete their modification.

### How Classes and Objects Work Together in the System

In previous sections, it was discussed how Class 2000 instances have each their own specific, custom, and individual shared, static functions, business logic that are declared, and made visible on the front end (Class Editor 2200), by their respective Class Property 2030 instances of Method types (“PropTypes” 2036). One of the major factors that characterizes an Appward Class 2000 instance, are these business logic methods that give smarts to said Class instances. Additionally, it has also been shown how each Object 3000 instance references only one Class 2000 instance. And in turn Object Property 3100 instances, belonging to an Object 3000 instance, reference each of the Class Property 2030 instances (one to one relationship), respectively, belonging to the Class 2000 instance (referenced again by said Object 3000 instance).

As mentioned before, in some embodiments, Object 3000 instances are the foundational block structures to build custom Apps and systems within the Appward environment. It is then crucial to show how any Object 3000 instance can access its respective Class's 2000 shared business logic in real time, dynamically. Shared (in Visual Basic .NET syntax), or Static (in JavaScript syntax), functions belong to any Class declaration itself. These functions, or class methods, can be used (or called) without the need to instantiate said Classes. In some embodiments, Dynamic Class Method calls are important because Appward is based on the foundation that real time, ease, and speed of configuration, development and execution of Apps must be a reality to end users and because Appward is open ended when it comes to allowing end-users to fully decide on what to develop and how to configure their own environments, then this reality necessitates for Class 2000 instances and Object 3000 instances to work together on the fly, in real time, dynamically. This means any existing, or future, Object 3000 instance can reach and execute its existing, or future, Class 2000 instance's shared (static) business logic on the fly, in real time.

In some embodiments, dynamic calls in programming are not something new, but how Appward leverages its base classes' architecture has advantages to this end. FIG. 3I describes how Appward's own unique architecture leverages dynamic calling between Object 3000 instances and Class 2000 instances to always execute reliably specific targeted Class 2000 business logic for specific Objects 3000. All Object 3000 instances may access their respective business logic within any Class 2000 instance declaration in this same process flow within Server 100. Here are the simplified process steps that always need to occur for a proper dynamic call of any Class declaration's business logic in Appward:

In some embodiments, some Object 3000 instance somewhere, say “popMain” 3910 from FIG. 3I, starts 1 an action by calling one of its “Method” Property 3100 instances, for example “Show” method 3910P62, which in reality may be designed (with its Class 2000 shared business logic) to show a Screen Popup at a given Web Client 1200 (a user requesting the popup screen) served via the Web Server 1000 that resides within the Server 100 system.

This Object 3000 instance may be passed to the Router function (3300) that checks (step A) the validity of that Object instance's respective Class 2000 instance's declaration and its Class Property 2030 (Method) instance's SHARED function declaration (actual declaration within .NET Server framework). Once validated, step B sets up the required Parameters to pass for that dynamic function call and then calls it, using NET framework's system Reflection library. In this example, the parameters that are needed for Screen Popup's (Class name) “Show” SHARED method are: a) The Object 3000 instance “popMain” 3910 and 2) the calling trigger object, which usually in such screen related methods is the Client object, which both the Server 100 and Web Server 1000 keep track of (more on this subsequent sections).

In some embodiments, at this point in the process flow the Class 2000 instance's shared business logic gets executed (with passed Parameters from Router system 3300), step C in FIG. 3I, which in this example is to accumulate and order, in a list, all the Screen popup “popMain” Object instance data, and meta data, including from all its Children Object 3000 instances. Upon completion of the “ScreenPopup” 2902 class's “Show” 2902P62 SHARED method call, the logic flow mechanism within the Server 100 returns the data result back to the Router 3300. Then at Step D returns the respective Screen Popup data to the original caller (same as the starting 1 event) at a web Client 1200 that requested for a popup screen to be displayed. In some embodiments, this concludes 2 this process of routing mechanism. Note in FIG. 3I that the “Show” function declaration 2902P62, within ScreenPopup class 2902 declaration, may be defined as SHARED as these dynamic calls occur using the Router 3300 system.

In some embodiments, this same process may be used for any Object 3000 instance to execute its associated Class 2000 instance's shared business logic. A “FileManager” Class 2000 instance having its “Download” shared logic be used by one Object 3000 instance referencing it to download files from the Appward cloud platform to that users local PC. Another Object 3000 instance might be referencing a “Database” Class 2000 instance and use its “Open” method instance Object Property 3100 to open a new database connection to an external database engine defined furthermore in the other Object Property 3100 instance of the container said “Database” Object 3000 instance. These are couple of examples from a vast set of Class 2000 instances that Appward has, or can scale to have more in the future, that can be utilized on-the-fly by referencing Object 3000 instance to run custom, individual and unique, shared business logics for custom application within the Platform.

### Object Editor

In some embodiments, Appward's ability to configure new Appward Object 3000 instances or change existing ones, in real-time, gives users ultimate flexibility within the platform to scale fast and be able to serve efficiently and precisely each user's needs in their own ecosystems. This is in significant contrast with mainstream software applications where web applications are hardcoded and are not open for end users to make custom changes of their own. Moreover, another advantage with Appward's Objects data structures may be how they get configured, connected, and operate in runtime. This latter fact sets Appward apart from other Low Code (or even No-Code) platforms that are currently in the market.

In some embodiments, the tree structure definition of Appward Object instances is foundational systematically because it allows for any group of Appward Objects to be linked to each other in a variety of different ways and configurations for the purpose of making custom apps. And that these apps can connect and communicate with each other with ease and transparency from any user's perspective using Appward's data binding syntax. One of the main on-the-fly configurations that is made possible via Appward's Object Editor 3200 user interface, see FIG. 3H. In some embodiments, this Object Editor may be one of the system files that every web client, FIG. 1 1200, gets served and loads within their browser application for usage whenever it is needed by an end user or developer. Due to this Object Editor 3200 interface anyone may be empowered to configure on-the-fly within the Appward ecosystem to make any kind of custom changes to their workspace, applications, and interfaces. Here are some of the functionalities this Editor 3200 has: 1) A menu 3220 toolset comprising of a) Add/Paste (adds an Appward Object 3000 instance of the Appward Class 2000 Instance chosen in the Class Selection 3210 dropdown. In some embodiments, if Copy mode was selected in the menu, then it will paste the copied object instance tagged in memory instead of adding. Add calls the Object 3000 constructor method, while Paste calls Copy method of the 3000 class, b) Child menu option for Adding or Pasting, the Appward Object instance in memory as a Child of the currently selected Appward Object instance, shown within the tree 3240 area, c) Delete menu option that deletes the currently selected Object 3000 instance (3945) along with all its Children. In some embodiments, this calls Object 3000 class's Remove( ) method function, which ends up removing the object records also from system Database 500 (remember all the Object instances shown in the Editor 3200 are “Original” Objects); 2) Class Selection 3210, Dropdown menu that allows selecting an Appward Class 2000 instance to create and add a new respective Appward Object 3000 instance from at the selected node within the tree 3240; 3) Tree Hierarchy 3240 view that displays the Parent to Child relationships in a tree format for all the Appward Object 3000 instances starting from the user's logged in sandbox (“Raffi” Object 3000 instance, shown as 9001 from FIG. 3D or as 14 in FIG. 3E). This is essential to configuring and building different structures and applications on-the-fly using the menu tools provided within the Editor 3200; 4) Object Properties Tabular view 3230, showing Object Property instances' details. This Table displays only the Appward Object Property instances for the selected Appward Object 3000 instance in the tree 3240 area. In some embodiments, the Object Property 3100 fields that are only displayed in this table view are the “Parameter” name (respective Class Property Name 2031 associated with this Object Property 2031 instance's “ClassProp” 3103 value), the “Value” (the Value 3104 field of each Object Property 3100 instance, the “User” (the IsClientOnly 3106 field of each Property 3100 instance allows for unique custom values to be set and stored for each user. This means, for example, that the Value 3104 field per each Property 3100 instance will be different for each logged in user. These client user values are stored within “ClientValues” 3107 dictionary within each Object Property 3100 instance), the “Retain” 3111 may be a Boolean field indicating if the IsClientOnly 3106 Values from the Object Property's ClientValues 3107 collection should be stored to database or only held within Server 100 memory. More on this is discussed within the context of the Database 500 system discussion, “Event” (the OnChange 3105 field of each Property 3100 instance that can carry a custom script that fires every time the Value 3104 of the respective Property changes), and “ClassEvent” (respective Class Property 2030 instance custom Script 2051). In some embodiments, the “Value” column can be fully edited and configured if respective “PropType” 2036 field may be of “Property” or “Event” type. “PropType” 2036 of “Method” can be ran directly from the Properties Table. 5) Help 3205 area displays help text on the selected Appward Object instance or their respective Appward Object Property instance. The content for this Help 3205 area may come from the respective Class Property 2030 instance “Help” 2041 field, see FIG. 2A; 6) Object Key view 3204 that displays the Unique Object instance key 3002 value that identifies the selected Appward Object instance within the tree 3240 area of the Editor 3200; 7) Path 3203 from client's sandbox, which is an absolute Path 4001 of the selected Appward Object instance starting from the sandbox that user may be logged into; 8) Path 3202 from immediate sandbox, which shows the absolute Path 4001 starting from the immediate Sandbox scope of the selected Appward Object 3000 instance; 9) Class name view 3201, which shows the Appward Class 2000 instance name of the selected Appward Object 3000 instance within the tree area.

### Scripting Engine and Script Editor

As mentioned, and shown, before that when any Class Property 2030 instance's “PropType” 2036 may be “Script”, then any respective Object Property 3100 instance that references this said Class Property may, in some embodiments, be able to contain, if needed, a custom programmable Script code. Empowering a Platform to be able to add, change and run custom scripts on-the-fly adds superior scaling and flexibility features to all the applications that our customers need as their operations grow and change. In some embodiments, these scripts can execute complex calculations and do various complicated Object, and Object Property, manipulations in the Server 100 system. This in turn may give any application real-time richness to adapt fast and perform efficiently complex operations serving Appward customers' needs. The advantage of Appward's scripting language and engine is that it may be comprised of mechanisms to integrate and work fully with the base Class and Object data models that all Appward's building block Object instances and Object Property instances are built on. Any system improvement in the base Object 3000 and Object Property 3100 class models can propagate to be used and leveraged in the scripting engine. Likewise, any system improvements in the scripting engine are used and taken advantage by all Object instances and Object Property instances.

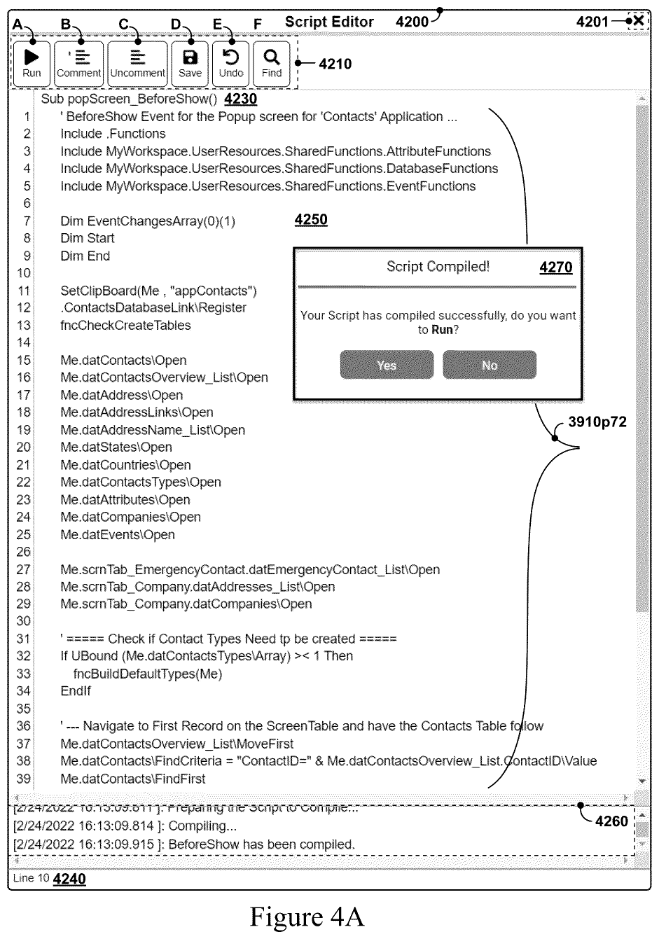

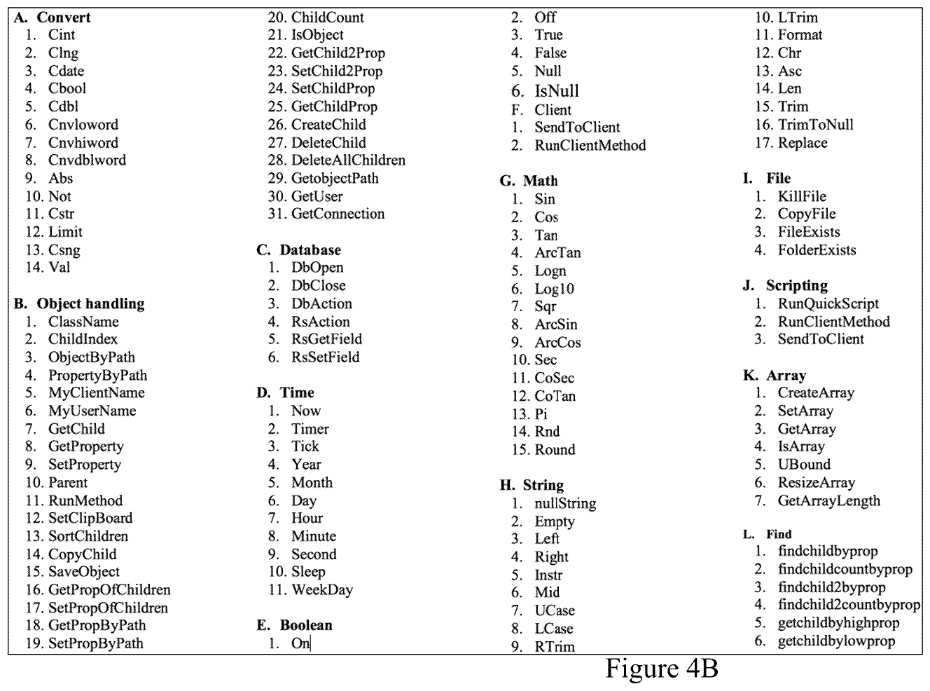

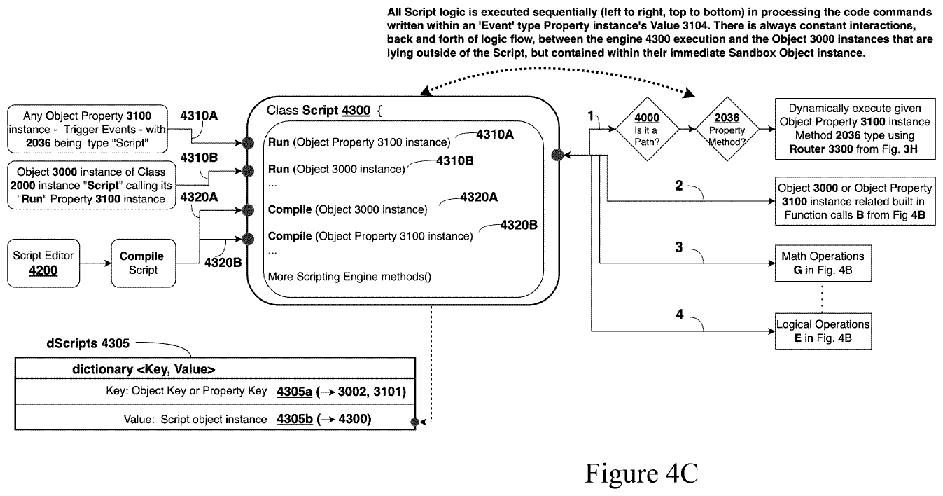

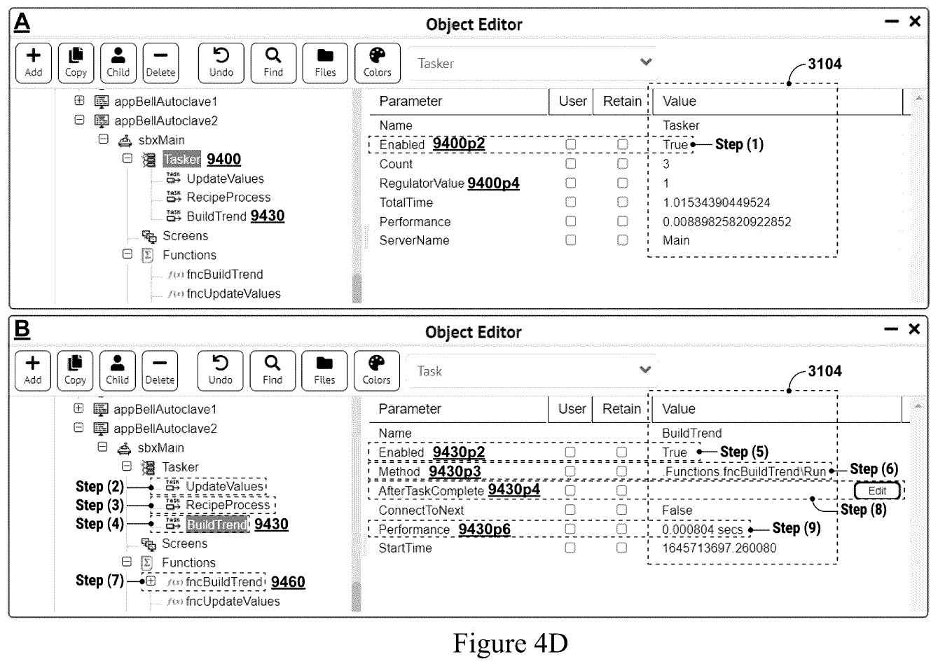

In some embodiments, Appward may have its own scripting language. A sample subset syntax of this language is shown in FIG. 4B. In order for a anyone to write a script, a Script Editor 4200 in FIG. 4A may be required and served by Appward's front end system as a user interface for coding. The script shown in FIG. 4A may be an Object Property 3100 instance of “Event” type that was previously mentioned in FIG. 3D, belonging to “popMain” 3910 Object 3000 instance. In some embodiments, this “popMain” 3910 has an “Event” called “BeforeShow” that may be fired every time this Screen Popup Object 3100 instance is about to be displayed and rendered within a web client screen on the front end within a browser. “BeforeShow” may be the 72nd Object Property 3100 instance, 3910P72, and the script itself is stored in the Value 3104 field of the said Object Property 3910P72. When a Script Editor 4200 may be closed (4201 icon) and there were changes made to the script, then the system will ask the user (coder) whether the script should be compiled or not. In FIG. 4A 4270 shows a sample notification of said “popMain” 3910 “BeforeShow” scripting compiling successfully. If the script had any warnings or errors, then those would be displayed in the debug section area in 4260 for the user to see and correct. Only compiled scripts can be executed on the Server 100 by the scripting engine 4300, FIG. 4C. Therefore, the compiler has an important role in making sure everything is setup and verified correctly in the internal script memory object at the Server 100 side. All scripts are executed ONLY on the Server 100 side, within the .NET framework (Appward does not have a client-side scripting engine nor a compiler). How this works, in some embodiments, starting with the compiler, is that every non-empty Object Property 3100 instance of “Event” type, “PropType” 2036, has a respective Script 4300 object instance, FIG. 4C, stored in a global dictionary, dScripts 4305, within the Server 100 system. Any Script 4300 instance may be keyed 4305a to its respective Object Property 3100 instance's Key 3101 within the dScripts 4305 dictionary. In some embodiments, Object Property 3100 instance's that have no Value 3104, empty scripts (empty strings), do NOT have a respective Script 4300 object instantiated for them because they do not have any script code, it's an empty text, to compile nor to execute. In some embodiments, the Compiler routine of the Script 4300 class has the following major responsibilities: a) Checks all entered Paths 4000 are valid (similar to the process from FIG. 3F in data binding mechanism in finding a Target object), b) Checks all variable and Alias declarations have no conflicts, c) Checks that there are no typos or misrepresentation in any one of the language syntax usages from FIG. 4B (Math operations, Logical operations, Data conversion functions, String manipulations, special file and database function calls, etc.), d) Checks that all loops and conditionals have proper matching start and end statements. If all these checks pass, then it will go ahead and build within its respective 4300 instance's memory: i) An internal stack of variables and object references, ii) A stack of commands used in the scripts and iii) a stack of calculation results. This sets the scene to be ready for this script 4300 object, related to an Object Property 3100 instance “Event” type, to be executed when triggered by the Server 100 system (from any source) or by any user at any Web Client 1200 front.

In either case, whether script compiled OK or not, the system allows for any new changes to be stored and saved at the respective Value 3104 of said Object Property 3100 instance, 3910P72, at the Server 100 side. In some embodiments, the Script Editor 4200 has a menu area with options to A run the script, B comment out scripts, C uncomment lines of commented scripts, D save the script, E undo any of the last changes, and finally do find and replace F capabilities within this said Script Editor. Every Script Editor 4200 has a header line 4230 displaying the script name, with parameters if any, which is always at the top containing the name of the Object Property 3100 instance's name, before the first line of any actual scripting. And all scripts close with at the end with an “EndSub” statement to indicate the end of the custom scripting function's code as shown in the Editor 4200. Additionally, every Editor has a body 4250 area that custom scripts are coded in by the developer, with each new line of code having its respective line number area (see 1 to 39 in FIG. 4A). For example, on line 32 the “UBound” script syntax may be used to return the upper bound array dimension of its input parameter, which in this case happens to be a relative Path 4002 targeting an Object Property 3100 instance containing an Array data type.

Just like other scripting languages, in some embodiments, Appward's scripting engine 4300 in FIG. 4C, may be comprised of operations as shown in FIG. 4B: math G operations, logical E operations, iterative (looping and recursive) operations, Resource management I with Files and Folders, Data conversion A operations, Database C operations, and it does a lot of different string H type manipulations. What is interesting about Appward's Scripting language is that, as mentioned previously, it is built to be fully integrated to operate with the base class model designs. This is clear first from the long list of Object 3000 and Object Property 3100 built in functions that the language handles, as seen in the sample list B of FIG. 4B, these comprise: Copying an Object 3100 instance B14, Deleting B27 and B28 an Object 3100 instance, Getting B7 an Object 3000 instance or its Parent B10, or one of its Object Property 3100 instance B8 and then setting B9 any to a value. Additionally, the language handles Paths, comprising: Getting an Object instance by Path B3, or an Object Property instance by Path B18, setting a value to a target Property 3100 instance by Path B19, etc. All these special scripting function B calls particularly take in Object 3000 and Object Property 3100 instances and manipulate them based on their function definitions. Some of the other functions take in a value and manipulate it, examples from A D G and H in FIG. 4B. Moreover, these sample functions, not being limited to constants, can also process the values passed from any Object Property 3100 instance's Value 3104 field.

Moreover, in some embodiments, to further illustrate the depth, flexibility and capabilities of the scripting engine 4300, in dealing with and manipulating various data: The engine has access to all global objects within the Sandbox that it may be contained within. By global objects, it is meant Object 3000 and their respective Object Property 3100 instances. And because said Object Property instances each can be of three different types (“Property”, “Method”, or “Event”), then the engine has access and capability to use and manipulate these Property 3100 instances in variety of configurations and combinations. For example, a “Method” Property 3100 instance of an Object, which may be related to a specific Class 2000 instance, with a specific business logic can be called from within a Script, see FIG. 4C lines 15 to 25 as a sample set of “Method” calls, to achieve particular needed operations within a given application for a given a customer need. The ones from 15 to 25, for example, open a database connection to the various data tables contained within their parent Database engine (MS SQL Server engine for example). This point, as in FIG. 4C 4300 engine case 1, shows how the scripting engine 4300 leverages its understanding of system Paths 4000 and may be able to call dynamically, on-the-fly using router 3300 from FIG. 3I, specific business logics, Class Property “Methods”, on individual Object 3000 instances to operate the application that they belong to. On the data storage and calculation front, again the scripting engine 4300 leverages the same data binding mechanism, covered previously in FIG. 3F, to connect to a target 4500 instance to get its value or set its value. See FIG. 4C line 38 where “datContacts” being an Object 3000 instance of “DataTable” Class 2000 instance type, after opening a database connection (line 15) from Server 100 to its actual external Database engine, it needs to set at its “FindCriteria” Object Property 3100 instance the have the correct filter, or Criteria, to accurately request records using a SQL query, which may be another characteristic of its container Object 3000 instance “datContacts”. On line 38, it is shown how “FindCriteria” Value 3104 may be set by concatenating (string manipulation) two strings with each other where one of them may be a constant and the other is gotten from another target 4500 instance's Property Value 3104 bound by a relative Path “Me.datContactsOverview_List.ContactID\Value” (representing the Column Value of another Data Table Object 3000 instance). Again, this point shows that the engine 4300 may be capable of accessing, using, and manipulating Object Property Instance Values 3104 containing different data types (“PropType” 2036 may be “Property”) at scale dynamically, on-the-fly, depending on needs and purpose of customers. Moreover, this latter capability is also true of handling Object Property 3100 instances of “Event” types (“PropType” 2036 may be “Script”). The scripting engine 4300 may be able to create or change the script code of another instance contained at another target 4500 Object Property 3100 Value 3104 field via using Paths and data binding. Note that target new script code, dynamically put together in code, when itself compiled for use, can have all the benefits of a regular script 4300 instance. This is an important feature where new scripts can be created dynamically, on-the-fly, based on the different conditions within an application. This feature can scale with the needs of users to serve or cover a more diverse and custom set of business requirements in real-time. This process may be covered as seen in FIG. 4C 4300 engine cases 2 and 3.

With the knowledge of scripting capabilities, we can see how Appward Paths, and their construction, are meaningful within the Server 100 system, due to the hierarchical nature of all the Objects residing in a tree. In some embodiments, the Server 100 system allows via scripting to construct any valid Path if the destination target is known geographically either by index under a certain parent Object instance (2nd Child, of the 5th Child or the 3rd Child from container Sandbox) or by name (“Contacts” Table's “FirstName” Column Object instance that lies under the Main Popup Screen “popMain” of “Employees” application). This dynamic construct for Paths, due to the nature of how they are formed and defined, gives the Platform flexibility to create Paths on-the-fly to get to target Object instances, check if they exist, and manipulate them once they are bound via said Path mechanisms to a Source 4400 Object Property 3100 instance. This is certainly the case when using a Script. It would be entirely possible to script completely new user interface and launch it for display where the icons (Labels, Texts, Images, etc.) are dynamically bound, to a certain data source, via the execution of said Script. For example, say there is a Label icon Object 3000 instance (“labell” under a popup screen) and it needs to be dynamically bound to a variable (“varTemp”, a sibling of “labell”) data source that contains today's local city temperature within a popup screen (part of an application). There are couple of ways to achieve this dynamic binding: Say this script may be written in the “BeforeShow” event of said popup Object 3000 instance, similar to FIG. 4A.

First, in some embodiments, if the stakeholder Object 3000 instance names are fixed, then we can script the following and it will accomplish the desired binding outcome: Me.label1\Value=“Me.varTemp\Value”

Second, in some embodiments, if the names of the stakeholder icon and data source Object instances are not known because they are dynamically created before the popup may be shown, then we can use some of the scripting functions B from the language in FIG. 4B to achieve this. For example, here's a script that can achieve this:
========
Dim L As ScreenLabel ' a local variable of Screen Label Class 2000 Instance type
Dim Var As Variable ' a local variable of Variable Class 2000 Instance type
Var=AddObject(“Variable”, Me, “varTemp”) ' create a new Variable Class Object 3000 instance under popup
L=AddObject(“ScreenLabel”, Me, “labell”) ' create a new Screen Label Class Object 3000 instance under popup
Dim ScreenPath
Dim VariablePath
ScreenPath=GetPath(Me) ' gets absolute path of this popup Screen
VariablePath=GetPath(Var\Value) ' gets absolute path of the Valiable Value Property instance
L\Value=Replace(VariablePath, ScreenPath, “MyParent”, 1) ' Convert Variable Path to a relative Path
========

In some embodiments, upon launch and display of the popup interface, at any web client, the Label icon will show the target's value. And as the temperature value changes during the day, because of this dynamic binding, the label will show the updated temperature due to its binding to said data source.

Subsequently, in some embodiments, the Script Engine 4300 also offers the advantage and flexibility of late binding. Late binding allows scripts and script functions 9240 to be modular and general in order to fit the needs of different callers (applications and Client 1200s). The way late binding works may be that it utilizes Script Function 9240 Parameter Object 3000 instances (of Class 2000 instance “Script Parameter”). The business logic within “Script Parameter” Class 2000 allows the Client 1200 to indicate what type of Object 3000 instance the Script Function 9240 should expect as an incoming parameter from one of its callers. This allows the Script Function 9240 to be built and compiled without yet having the actual Object 3000 instance that it will execute on when called. Since the Parameter of Script Function 9240 indicates the Class 2000 instance of the Object 3000 that Script Function 9240 is expecting, then Script Function 9240 can utilize the Class Properties 2030 of that Class 2000 in order to build and compile that Script Function 9240 accurately and have it ready for use. This further promotes the quick, on-the-fly application development within the platform since the actual Object 3000 instance does not yet need to be built at the time the Script Function 9240 may be built and compiled, the Object 3000 instance will only be used when the Script Function 9240 is called. When the Script Function 9240 is called, the different callers of the function would pass an Object 3000 instance as the parameter for the Script Function 9240 matching the Class 2000 instance of the parameter that the Script Function 9240 needs. The Script Function 9240 can then execute the respective logic defined within it on the specific Object 3000 instances that are sent from the callers, manipulating the Object 3000 instance, and returning data back to the caller if necessary. The following Script Function 9240 demonstrates this process:
========
1—fncSetDimensions_OnRun (Popup As ScreenPopup)
2—Popup\Left=MyWorkspace.scrnMain.scrnAnchorArea\Left
3—Popup\Top==MyWorkspace.scrnMain.scrnAnchorArea\Top
4—Popup\Width=MyWorkspace.scrnMain.scmAnchorArea\Width
5—Popup\Height=MyWorkspace.scrnMain.scrnAnchorArea\Height
6—RunClientMethod (Popup\Update)
7—EndSub
========

The above function, in some embodiments, can be called by multiple different Clients 1200 and applications in order to size and position an Object 3000 instance of Class 2000 “ScreenPopup” based on each callers configured area (“scrnAnchorArea” Object 3000 instance of Class 2000 instance “ScreenAnchorArea” in this case) to show various ScreenPopup Object 30000 instances within. Starting with line 1, the above Script Function 9240 passes a ScreenPopup Object 3000 instance that is of Class 2000 instance “ScreenPopup” as its parameter with the name “Popup”. Then within the subsequent lines (2-6), the Script Function 9240 manipulates the passed “Popup” 3000 instance and sets its positions and dimensions according to the view size of the “scrnAnchorArea” Object 3000 instance that the associated calling Client 1200 has set up within their screen. This “scmAnchorArea” Object 3000 instance could be configured differently than what another Client 1200 may have, yet the different Clients 1200 can call this same Script Function 9240 in order to fit their associated ScreenPopup Object 3000 instances within their specific defined views. Finally, in line 7, the “Update” Object Property 3100 “Method” will be called. In some embodiments, the “RunClientMethod” function that is used in this case to call the “Update”, may be a special function that illustrates a powerful feature of the Script Engine 4300. It provides the functionality to trigger a client-side event from within Server 100. In this case, it allows the script to route back to the calling Client 1200 and have the system trigger an update method call of the associated ScreenPopup, in order to reflect the changes on the “Popup” Object 3000 instance (from lines 2-6) for the calling Client 1200 This ends up displaying the final positions and dimensions of the “Popup” Object 3000 as the Client 1200 intended. The “RunClientMethod” is a powerful function which provides the advantages of running functionality on the Client 1200 side from within a script that may be executing on the Server 100 side all within the same script execution. A function, such as “fncSetDimension” from the above example, could be injected within any “BeforeShow” Script of a ScreenPopup Object 3000 instance, in order to have the associated ScreenPopup Object 3000 instance configure itself to the calling Clients 1200 “scrnAnchorArea” size, before displaying the ScreenPopup Object 3000 instance for that Client 1200. This is the versatility and modular behavior that is an advantage of late binding, and it can be used to write one Script Function 9240 that can be reused by various applications and Clients 1200 passing their own Object 3000 instances as parameters to the Script Function 9240, instead of repeating the same code within each and every caller. This is one feature that takes the on-the-fly application building reality within the platform a step further, since it utilizes existing building blocks which are the Script Function 9240 Object instances, essentially forming a library of run time functions, which are then seamlessly leveraged to build out new applications or update existing ones in real-time.

Additionally, in some embodiments, it is important to note that when it comes to all Script executions within the Server 100, that concurrency issues are also properly dealt with as they are in the base class models of Object 3000 and Object Property 3100, shown previously in FIG. 3J. The class data fields “LockObject” 3012 and “LockProp” 3109 similarly during Script execution use the “Locking” concept in computer programming (SyncLock within .NET framework) to make multithreaded application processing a reality. In some embodiments, there may be more than one way where a concurrency issue can occur in scripting due to multiple Clients, each with their own independent thread, running different Script 4300 objects, via different container Object 3000 instances, that end up processing the same target 4500 Object Property 3100 instance at the same time. In this situation, as demonstrated before from FIGS. 3A and 3J, the “LockProp” 3109 file of that said target 4500 Object Property handles the queuing process between the two Web Clients, and their Scripts that are in execution. Another scenario as seen in FIG. 3J, where a web Client3 1213 is running, step 3, function “OpenApp” 9240 Object 3000 instance that opens and shows the application Object 3000 instance that is passed to it (via its Function parameter) to the requesting Web Client 1213. While this 3 is in process, at the same time a second web Client 1214 may be trying to the same thing, step 4 with using the same “OpenApp” 9240 function Object 3000 instance at the Server 100 side, say to launch another application. It is shown that 4 has to wait for 3 to complete with the return of 3A response from Server 100 back to web Client3 1213. Only after the return of 3A web Client4's 1214 actual action starts 4A taking place at the Server 100 side in running the same script Function 9240 Object 3000 instance and finish 4B in returning back its response to its web Client 1214. This shows that scripts and their respective container Object 3000 instances (if it's a Script Class 2000 Instance references) or container Object Property 3100 instances (if it's an “Event” PropType 2036) do control multithreading properly between multiple Web Clients, even when it comes to executing custom scripted code in runtime.

### Tasker Class 2000 Instance

There is another noteworthy feature that is available within Server 100 which is fundamental for the controlled, repeated execution of Object Property 3100 instances that are of type “Method”, Script Functions 9240, or Script Object 3000 instances. In some embodiments, this is made possible through the business logic that may be embedded within the “Tasker” and “Task” Class 2000 instances. A Tasker Object 3000 instance (of Class 2000 instance “Tasker”) makes it possible to execute any script or “Method” Object Property 3100 one or many times at a specified interval without relying on any event triggers by a Web Client 1200 (such as mouse clicks, key entries, etc.). This provides the powerful and flexible feature of having Server 100 repeatedly execute tasks, without needing any sort of Web Client 1200 interaction. Furthermore, any Tasker Object 3000 instance utilizes the multi-threaded reality of Server 100 and runs on its own unique thread within Server 100, meaning that it is not tied down to any Web Client 1200 thread or any other Tasker Object 3000 instance thread. Through this multi-threaded structure of Taskers, it is possible to have multiple taskers running at the same time and performing a variety of different operations, executing methods or scripts, without waiting on one another, and without ever interlocking with other Tasker or Web Client 1200 threads. Another note regarding Tasker Object 3000 instances may be that as long as the “Enabled” Object Property 3100 instance of a Tasker Object 3000 instance may be “True”, the Tasker Object 3000 instance will start running as soon as all objects are loaded within Server 100 memory upon Server 100 launch (refer back to FIG. 1 for Server 100 launch details). The Tasker 3000 Object instance will stop executing whenever the Tasker Object 3000 instance's “Enabled” Object Property 3100 instance may be set to “False” or when said Tasker Object 3000 instance gets deleted.

In some embodiments, the structure of a Tasker Object 3000 instance and the steps it goes through to execute its functionality may be illustrated in FIG. 4D. In FIG. 4D diagram A, a Tasker Object 3000 instance is depicted as 9400. Note the Tasker 9400 has children Task Object 3000 instances (Of Class 2000 instance “Task”), the last one of them being the Task 9430 Object 3000 instance that FIG. 4D diagram B will focus on. Also, note the Object Property 3100 instances for Tasker 9400 that are illustrated. In some embodiments, during Step (1) of execution the “Enabled” 9400p2 Object Property 3100 of Tasker 9400 will be checked first since it represents the on and off switch for a given Tasker Object 3000 instance. If “Enabled” is “True”, then the Tasker 9400 will run to execute associated functionality within its own thread. If “False”, the tasker will be considered turned off, in which case it will no longer execute any functionality. The “RegulatorValue” 9400p4 Object Property 3100 instance of the Tasker 9400 defines the interval (in seconds) at which the Tasker may be running at. If for example 9400p4 Value 3104 may be 60, then the Tasker 9400 will run every 60 seconds, if it is 0.25, then the Tasker 9400 will run every quarter of a second to execute the defined functionality. The functionality that the Tasker executes may be based on its Children Task Object 3000 instances, which it iterates through in order or in sequence and executes the associated logic defined within them, as seen in FIG. 4D diagram B.

In some embodiments, FIG. 4D diagram B illustrates one of the Task Object 3000 instances that may be a child of the Tasker 9400 Object 3000 instance from diagram A. As said, the Tasker 9400 may be continuously running based on its “RegulatorValue” 9400p4, when it is running it may be looping through each of its Children Task Object 3000 instances and executing their defined logic, this is depicted by Steps 2, 3, and 4. Step (4) starts with the execution of the “BuildTrend” Task 9430 Object 3000 instance. Diagram B illustrates the inner workings of this Task 9430 to detail how logic execution occurs within a Task 3000 Object Instance. Step (5) illustrates that once more, the “Enabled” 9430p2 Object Property 3100 instance of the Task 9430 may be checked, since it defines if the Task 9430 Object 3000 instance will execute or not. The Task 9430 will only execute if “Enabled” 9430p2 may be “True”, otherwise it may be skipped when the parent Tasker 9400 is running. Next in Step (6), the “Method” 9430p3 Object Property 3100 instance of Task 9430 is called, which defines any logic or function that needs to execute for this specific Task 9430. This is the core functionality that the Task 9430 may be executing. The 9430p3 Object Property 3100 allows for a Path 4000 entry, in which case the 9430p3 Object Property instance may be being utilized as a Source 4400 that may be pointing to a Target 4500 which indicates the location of the functionality to execute. In this case, as noted by Step (7) it may be pointing to the “Run” Object Property 3100 “Method” instance of the Script Function 9240 called “fncBuildTrend” (shown as 9460 in FIG. 4D diagram B). This will trigger the associated Script Function 9240 to execute the logic defined within itself. Afterwards in Step (8), the Tasker 9430 will execute the “AfterTaskComplete” 9430p4 Object Property 3100 which may be of type “Event”. If there is a custom script defined within Object Property 3100 instance 9430p4, then the Tasker 9400 will execute that logic as well and complete the given Task 9430. In Step (9), after the Task 9430 may be completed, the Tasker 9400 will log the Task 9430 instance's performance, or the time it took to execute that Task, under the “Performance” 9430p6 Object Property 3100 of the Task 9430p4, to be evaluated by a Web Client 1200 when necessary. The Tasker 9400 will then wait for its next interval defined by the “RegulatorValue” 9400p4 to elapse, in order to start the process over, iterating through its Task children Object 3000 instances and executing their defined functionality.

Ultimately, in some embodiments, Tasker Object 3000 instances provide the benefit of automating numerous, repeatable processes that may not be feasible for a Web Client 1200 to perform. Few examples of this are: 1) A Tasker Object 3000 instance that may be used for monitoring I/O (inputs/outputs) on a piece of machinery and storing the monitored data onto an Array every minute. This array could then be utilized by a “ScreenChart” Object 3000 instance of Class 2000 “ScreenChart” to plot trend data over time based on the data that the tasker feeds it. 2) An application that maintains a queue of notifications, alerts that are useful for connected Web Clients 1200 to see. These can include messages stating that a new application or a new version of an existing application has been released, etc. The notifications application can utilize a Tasker Object 3000 instance to retrieve a list of all active Web Clients 1200 that are logged into the platform at the current time the Tasker Object 3000 instance may be running and push out any new notifications from the “notifications” application every hour to those Web Clients 1200 screens. 3) Taskers can also help measure the performance of the scripts, Script Functions 9240, and Object Property 3100 “Methods” over time. For instance, a Web Client 1200 can use a Tasker Object 3000 instance to run a Script Function 9240 every 10 seconds for hours on, to see how different factors affect the Script Function 9240 performance throughout the day, in order to uncover any performance issues within applications, etc. 4) A Tasker Object 3000 instance can be used to automate daily reports from employees, where a report could be generated and emailed to managers containing the finished tasks of employee for a given day. 5) A Tasker Object 3000 instance can be used within an email centered application, where the tasker would retrieve any new emails for said Web Client 1200 based on the frequency they set (every minute, every hour, etc.) and notify them by sending a notification to the awPage that said Web Client 1200 is viewing.

To conclude, as shown, on the Server 100 side system benefits: All Object (3000) instances that represent fully built applications, with all their building blocks and subsystems, are loaded entirely into run time dynamic memory. Everything that is served to end users, web Clients, may be obtained straight from live memory. There is no need to get things from a database, launch an app, and then put said data together with some web files (HTML, CSS) before serving it to Clients. Appward saves time and makes web service faster with its fully loaded object-oriented hierarchical data model, applications, that are ready to be served for usage all the time to any client. The same is true when using these applications, since all interactive elements with their business logics are loaded into memory, then these interactions end up processed faster and the responses with data updates are faster. The applications from launch to use to closure ends ups being all around faster and more responsive. And this is even truer with the Web Server and the Client-side systems that serve and utilize this Server-side Object (3000) hierarchy at the front end. With this said, next, the second major Appward System is discussed in detail.

### Appward's Web Server and how it Connects to any Client

There is no on-the-fly configuration of applications and usage of those said custom applications by end-users if there is no WebServer 1000, from FIG. 1, that serves an entire Client system 1200 of end users to enable such access and capabilities. So, it is important in these next sections to discuss the details of Appward Server's 100 WebServer 1000 mechanism with all of its comprised components that enables the connection of said end-users, via Web Clients 1200, to be fully integrated and given access to the object-oriented structures, Object 3000 and Class 2000 instances, that the Server 100 platform contains as an axiom for dynamic on-the-fly manipulations, configurations and usage.

In some embodiments, the WebServer 1000 may be comprised of the following main components as seen in FIG. 10A: 1) The HTTPS Server 1010, 2) The WebSocket Server 1020, 3) Dictionary of active Client 1100 connection instances, 4) and the Appward's own Remote Procedure Call (RPC) 1150 syntax and routing mechanism.

Before we get into the details of each of the said WebServer 1000 components, it's worth mentioning that said WebServer 1000 instance, with all of its components, may be created during the launch of Server 100 as the Platform boots up, as mentioned before with FIG. 1. The WebServer 1000 instance may be based on the data structure model presented in FIG. 10B. The first thing that WebServer does when it is created is to setup both of its internal components, HTTPS Server 1010 and WebSocket Server 1020, to be ready and actively listening for new incoming Web Clients 1200. Successful active listening entails checking first with the Server's 100 hardware to ensure the necessary TCP/IP addresses and ports are available and reserved for said two components of the WebServer 1000.

In some embodiments, when the HTTPS Server 1010 is created, it spins off its own independent Thread 1001 instance and listens continuously to any incoming new Web Clients 1200 at its own specific HttpPort 1003 field. This said server 1010 contains its own HTTPS security certificate 1008 that it will share with any new incoming Web Client 1200 to upgrade them from unsecure HTTP mode to more secure encrypted HTTP (HTTPS) communication one. At the same time, during said Server 100 launch, the WebSocket Server 1020 may also be created, as mentioned above, and it also spins off its own independent Thread 1021 and starts listening to any new incoming web socket connection that will occur once a Web Client 1200 application system completes its loading process, more details on this in subsequent sections within the Client-side system application details.

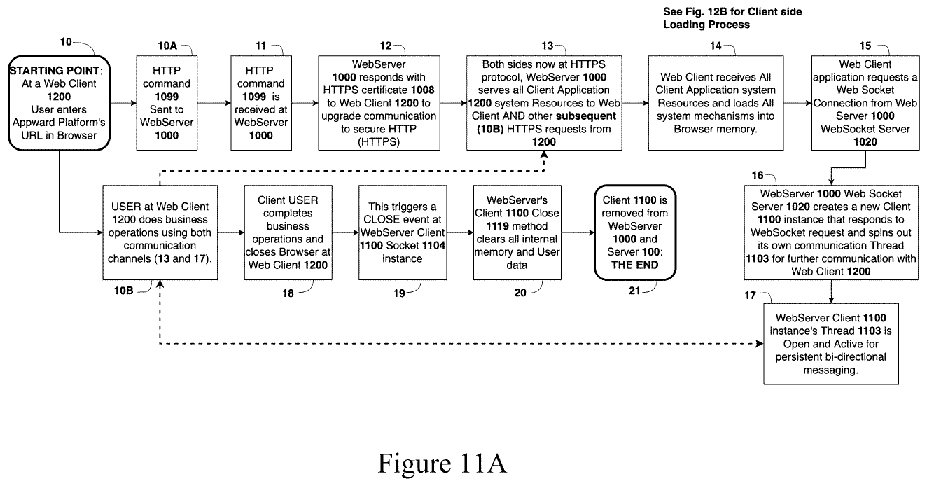

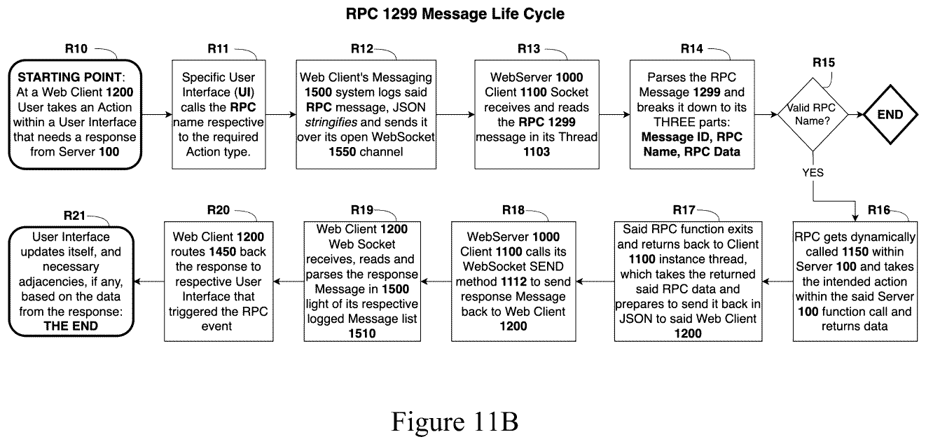

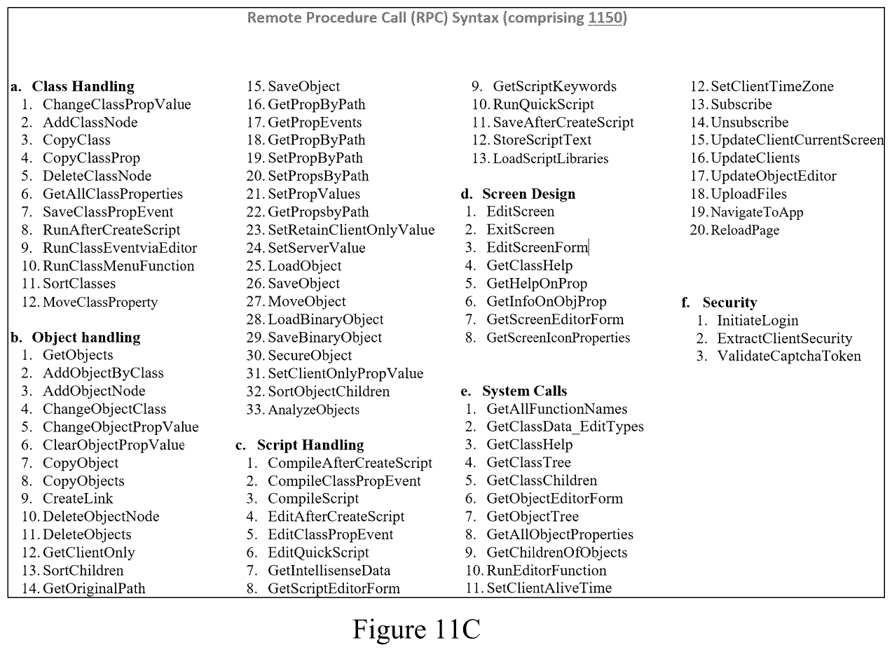

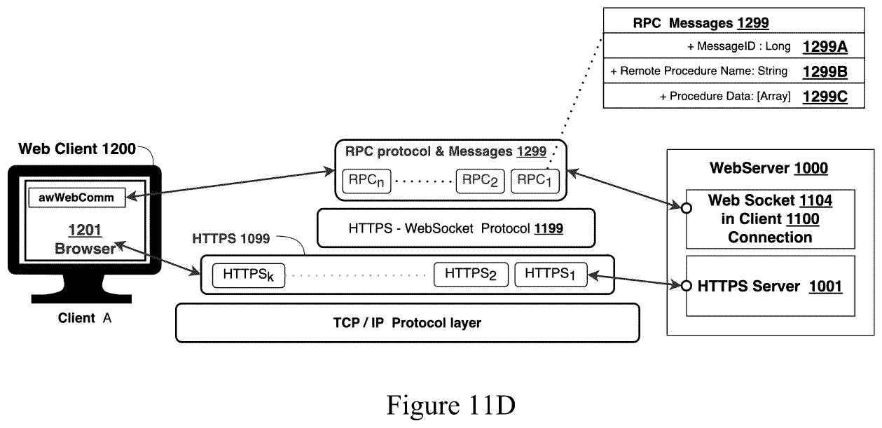

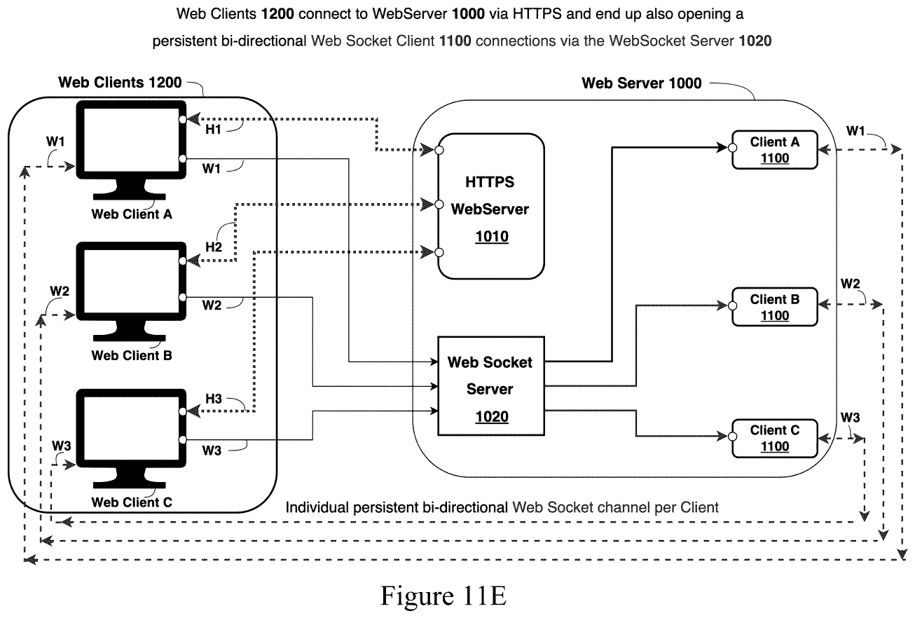

In some embodiments, the flow of logic, as seen in FIG. 11A, when a new incoming Web Client tries to connect to the Appward WebServer 1000 may be as follows: An end user upon entering the web address 10 for Appward's platform within any browser at a Web Client 1200, the browser then will fire a HTTP 1099 command directed to the WebServer 1000 physical address location 10A, due to DNS routing, requesting a resource (usually asking for an HTML file or page). The HTTPS Server 1010 will receive and read the incoming HTTP command 1099 within its own thread routine (11). In order to make the Client-Server connection secure, the HTTPS Server 1010 will first respond back to the Web Client 1200 browser its SSL Certificate, contained at 1008, which after completing back and forth the SSL handshake the existing communication will be upgraded to a private secure session (12). Both sides now having a secure HTTPS connection, the HTTPS Server 1010 starts serving all the Client System application resources (13) (resource web files—more details on this in subsequent sections) and the Web Client's browser upon receiving all of said resources, FIG. 1 1900, loads all the internal client systems into memory within browser (14). Upon completion of loading said Appward's Client System application within a web browser at Web Client 1200, said 1200 may be designed to request to open a WebSocket connection (15) back to the WebServer 1000. The WebSocket Server 1020 will receive this request, which internally within its Thread 1022 routine will trigger to create a new Client 1100 instance (16) within the WebServer 1000 system, stored at the shared Clients dictionary 1050. This said Client 1100 instance creates its own Thread 1103 and using its own Socket 1104 instance responds back to the Web Client 1200 request in opening, web socket protocol based, a persistent bi-directional communication channel (17). This makes the WebServer 1000 Client 1100 instance have an independent thread of its own to actively listen to future incoming WebSocket messages, using ReceiveMessage 1111 routine, or send out messages, via SendMessage 1112 routine, to its connected Web Client 1200 counterpart. Because of this architecture each Client 1100 connection may be independent from one another within the WebServer 1000 system, and it makes WebServer 1000 a multithreaded multi-Client application. At this point, HTTPS Server 1010 and WebSocket Server 1020 have completed their logic flow in establishing a secure connection to said new Web Client 1200 that has two routes of communication with its WebServer 1000. At this point the end user may be seeing and interacting within the Appward interface and conducting needed operations based on the user's business needs (10B). During said user interactions within the Web Client 1200, the Client System can get or set data from either mode of communications, depending on the type of need, meaning: For any file Resource 1970 needs, as seen in FIG. 1 said resources are local to the WebServer 100, the system uses the HTTPS Command 1099 route (13). For dynamic live data within a give user interface, the Client system uses the open persistent WebSocket channel route (17) to get or set Screen related live data from Server 100. Said Screen data are gotten from Server 100 object-oriented hierarchical Object 3000 instances by using the pre-defined Remote Procedure Calls (RPC) 1150 class mechanism, that exist within Server 100 as shown in FIG. 10A. These said RPCs are triggered from the Web Client 1200 to the WebServer 1000 Client 1100 instance's Socket, see below more on RPCs on how this works. Now when the user finishes his/her work and exits Appward by closing Browser (18) at Web Client 1200, this triggers a “Close” event (19) at the WebServer Client 1100 instance's Socket 1104. Using this Client 1100 instance's said “Close” 1119 method, custom user data with other internal object memory may be cleared from the WebServer 100 system (20), and then the Client 1100 instance itself may also be removed from memory (21) being sent to the operating system's garbage collector. This concludes the life cycle of a Web Client 1200, and in turn a Client 1100 instance's too, as it connects to Appward's WebServer 1000, gets, uses and manipulates custom specific one or more said applications, including their building block 3100 Object instances, and do certain tasks and then disconnect its Client upon completion.

This covers the details on the structural and physical networking modes that Appward Client-Server connections enjoy. Moreover, in some embodiments, the protocol layer that works above this bridge to make the Client-Server connection semantically and efficiently work is mostly through the utilization of RPC Messages 1299 between the two end points of said connections. RPCs, Remote Procedure Calls, which is common in distributed computing, may be used in Appward effectively over said WebSocket 1199 protocol, as shown in FIG. 11D. As mentioned before, said WebSocket channel when connecting two ends, Client and Server, enables a persistent open bi-directional data transfer medium between said two end points. This is more efficient way of serving data to Web Clients than just HTTPS medium. Therefore Appward, as it will be shown in detail, utilizes this reality to serve Web Pages, Web Applications, and many more System and User live and dynamic data to empower custom rich usage and configuration of apps all in real-time. An RPC, as shown in FIG. 11D, may be JSON formatted data object comprising: 1) Message ID, which may be a ID uniquely identifying every message during the entire Client-Server connection lifetime, 2) The Name of the Remote Procedure called from Web Client 1200 that will occur at the Server 100 side, and finally 3) the Data set that this particular Procedure call will need, to execute properly, as it is passed to it dynamically as a parameter.

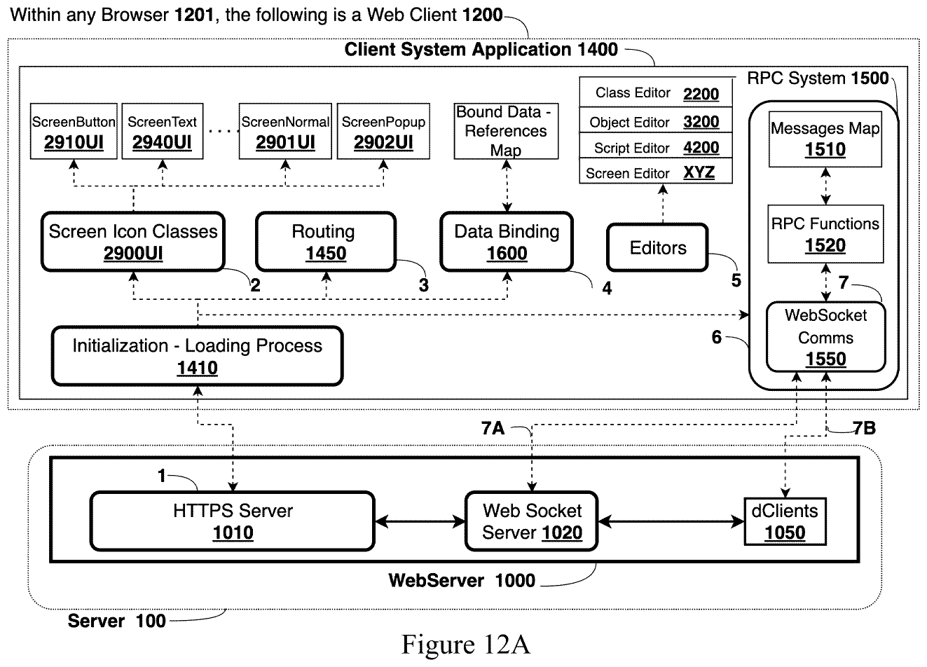

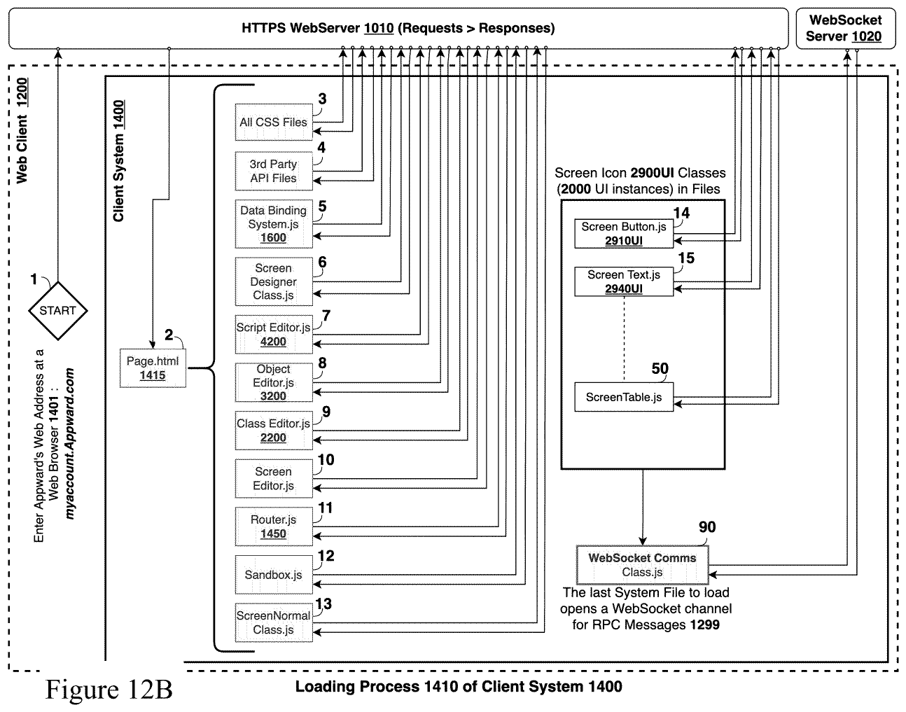

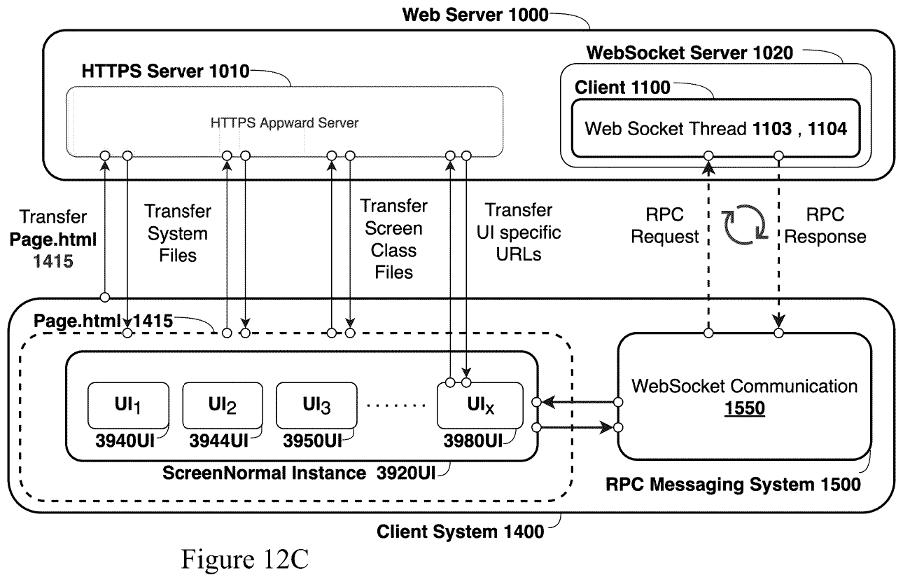

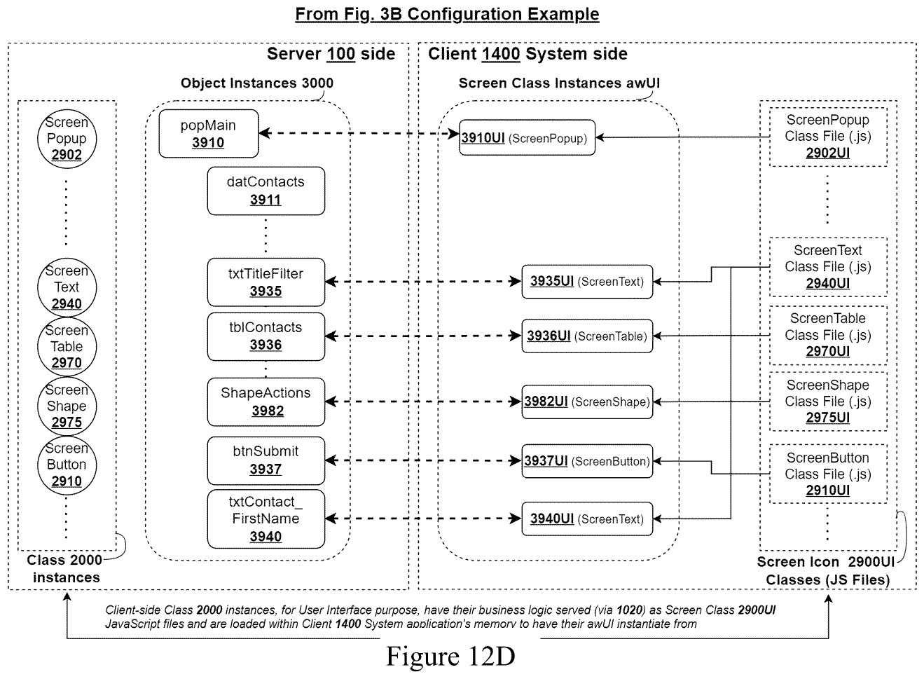

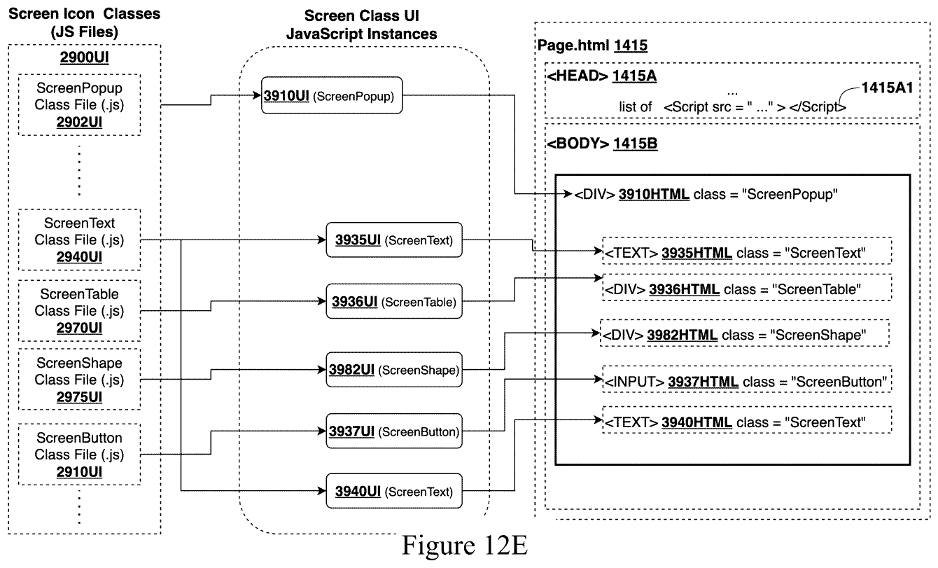

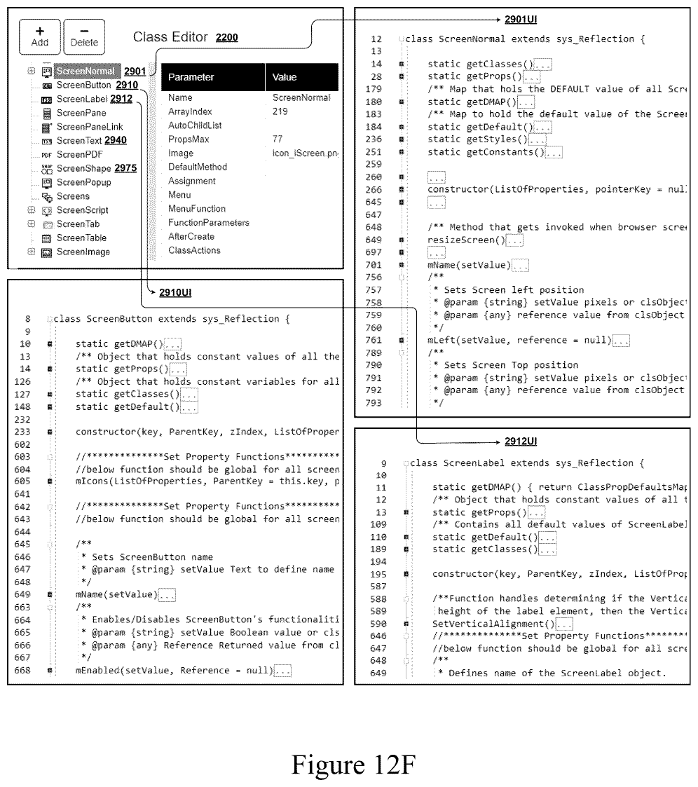

In some embodiments, the flow of all said RPC messages 1299 between a Web Client 1200 and a Server 100, as seen in FIG. 11B, is as follows: Whenever any end user is within an Appward Web Client 1200 performing any work in said application, in general that usage may entail the triggering of Remote Procedure Calls (R10) from that said Web Client to the Server 100 in order for any action to be completed in responsive manner (whether that action is navigating to a new Screen, or typing a text to a filter a Table, or clicking on a menu button). So, whenever an RPC 1299 Message is fired, due to a user action, the RPC Message that is comprised of said 3 parts, as mentioned above and in FIG. 11D, will be formatted in JSON and send over the open WebSocket Web Client connection (R12). This same exact RPC Message may be received and read by its respective WebServer 100 Client 1100 instance's Thread 1103 (R13) and then parsed out (R14) to its three base components on the Server 100 side, WebSocket Server 1020. As mentioned above, the RPC Name needs to be validated (R15) first before it can be dynamically called by the RPC mechanism, 1150 in FIG. 10A. If the RPC Name exists, the routine function to be called, then the 1150 system makes a dynamic call (R16), using .NET's system reflection library, to get to the specific RPC function within the RPC Class 1150 in Server 100. The execution of this function may be an exact match of what the user interface specific action needed at the Web Client 1200. When the routine is completed it always returns a data object upon exiting that said RPC function (R17). Because the dynamic call in (R16) occurred within the Client 1100 instance's thread, upon returning the data from the RPC function, the Client 1100 instance formats said data object back into JSON and then uses the “SEND” method 1112 of the WebSocket to transfer back (R18) the response data from the WebServer 1000 back to the Web Client 1200. When the Web Client receives and reads the RPC response data, it parses the incoming Message and interprets it (R19) based on the original RPC event object, including its meta data stored all at a Message Map log queue on the Client System. The response data with its Message meta data will then be able to route back (R20) dynamically to the specific User Interface item that triggered the original event and make the necessary update (R21) to itself and its dependencies, if needed. See in subsequent sections more information on how the RPC Messaging 1500 system and the Routing 1450 system work on the Client 1400 system side (FIG. 12A). This concludes the journey that any sample RPC message which may be created at the Web Client 1200, goes to the Server 100 to make specific changes, within the Scope of said Client's Workspace, and then return back with a respective response data to complete the handshake and make necessary adjustments at the Client side as part of a responsive live and dynamic mechanism. This, and all RPCs as mentioned before, using the open bi-directional WebSocket channel for communication between Appward Client and its Server.

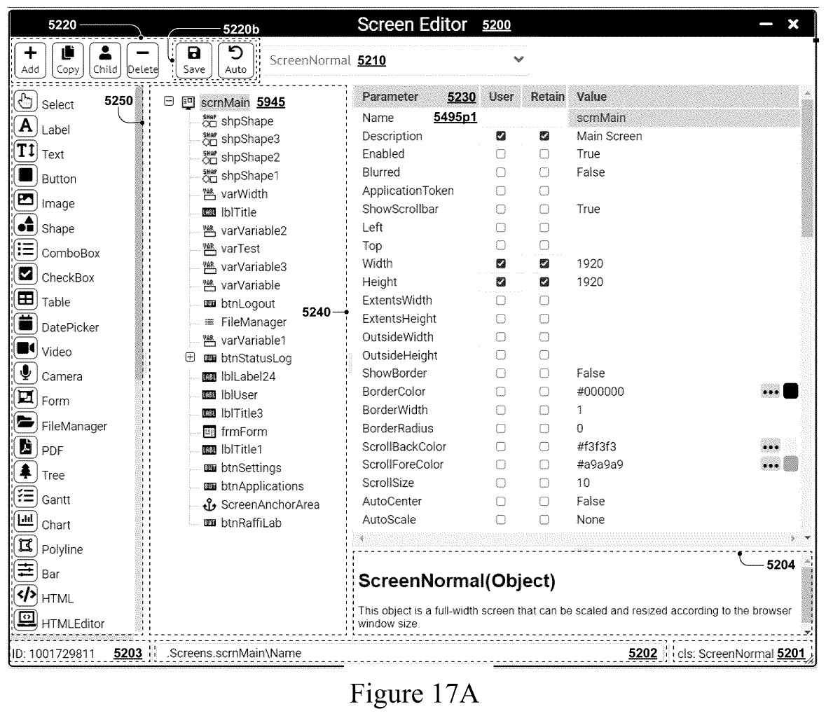

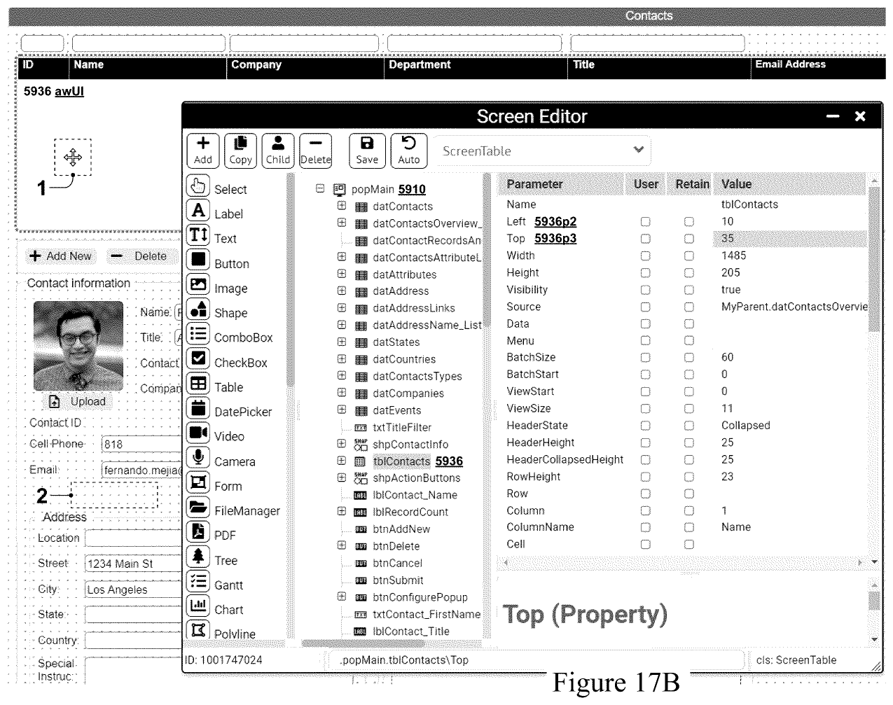

In some embodiments, there may be many types of actions that a Web Client needs to take during its lifetime connection as the user may be launching different applications and performing various types of activities within said applications that said user had access to. FIG. 11C shows Appward's list of RPC syntax, and in a way its Client-Server communication language, which shows at a glance all the different capabilities that are available for a flexible, rich and full Client-Server experience. The most commonly used RPCs are “SetPropByPath” (b19), “RunQuickScript” (c10), “AddObject” (b2 and b3), “DeleteObject” (b10 and b11), and “ChangeObjPropValue” (b5). The first two, b19 and c10 may be heavily used by Screen widgets whenever they are taking an action to change a Property Value (Object Property 3100 instance Value 3104) or call a Property Method (same as prior but “PropType” 2036 of “Method”) by using the Path data binding format. While c10 may be an RPC that fires an Event containing a Script at the Server 100, using Script Engine 4300, based on the user action at a specific widget. See next section for a detailed real-life example on these two RPCs. The above recited last three popular RPCs are more commonly fired when designing and configuring Object 3000 and Object Property 3100 instances within the Object Editor 3200 in building new applications on-the-fly or updating existing said application user interfaces via Screen Editor 5200 (FIG. 17A) by end users within a Web Client 1200.

FIG. 3B showed a sample user interface application 3910UI that contained a text box icon 3940UI that was the rendering of an Object 3000 instance 3940 of Class 2000 instance ScreenText 2940, as shown in FIG. 2D, after being sent over from Server 100 to a Web Client 1200 application. To show how the above said popular RPCs (b19 and c10) are utilized in making said text box icon 3940UI interactive, functional and responsive to serve its purpose within said application (3910UI). So, for example, if the user wished to change the existing “Value”, Object Property 3100 instance Value 3104, of the currently displayed text in 3940UI from “Raffi” to “Dave”. Then upon typing “Dave” to replace the existing Value within the textbox (“Raffi”) and pressing the “Enter” key to submit the new text to the Server, the Web Client will take the following actions based on its Class 2000 instance 2940 ScreenText business logic: 1) Upon detecting a new text entry, within 3940UI HTML Text Element by pressing “Enter” key, the ScreenText Class 2000 instance 2940 will fire a “SetPropByPath” (b19) RPC. This RPC will have its unique Message ID (say 555, indicating usually that this is the 555th message between this particular Web Client and its respective Web Server Client 1100 instance since the inception and opening of the WebSocket channel), the RPC name may be given by b19, and finally the RPC data associated with b19 structured in an array [Property Path of 3940 Value, The new text Value entry, The caller Icon Object 3000 instance 3940 Key 3002]. This may be what this said first RPC message fired from the Web Client would look like in a JSON format=

{
ID : 555,
Name: “SetPropByPath,
Data: [ “.popMain.txtContact_FirstName\Value”, “Dave”, 123132233)]
}

In some embodiments, following the process logic flow mentioned in FIG. 11B, this Message will be picked up at the Server 100 side by the respective Client 1100 instance. After parsing the message the Client 1100 will call the “SetPropByPath” function in 1150 class and set the Value 3104 of Object Property 3100 instance located by the Path (“.popMain.txtContact_FirstName\Value”) to “Dave” within the Server 100 memory. Now this new text entry value may be set within the entire Server 100 Platform. Afterwards, the response data object for this RPC, in this case a simple a simple Boolean “True” value indicating successful setting, returns back (with the original Message ID) to the respective connected Web Client 1200 instance in JSON format. And the Web Client in turn receiving the incoming response completes the full RPC cycle by routing dynamically the data back to the caller Icon (Screen Text 3940 Object instance) to update itself (rendering in this case the new text entry value “Dave” on the displayed screen). Now, as it was shown in FIG. 2F, ScreenText Class 2000 instance 2940 as part of its Class characteristics has another Class Property 2030 instance 2940P36, called “OnChange”, that may be an “Event” type (PropType 2036). This event may be triggered whenever any Object 3000 instance of ScreenText Class type has a change in its Value, Object Property 3100 instance 3940P36 Value 3104 field. So, this brings us to the firing of the second RPC Message at said Web Client, immediately right after processing of the first RPC (“SetPropByPath”). All client-side user-triggered events are sent to the Server 100 to be executed by the scripting engine by utilizing the “RunQuickScript” RPC (c10). Similar in format (JSON) this RPC will have its unique Message ID (556 because it may be immediately fired after the first RPC), the RPC name given by (c10) and the data for this specific RPC, which for (c10) would be [The Object 3000 instance 3940 Key 3002, The Property 3100 instance Name of the “Event” being executed, The needed parameter values, if any, for the specific “Event” instance]. The RPC data format, order and count needs to match exactly the definition of this “Event” Class Property 2030 instance 2940P36 (“OnChange”) at the Server 100 side. In this “OnChange” 2940P36 may be expecting one parameter value and that is the new text entry value. Here's what the JSON RPC Message would look like for ScreenText 3940 Object instance's “OnChange” RPC c10:

{
ID : 556,
Name: “RunQuickScript,
Data: [123132233, “OnChange”, [“Dave”] ]
}

In similar process logic and data flow, as mentioned in FIG. 11B, in some embodiments, this Message (556) may end up calling the “RunQuickScript” (c10) function within Server 100 that in turn finds the Object Property 3100 Event instance 3940P36 and executes its custom contained script logic by running through the scripting engine 4300 system. Once the custom script contained within 3940P36 completes logic execution, the (c10) function exits and returns custom data (depending on what was scripted in 3940P36 to return to the respective application to the respective Web Client) back to the Client 1100 instance Thread 1103, which in turn may send it back to the Web Client 1200 over said connected open WebSocket channel. Once at said Web Client end, said RPC (c10) may be similarly processed and routed back (as in the b19 case) to its origination icon caller, trigger point, ScreenText Object 3940UI for a final update based on the custom response data contents. What is interesting with “RunQuickScript” RPCs (c10) is that the response content data can and may have custom follow up updates of its own that the Web Client system might want to execute additionally. For example, referring back to FIG. 4B for scripting language commands, if “SendToClient” J3 was scripted to return back specific data (say changing the “Visibility” Property Value of a ScreenButton “Submit” icon 3937UI object instance from “False” to “True”) pertaining to that specific said application interface 3910UI, then upon completion of “OnChange” event RPC process at the Web Client 1200 the application's user interface 3910UI would have made visible (“Visibility” Property 3100 instance from False to True) a hidden button “Submit” 3937UI because the textbox 3940UI had a new text entry that changed the selected “Contact” first name. And from a business application standpoint, in this example, the “Submit” button must be shown to store any new changes. This shows the power and flexibility of the RPC Messaging system that takes action on the Server 100 side and in turn brings back data to the Client-side. And also, this said (C10) RPC in conjunction with the power of Appward's scripting engine 4300 creates a richer, responsive and dynamic Client-side environment AS WELL, even though Appward's scripting engine runs only at the Server 100 side. The scripting engine 4300, due to its language features and full integration with the Platform Client-Server architecture, can still send data and take actions within specific Web Clients' Client-Side Classes.

This shows how the RPC messaging system enables this rich efficient bi-directional persistent Client-Server communication within Appward by utilizing the WebSocket Server 1020 and Client 1100 architecture within WebServer 1000. In some embodiments, this in conjunction with the traditional HTTPS Webserver 1010 mode of communication between Web Clients and Server, gives Appward the following overall advantages: 1) The WebServer 1000 can serve client-side web data faster through web sockets channels because said WebSocket channels have persistent connections and are bi-directional. They do not have the additional overhead of opening and closing a connection for each HTTP command, 2) Multiple commands from Client-side to the Server, or vice-versa, to take needed action (set values, run event scripts, etc.) can be done in one RPC command Message (instead of multiple HTTPS ones), 3) This said WebServer 1000 system because of its full integration with the rest of Server's 100 base template data structure models and their respective adjacent mechanisms, can leverage this synergy by serving Client-side information comprising data on screens and their respective child widgets (icons) embedded with dynamic bound data all in one shot. In some embodiments, Appward's WebServer 1000 serves dynamic hierarchical Object 3000 instances (in JSON format) from memory to each Web Client to interpret and render their own full dynamic web Pages (instead of serving HTML, CSS and JavaScript files). This efficiency in speed and service will be further shown as the Client-side system application is detailed in subsequent sections, 4) Each Client 1100 instance connection (via its own WebSocket 1104 channel), representing a single Web Client 1200 external browser connection, within WebServer 1000 has its own independent thread to secure its own data from other Clients, making Appward an efficient and reliable multi-client multithreaded reality, as shown in FIG. 11E. And this stays true even when multiple Chrome tabs are open within the same browser application at the same Web Client 1200 terminal. Each of these Chrome tabs still represent a unique and independent Appward Web Client 1200 connection with the WebServer 1000. Although each new Web Client 1200 (A, B, or C) starts its initial connection via traditional HTTPS commands (H1, H2, or H3) with Appward's HTTPS WebServer 1010, each ends up adding another managed channel of communication (WebSocket W1, W2 or W3) that may be persistent, bi-directional, and more efficient.

### Appward's Client-Side Architecture and Process

Moving on to the Web Client 1200 side of the system platform, where any end user at any given terminal within a Web Browser (1201) can connect to the Appward Server 100 system by typing in its web address in the address bar of said Browser. What follows, in some embodiments, once a Web Client HTTP URL request reaches Appward's Web Server 1000 as described before in FIG. 11A, may be the (1) initial Client-side loading process 1410 that loads into memory all the other Client sub-systems as shown in FIG. 12A comprising: (2) All the User Interface Screen Classes (user interface 2900UI business class logic of respective Server-side Class 2000 instances), (3) Routing 1450 mechanism that connects Client-side UI business logic Classes dynamically with their respective UI Object instances and more, (4) Data Binding 1600 system, (5) various system Editors (Script Editor 4200 from FIG. 4A, Class Editor 2200 from FIG. 2D, Object Editor 3200 from FIG. 3H, Screen Editor 5200 shown FIG. 17A), (6) RPC Message 1500 system, which includes (7) the instantiation of a WebSocket persistent communication channel 1550 to connect back (7A) with the WebServer 1000 (Client 1100 instance to be specific at the Server 100 side) and carry on subsequent client-server messages (7B) based on user needs.

Starting with the loading process 1410, as shown in FIG. 12B, in some embodiments, the entire Client-side Application 1400 System may be served from HTTPS WebServer 1010 sequentially as the required system files (3 to 12) are requested by, and coded in, the HTML Page (2) one after the other. These said System files when load into memory establish the above-mentioned individual Client Systems from FIG. 12A (Routing 1450, RPC 1500, Data Binding 1600). After the system files are loaded, the next set of resources that are requested from the Server 100 side are the Class 2000 instances that have Client-side user interface 2900UI and business logic. These are JavaScript files for each respective Screen Icon Class 2000 instance that has a respective declaration in the Class Editor 2200. For Example, ScreenText 2940 as was shown back in FIG. 2D has its business logic and rendering features hard coded in a JavaScript (.js) file (2940UI ScreenText.js 15). This file 15 must be transferred from Server per Client system request. A much larger example may be the ScreenNormal Class 2000 instance 2901 that may be the Appward representation of an entire dynamic web page. Its 2901 JavaScript file (ScreenNormal.js 13) may be also served as a required component of the Client-side System 1400 application. Said 15 file contains the Client-side ScreenNormal 2901UI class declaration. So, steps 12 to 50 in FIG. 12B cover all the Client-side Screen Icon Class 2000 instance UI Files that contain respective Client-side Screen icon 2900UI class declarations. Once these are loaded the last phase of this initialization Client System loading 1410 process may be getting and loading of the WebSocket communication Object back with the WebSocket Server 1020, which in turn instantiates a counterpart Server-side Client 1100 connection instance object, as discussed before in FIG. 10A and FIG. 10B.

Before the above-mentioned major components are discussed individually and in detail, it's important to mention that, in some embodiments, Appward's Client-side 1400 System application may be a Single Page application framework when it comes to rendering different web pages within its 1400 System Single HTML Page (Page.html 1415 file (2) from FIG. 12B). The high-level goal of Appward's Client-side 1400 System application in working with its Server-side counterparts is to be able to receive structured data of Object 3000 instances, with their Class 2000 instance definitions, and in turn render them into their respective live HTML elements each containing their internal smarts. In some embodiments, all these HTML elements are created dynamically and in turn can also act as live user interfaces, all within the same and one “Page.html” 1415 DOM. Each of these HTML elements will be contained within their own JavaScript object instances (defined by said JavaScript Screen Icon Classes as mentioned in FIG. 12B 12 to 50). More details on this rendering process below, for now the main reason for the WebSocket Server 1020 and its Client-Side 1550 counterpart in having an open persistent WebSocket channel is to efficiently transfer such sets of hierarchical Object 3000 instance data from Server to Client and render (based on Client user request) custom rich applications and web pages all in the same, again one and only, HTML Page 1415. Hence the Single Page Application Framework for Appward Web Clients. This is further seen in FIG. 12C where, in some embodiments, once an Appward web page (3920UI ScreenNormal Class 2000 instance) may be loaded, then the said web page UI, or any one of its children UIs, in turn can communicate back to the Server 100 individually using Appward's own Remote Procedure Call 1299 (RPC) protocol for any user interactions, via said WebSocket Channel, comprising: 1) Setting Object Property Values (Object Property 3100 Value 3104) or 2) running specific Class 2000 instance business logic (Client-side or Server-side) by calling an Object Property 3100 instance of “Method” type, or 3) triggering user events that can execute custom logic scripts (4300). As for media content resource needs (like Images, Video, PDF documents, etc.) that certain screen icon Class 2000 instance types require (e.g., Screen Image Class 2000 instance will require an Image File), such contents, files or resources, will be requested and served via the HTTPS WebServer 1010, as mentioned before in FIG. 10A and FIG. 11A.

FIG. 12D clarifies the mapping between instantiated UI JavaScript Objects within the Client System 1400 application that may be sent over, via said WebSocket Server 1020, to represent Object 3000 instances of screen icon related Class types, meaning Class types that serve Client-side interface and functionality, from the Server 100. Only Object 3000 instances of screen icon nature Class types (Class 2000 instances that have respective 2900UI class declarations) may get served in JSON data format via the WebSocket Server 1020 to Web Clients 1200. A partial view of FIG. 3B may be displayed in FIG. 12D showing a Popup Screen 2902 Class 2000 instance type Object 3000 instance named “popMain” 3910 with a partial set of its Object 3000 children 3008 instances (the “txtFilterTitle” 3935 that may be a ScreenText 2940 Class 2000 instance type, the “tblContacts” 3936 that may be a ScreenTable 2970 Class 2000 instance type, and the “btnSubmit” 3937 that may be a Screenbutton 2910 Class 2000 instance type, among other Screen icon class types, excluding “datContacts” 3911 because it is not a screen icon Class 2000 instance type). In this example, said Screen Popup “popMain” 3910 gets transferred to a Web Client, based on some request trigger event as JSON formatted data within a RPC 1299 Message (as discussed before in FIG. 11B). In some embodiments, the Web Client 1400 System application will then route and instantiate a set of JavaScript object instances starting with “popMain” 3910UI, and then its respective Children, from all the Class type definitions that were already loaded from said Screen Class files (FIG. 12D 2900UI) into Browser memory as ScreenPopup.js 2902UI, ScreenTable.js 2970UI, ScreenButton.js 2910UI and ScreenText.js 2940UI as part of Initial Loading Process (FIG. 12B boxes 13 to 50). Each of these said JavaScript Object UI instances, in some embodiments, may contain an associated user icon HTML element that are displayed within said popup screen's HTML element, as children elements, as shown previously in FIG. 3B, in the overall said Web Client's 1200 browser DOM also shown in FIG. 12E. Again, in some embodiments, only Object 3000 instances of Screen Icon Class types get sent over from the Server 100 to any connected Web Client 1200 because only such said Class types have any business logic, declared in individual JavaScript classes with user interfaces and smarts, within any Client System 1400 application. Here is partial list, with brief definition, of some of the client-side Appward Class 2000 instances:

ScreenNormal: This is the main Appward web page (ScreenNormal 2901UI Class 2000 instance) user interface Screen, which also may be a container (has Children icons) of other smaller user interface Appward Classes.

ScreenLabel: This is a user Interface for an Appward Label class type.

ScreenButton: This is a user Interface for an Appward Button class type.

ScreenText: This is a user Interface for an Appward Text input class type.

ScreenCheckbox: This is a user Interface for an Appward Check box class type.

ScreenAudio: This is an Appward Audio class type that plays music in background.

ScreenBar: This is a user Interface for an Appward bar class type.

ScreenCalendar: This is a user Interface for an Appward Calendar class type.

ScreenCamera: This is a user Interface for an Appward Camera class type.

ScreenCapture: This is a user Interface for an Appward Image capture class type.

ScreenChart: This is a user Interface for an Appward Chart class type.

ScreenChat: This is a user Interface for an Appward chat messenger class type.

ScreenCombo: This is a user Interface for an Appward Combo box class type.

ScreenTable: This is a user Interface for an Appward Table class type.

ScreenFileManager: This is a user Interface for an Appward File Manager class type.

ScreenForm: This is a user Interface for an Appward Form class type.

ScreenGanttChart: This is a user Interface for an Appward Gantt Chart class type.

ScreenHTML: This is a user Interface for an Appward HTML iFrame class type.

ScreenHtmlEditor: This is a user Interface for an Appward HTML Editor class type.

ScreenHyperLink: This is a user Interface for an Appward text hyperlink class type.

ScreenImage: This is a user Interface for an Appward Image class type.

ScreenMap: This is a user Interface for an Appward Map class type.

ScreenMenu: This is a user Interface for an Appward Menu class type.

ScreenPane: This is a user Interface for an Appward Pane panel class type.

ScreenPDF: This is a user Interface for an Appward PDF Viewer class type.

ScreenPolyline: This is a user Interface for an Appward polyline class type.

ScreenShape: This is a user Interface for an Appward Shapes class type.

ScreenTray: This is a user Interface for an Appward application Tray class type.

ScreenTree: This is a user Interface for an Appward Tree class type.

ScreenVideo: This is a user Interface for an Appward Video class type.

Script: This is a user Interface for an Appward Script Editor class type.

ScreenPopup: This is a user Interface for an Appward Popup screen class 2902UI type that extends from the ScreenNormal 2901UI Class 2000 instance. The difference is that the same Popup UI can be duplicated to be shown multiple times, while ScreenNormal types cannot because they are covering the entire main background web page.

FIG. 12F shows a sample of these Screen icon Class 2000 instances' JavaScript class declarations (ScreenNormal, ScreenButton and ScreenLabel) and how each of them, by design, in some embodiments may match exactly their respective name in the Class Editor 2200 UI definitions. All such JavaScript Classes are sent over the HTTPS WebServer 1010 though the only HTML file, Page.htm 1415, as it goes through requesting these resources via HTTPS URL commands in a waterfall fashion as shown before in FIG. 12B. It is worth mentioning that said Screen icon Class URLs are dynamically added, in run time, to the HTML 1415 file as each screen icon class is verified in the system. This verification happens once initially when Server 100 is launching. Said verification occurs in the system by checking each of the client-side Screen Icon Class 2000 instances that are in Server 100 memory against the Screen icon Class files 2900UI (also loaded in Server 100 memory) that contain the JavaScript class declaration with matching name and business logic (see sample JavaScript Classes shown in FIG. 12F). In some embodiments, every Class that passes this verification may be added dynamically as an HTML <Script> Element tag 1415A1 in the Page.html 1415 file header <Head> 1415A (FIG. 12E). It is this version of the Page.html 1415 file that is served by the HTTPS WebServer 1010 to any new Web Client 1200 connection as shown in FIG. 12B. This is by design in keeping up with Appward's architecture of being dynamic when it comes to adding, removing and updating Appward Classes, Class 2000 instances, on-the-fly. Once any new Screen icon Class 2000 instance, with its Class Property 2030 instances, is added via the Class Editor 2200 user interface, then all that is required is its matching Screen icon Class 2900UI File to be uploaded to the Server 100 system and then the WebServer 1000 will be able to detect the change and serve it to subsequent new Web Clients 1200.

Now that Screen icon Classes are defined with their respective JavaScript classes (2900UI) and how they are loaded within Client side 1400 system, it may be important to understand how any set of Object 3000 instances that are sent from the Server 100 get instantiated at the Client-side 1400 system from such JavaScript classes as UI Objects and get rendered to be displayed within a Browser screen. To bridge this gap, in some embodiments, the two Client-side 1400 System components that were mentioned before (FIG. 12A) as part of the initial loading process need to be discussed: 1) The RPC Messaging 1500 system, and 2) The Routing 1450 Mechanism.

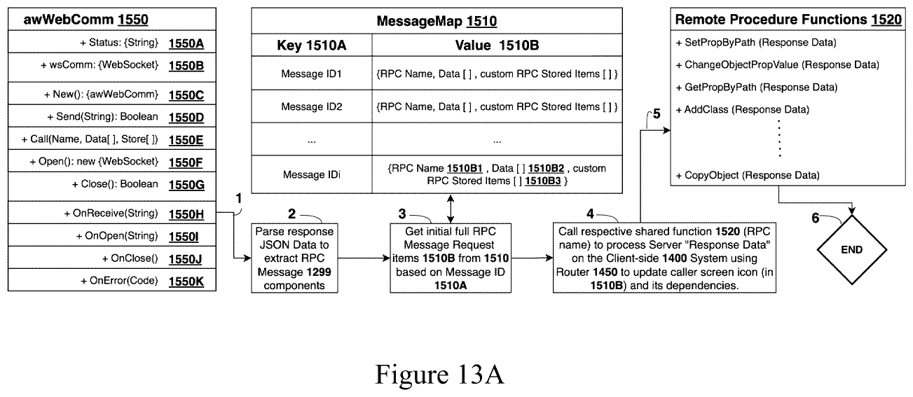

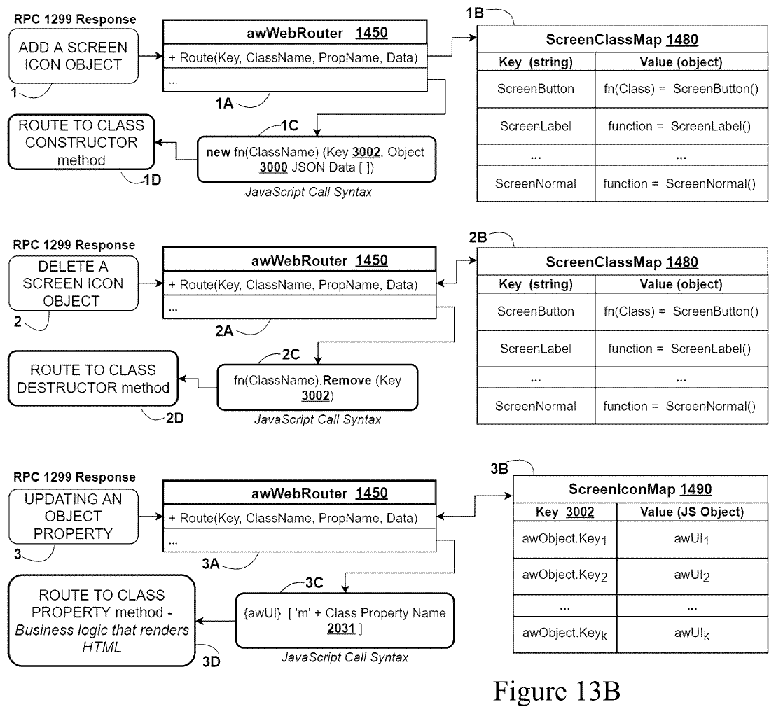

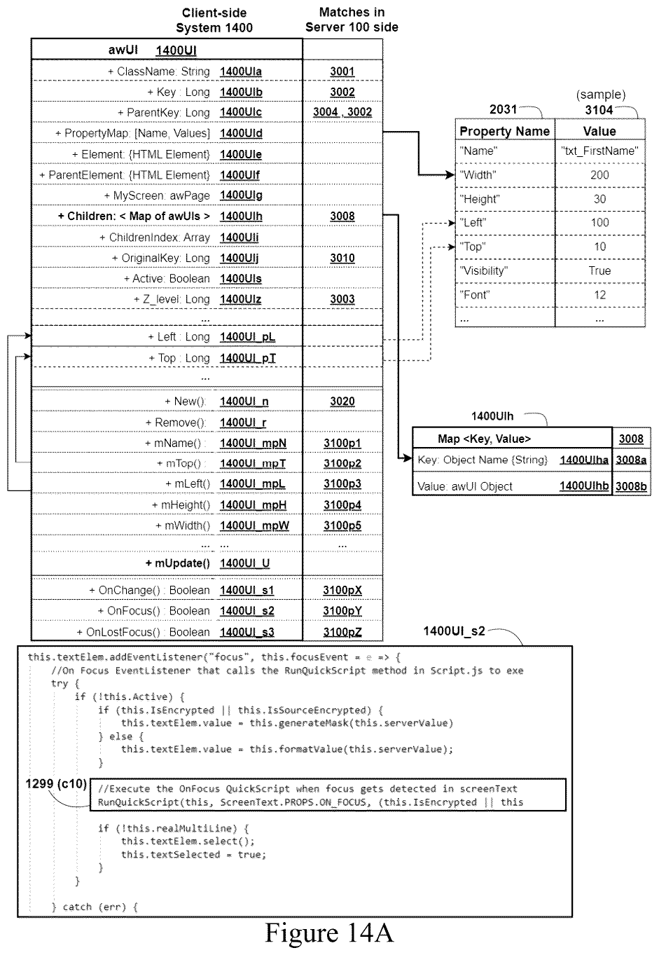

But first, in order to make sense of these two mechanisms, some coverage on the base characteristics that may be a common denominator for all the different JavaScript class definitions (2900UI) which all respective different User Interface (UI) screen icon Objects are instantiated from, is needed. For sake of clarity, even though all these screen icons can belong to different class types (different Class 2000 instances and in turn different 2900UI class declarations), on the Client-side 1400 system application all said screen icon JS Objects may be referred to as awUIs, generally speaking, to indicate some sort of screen icon widget with smarts rendered within a given web client screen. See FIG. 14A for said base class definition, that is not a true (or real) JavaScript class but illustrates conceptually the most common fields that may be true to all the truly declared JavaScript Class 2900UI definitions. FIG. 14A shows some of the mapping between the Client-side 1400 system base UI class 1400UI fields and the Server 100 counterpart Object 3000 and Object Property 3100 classes. In some embodiments, awUIs (1400UI) are the building blocks for allowing user interface capability to Appward customers throughout applications in the Appward ecosystem. In some embodiments, they are the visual components, individual screen icons, that users interact with to achieve specific purposes such as navigating through different screens (web pages) by clicking ScreenButtons 2910UI (FIGS. 3B and 12D). These awUIs work together to accomplish diverse set of tasks, as it has been shown in FIG. 3B with the “Contacts” application user interface for example. These awUIs may allow for a seamless experience when creating and designing Appward applications for end users. To find out how, see the awUI 1400UI common class in FIG. 14A comprising: A) ClassName 1400UIa which may be the name of the client-side Class 2900UI that may be used to instantiate this awUI. In FIG. 3B example, 3940UI which may be a rendered HTML text box and may be an awUI class of “ScreenText” name. Class names on the Client-side may also used to access the entire JavaScript class code as an Object via the global map as shown in FIG. 13B 1480. This is important for the Routing 1450 System as it may be shown downstream; B) Key 1400UIb may be a unique non-zero positive identifier of this awUI that may be the exact same match as the corresponding Object 3000 instance counterpart (3002) in the Server 100. This field may be used to identify every awUI uniquely and directly in the Client-System 1400 application and make the necessary changes (via RPC 1299 calls) on the Server 100 side, when needed. In some embodiments, this may be used in the ScreenIconMap (FIG. 13B 1490) to easily access each awUI for easy lookup and manipulation on the Client-side 1400 application; C) ParentKey/ParentElement (1400UIc and 1400UIf, respectively) this may be the key and HTML element of the awPage (more details on this downstream), respectively, that contains this awUI. In some embodiments, these are used to directly check which awPage an awUI is part of. This is useful in differentiating when there are multiple awPages open at once (e.g., Screen Popups 2902UI class types can do this). For more complex Icons (e.g., awUI such Screen Table), these fields would point to the direct Parent HTML container (Screen Column's parent may be a Screen Table); D) PropertyMap (1400UId) may be the map (collection) that keys all the Object Property Names (2031) of this screen icon instance, awUI, to its Object Property Values (3104), as shown in FIG. 14A where 1400UId may be a map that contains a sample list of Property Values of a rendered screen text box. As mentioned before, when detailing about the three Class Property types (“PropTypes” FIG. 2D 2036), only “Property” and “Event” type values get sent over from the Server 100 to the Client-side 1400 System because those only contain data. So PropertyMap (1400UId) only contains “Property” and “Event” data values (3104) keyed to their respective Class Property names (2031). “Method” Class Property types are defined and declared with their respective business logics in functions within each JavaScript class file (2900UI). Because even “PropTypes” (2036) of “Property” need business logic (method call of said JavaScript class declaration) to render and style each awUI on the front-end within a screen display, then all said method calls have a “m” prefix before their function names to differentiate them from their “Property” type class property name fields within the JavaScript class. For example, “Top” (1400UI_pT) and “Left” (1400UI_pL) fields have respective “mTop” (1400UI_mpT) and “mLeft” (1400UI_mpL) method calls within any said JavaScript class. The reason for each “Property” type to be stored in two places (PropertyMap and each with its own respective class field) is because the PropertyMap may be used always to reflect the values that are currently at the Server 100, while the individual field Properties (“Top”, “Left”, “Width” etc.) are also used for transient animation purposes on the client-side system. As for “Method” types (2036) the “m” prefix still applies in their function declarations for consistency in Routing 1450 purposes as it'll be shown. In some embodiments, for example, ScreenNormal class (2901) may have an “Update” Class Property of “Method” type that when called on the front end, it goes to the Server 100 to get the latest changes for that Screen awUI object (from its respective Object 3000 instance) and upon return render the new updates. This said update function method may be declared as “mUpdate”. Lastly, “Event”, or “Script”, types (“PropTypes” 2036) are declared differently using JavaScript events within each UI class type. Once PropertyMap may be set in the constructor call of any JavaScript Class awUI creation, it may be then used to initialize all the awUI HTML renderings through looping over this Map's (1400UId) Key-Value pair contents and set each property styling and characteristic for “Property” types (2036) using the Routing 1450 system to get to each respective method function (e.g., “mLeft” for the “Left” property, etc.). This map size varies based on the Class 2000 instance definition because different Classes have different number of Class Properties 2030, which all awUI's PropertyMaps must follow; E) Element (1400UIe) may be the field that holds and references the HTML element tag in the DOM that represents this awUI object instance visually. For a ScreenText, this would be the ‘textarea’ html tag on the awPage in the browser. In some embodiments, all awUI Object Property manipulations (“Property” 2036 types) may be carried out and modified on said textbox, which in turn may be reflected within the respective Element in DOM and vice versa. The Element, in browser DOM, is may also be ID-ed (HTML attribute “id”) by the same Key (1400UIb) value to have a one-to-one direct mapping with its awUI object instance. This way any user interactions with the HTML element may be directly be linked back to the client-side awUI instance object that in turn will take respective actions at the Server 100 side to be in sync at all times; F) MyScreen (1400UIg) may be the awUI Screen class type (awPage) Object instance that this awUI belongs to at the client side. It is useful for each awUI object instance to have a direct connection to its container Page object (ScreenNormal or ScreenPopup class types); G) Children (1400UIh) may be a map, a set, of all the other icon Objects (awUIs) that this awUI might contain under itself as children. When it comes to simple awUI icons this set is usually empty. However, when it comes to complex Icons (Screen Table, Screen Chart, Screen Check box, etc.) this field contains the children awUI icons that make up the parent awUI. In some embodiments, a web page (awPage—of ScreenNormal or ScreenPopup type) may have other screen icon instances, awUIs, contained within this said field that make up the rendered icon elements on said screen: H) ChildrenIndex (1400UIh) field may be the index of each the awUI Children, to identify their sorting order, when a given awUI (complex) Icon has awUI Objects underneath itself; I) Z_Level (1400UIh) field may be the HTML Z-index order (integer value) of each awUI icon within each awPage. It's what decides which Icon may be displayed on top another when multiple Icons are layered on top of each other within a page. Z_Index may be set by the ChildrenIndex (1400UIh) field and vice versa. The higher the sorting index, the higher the Z level of an awUI icon and its respective HTML element within the DOM; J) Active (1400UIh) field may be a Boolean value to indicate whether this awUI icon may be in screen design mode or not. Certain run time features may be disabled while others are enabled in design mode on any awUI icon based on this field. Since each awUI object instance has its own said “Active” field, then the Client-side 1400 System application may be able to individually and independently set certain screen(s) in design mode while others be kept in run time, based on customer need and operations. So, a sample user logged in workspace can have five applications, five ScreenPopup UIs, running at the same time. And because of this (1400UIh) feature a user can select to set one of the application UI's into screen design mode, while keeping the other four applications still in full run time mode to do operations. See more details on the Screen Designer editor below.

In some embodiments, the above-mentioned fields may be common to all the frontend Screen Class definitions (2900UI) within the Client-side 1400 system. Following are the details that also defines the most common functionalities in each said Client-side Screen icon Class declaration, comprising: F1) New (1400UI_n) may be the Constructor method of the said client-side class to create an instance awUI object. In this method the HTML Element (1400UIe) may be created, the properties in the PropertyMap (1400UId) are applied to the HTML Element using the values, setting styles and more, from the said map. The ClassName (1400UIa), Key (1400UIb), ParentKey (1400UIc), and ParentElement (1400UIf) are set too. Lastly, the HTML Element may be added under the ParentElement (1400UIf), which then reveals the newly created awUI on the screen within the Browser (1201) starting with its “Left” (1400UI_pL), “Top” (1400UI_pT), “Width” and “Height” values to the rest of the other fields that each icon Class has as Class Properties 2030 of “Property” 2036 type. In some embodiments, the newly created instance icon may also be added to ScreenIconMap (FIG. 13B 1490) and its parent container Screen page MyScreen (1400UI_g) instance object set too; F2) Remove (1400UI_r) is the destructor method of the said client-side class which removes the awUI instance from the screen and the Client side 1400 System in general. This method gets called whenever the user removes this said awUI Object from system memory or most commonly when the awPage is changed or closed (more on page navigation below). In some embodiments, the HTML Element (1400UIe) may be removed from the ParentElement (1400UIf), thus deleting it from the screen. In some embodiments, the awUI object instance's all events are deleted too and furthermore the instance itself is removed from the client System 1400 global structures (e.g., ScreenIconMap 1490) for the garbage collector to pick up; F3) mLeft/mTop, (1400UI_mpT) and (1400UI_mpL) respectively, are common set property functions that correspond to an awUI's respective Left (1400UI_pL) and Top (1400UI_pT) properties, as mentioned above. These values are relative with respect to their parent container (usually a ScreenNormal or ScreenPopup class types) ParentElement (1400UIf). Whenever an awUI gets dragged across the screen, for example with a mouse, these functions may be dynamically called which in turn updates the HTML Element's (1400UIe) left and top styles. The user then sees the awUI moving as expected with their cursor; F4) mHeight/mWidth, (1400UI_mpH) and (1400UI_mpW) respectively, are set property functions that may correspond to an awUI's respective Height and Width properties. Whenever an awUI gets resized, for example from an RPC c10 type (FIG. 11C) response data containing a “SendToClient” (J3 in FIG. 4B) to change the Width & Height Property Values of said screen icon, these functions may be dynamically called which in turn updates the HTML Element's (1400UIe) width and height styles. In some embodiments, the user may then see the awUI shrinking/expanding as expected; F5) mUpdate (1400UI_U) is a function method that is important for routing in relation to data binding, see Routing 1450 and Data Binding 1600 mechanisms below. For example, in data bound items when a target property (4500) value changes, said update method gets called here to update the awUI's property value to the new changed target's value coming from the Server 100 side. Finally, in some embodiments, some of the most common events in any screen icon JavaScript class 2900UI declarations, comprising: E1) OnChange (1400UI_s1) may be an “Event” “PropType” (2036) that for example within an ScreenText class, would be fired when a new value is entered at said textbox HTML tag within the DOM. The “RunQuickScript” (FIG. 11C c10) RPC 1299 message gets fired if and only if said Object awUI instance's this event property field contains custom script logic. Otherwise, if there is no script (empty sting) then this event does not get fired even if there was a change in value at the respective HTML tag element. When fired, this event via said RPC c10 calls the OnChange Object Property 3100 Event to be executed at the Server 100 side. Inside this Event, the user can define any custom logic using Appward's Script Editor 4200 and Appward's scripting language (FIG. 11C); E2) OnFocus and OnLostFocus (1400UI_s2 and 1400UI_s3) are common events, for example in ScreenText class type when the HTML tag element may be clicked on or clicked off, the corresponding event may be fired and calls its respective Object Property 3100 Event at the Server 100 following the same RPC process and conditions as mentioned for the “OnChange” (1400UI_s1) event. See FIG. 14A that shows the declaration of a sample ScreenText class 2940UI for “OnFocus” (1400UI_s2) event type Property with details on how a C10 RPC 1299 may be fired.

Using the above details to expand on a previous example from FIG. 3B, in some embodiments, the 3940UI may be an object instance from ScreenText class type (2940UI). It's parent HTML container (ParentElement 1400UIf) may be the “popMain” 3910UI object instance of ScreenPopup type 2902UI. Its Element 1400UIe may be a ‘textarea’ HTML tag displayed at Left (1400UI_pL) position of 180 px, Top (1400UI_pT) position of 265 px, Width (1400UI_pW) position of 100 px and Height (1400UI_pH) position of 20 px within its parent HTML ScreenPopup container. As mentioned before, like all other screen icon class declarations, ScreenText (2940UI) has more declared Class Property (2030) instances than those covered in the base template 1400UI class. For example, it's “Visibility” value (3104) may be empty string, which defaults to making the HTML tag render as visible (hidden would have a “False” value). The “FontSize” property value (3104) may be 12, which sets the text size styling in the UI and it may be left aligned (“Alignment” Class Property) with a font family “Arial” (“Font” Class Property). It's “Value” Property (3100) has a Path that binds it to Screen Table Column Field Property target (4500) that contains “Raffi”, which may be rendered as the displayed text in the UI. Its “ShowBorder” Property value (3104) may be “true” with a “BorderWidth” of 1 px, empty “BorderColor” (defaults to Black) and “BorderRadius” of 5 px. This is why the rendered HTML element has a black 1 px width border around its text value. These are few of the many other Object Properties (3100), with different characteristics and smarts, that the ScreenText class has rendered within the ScreenPopup 3910UI screen with its other sibling screen icons' that are children of said ScreenPopup container (“tblContacts” 3936UI of ScreenTable 2970UI class, ScreenButton “btnSubmit” 3937UI of ScreenButton 2910UI class, etc.). Note finally that all this ScreenText's instance 3940UI events properties do not contain any custom script except the “OnDirty” Object Property (3100), which will be triggered upon the user clearing the entire text entry from the 3940UI ScreenText. This in turn will execute its contained custom script on the Server 100 side. In understanding this base UI class (1400UI) model, it can be inferred how having a screen icon Object 3000 instance data at the client-side can be rendered to display within a user interface screen all its specific characteristics upon being created as an awUI object from its respective specific class type definition (2900UI). Moving back to bridging the gap between how Server 100 Object 3000 instances end up with their respective awUIs being rendered within a WebClient 1200: Staring with the RPC Messaging 1500 system, followed by the Routing 1450 System next.

In FIGS. 11B, C and D RPC 1299 messages were defined and shown how they were called and processed on the Server 100 side to take a variety of actions (based on the specific RPC name) and return specific responses back to their respective web clients 1200 over WebSocket 1550 channel. What follows is the process of handling returned RPC message 1299 responses within Client-side 1400 System within the RPC handling 1500 system. FIG. 13A shows the process of handling returned data back to a Web Client specific user interface, a screen icon, a JavaScript Object instance awUI, that issued the initial RPC request. In some embodiments, this starts first with an RPC request from the Web Communication 1550 class instance that wraps a standard JavaScript WebSocket 1550B with all its API features (Methods: “Send” 1550D, “Close” 1550G, “Open” 1550F and the following Events: “OnReceive” 1550H, “OnOpen” 1550I, “OnClose” 1550J and “OnError” 1550K). Additionally, it may add two more fields: A) “Status” 1550A to give a direct indication of the WebSocket communication status, and B) a “Call” method 1550E that may be called from every screen icon awUI that wants to send an RPC to the Server by passing to its specific custom data requirements based on the remote action procedure call type. 1550E prepares the RPC Message 1299 format structure by generating a unique Message ID 1299A, the type of action needed represented by the RPC name 1299B, the Data 1299C sent to Server. Additionally, in some embodiments, 1550E may take any extra items about the caller screen icon awUI, the trigger source, and other metadata about the specific RPC name so that upon return of said RPC response they are used to give a clear and accurate routing back to the source, see Routing 1450 mechanism for more details below. In some embodiments, all of these 1550E parameters are stored first, in a FIFO queue, within the Message Map 1510 keyed to its respective unique Message ID 1299A. In some embodiments, afterwards, 1550E sends out the JSON formatted data over the WebSocket 1550B open channel. Now as explained in FIG. 11B, in some embodiments, each RPC Message gets processed by its respective Server 100 side Client 1100 instance's thread and returns a response back over its WebSocket to its Web Client's 1200 RPC Messaging 1500 System, which triggers the “OnReceive” 1550H event of the 1550 API. This starts the process flow illustrated in FIG. 13A, where retrieving the stored initial Message from the Message log Map 1510 and using the Routing 1450 mechanism gets the response data to the respective triggered screen icon stakeholder awUI and update it with all its dependencies.

As mentioned above, in some embodiments, the Routing 1450 system may be mainly used to route all the RPC Messages 1299 within the Client-side 1400 system that have gotten a response back from the WebSocket Server 1020 to each RPC. Routing 1450 system routes new incoming data from the Server 100 to appropriate end ScreenNormal or ScreenPopup awPages to keep all the respective awPages and awUI updated with the latest server-side changes. Appward web pages are highly dynamic in getting everything rendered initially, on HTML page load as shown in FIG. 12B. And afterwards, as importantly, in maintaining these client web pages (more details on web pages downstream) with the latest data updates during operations. So, when users interface with their respective web pages, individual UI data are changed (either from user actions or server-side actions) and need updating from the central Server 100 System. These changes are data information that must be transferred promptly and accurately so that Appward Web Clients 1200 stay true with their respective Server-side 100 counterpart settings (Object 3000 instances). All Appward Web Clients 1200 are server centric by design like this. And this reality is maintained through the open WebComm 1550 communication object that constantly may be messaging using Appward's RPC 1299 protocol. And these RPC 1299 message responses within the Client 1400 system are followed by the Routing 1450 mechanism comprising four three categories: (1) Adding a new Object screen or screen icon, (2) Removing an existing Object screen or screen icon. Both (1) and (2) are responsible for the behavior that allows for Web Clients 1200 to navigate to and show different ScreenNormals and ScreenPopup web page instances. (3) Updating a Property 3100 Value of a ScreenNormals or ScreenPopup icon Object 3000 instance, which through the 1450 mechanism may be able to have that update get reflected on its respective awUI representation. Similarly, updating data bound Object instances when the associated target 4500 Object 3000 instance or the Object Property 3100 instance may be changed on the Server 100 side. In some embodiments, the Routing 1450 system mechanism in this last case may be responsible for routing to the associated awUI that represents the Source 4400 and have the new Target 4500 Value 3104 get reflected within that awUI (more on this discussed within the context of the Data-binding 1600 system). These said Routing mechanism 1450 categories are fundamental in providing much of the functionality and features in routing data updates when it comes to Web Clients 1200 interacting with awUI, ultimately promoting real-time, on-the-fly development and usage of applications.

In some embodiments, routing may be mainly utilized on said JavaScript Object UI instances (awUI), representing screen icon Object 3000 instances, and not as much for Class 2000 instance manipulations or background Client-side 1400 system checks (like system time stamps or user activity checks). In some embodiments, a single RPC message can contain any number of combinations of the above three categories in a single response. But besides iterating through the data, in multiple route calls, it still boils down to above said three cases. The above categories are illustrated by FIG. 13B, which shows the Routing 1450 system and the processes for the said scenarios.

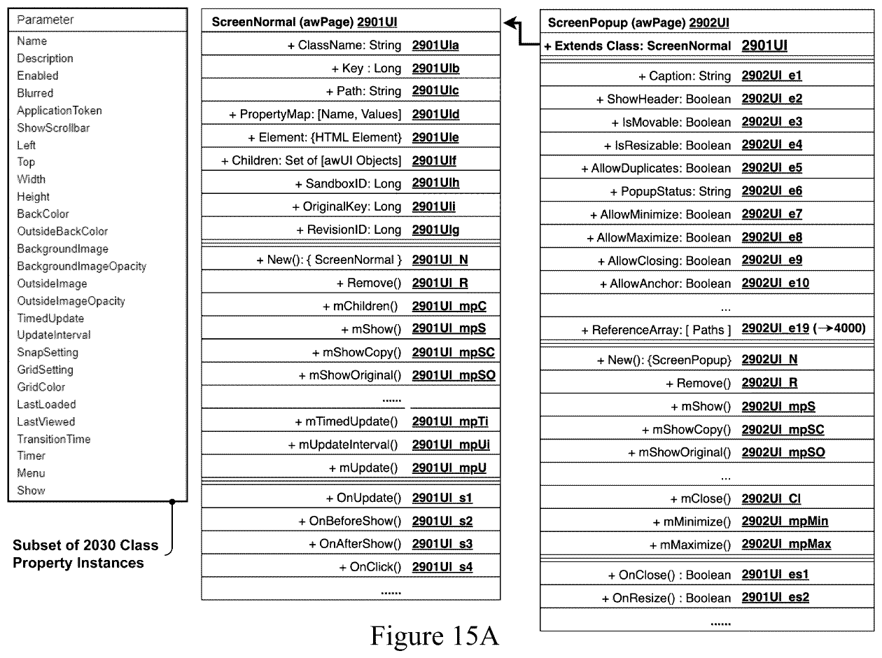

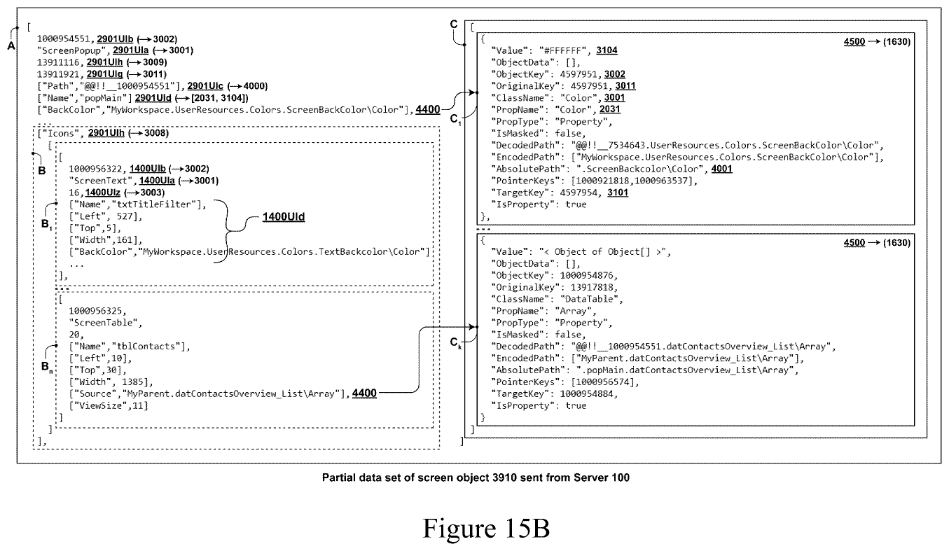

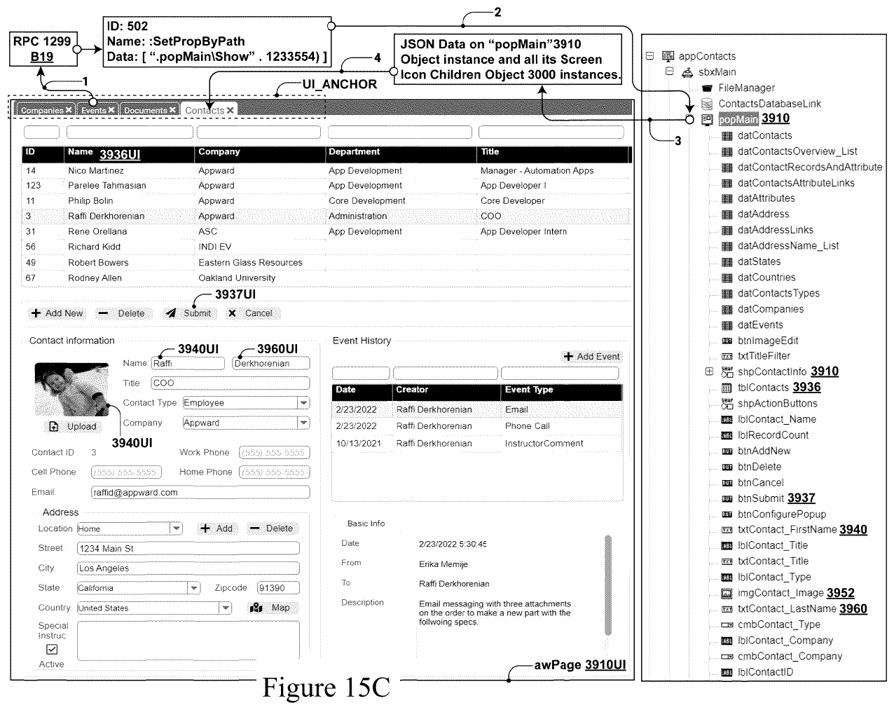

FIG. 13B case 1 demonstrates the process that the Routing system 1450 goes through, in some embodiments, to instantiate any new awUI instance within their respective ScreenNormal or ScreenPopups awPages for a Web Client 1200. As demonstrated in FIG. 13B, case 1 may start when a new Object 3000 instance may be added under a given ScreenNormal or ScreenPopup Object 3000 instance whose associated awPage the Web Client 1200 may be viewing. In some embodiments, the new Object 3000 instance may be first added within Server 100, then whenever that associated ScreenNormal or ScreenPopup Update method gets called (2901UI_mpU either a timed update or through scripting, more on this discussed in subsequent sections), Server 100 would process the RPC 1299 request and send the RPC 1299 response with associated data back to Client system 1400 for processing. This data will be in JSON format and contain information on the new Object 3000 instance addition. The JSON data may be similar to the illustrated JSON data in FIG. 15B. The JSON data comprises the Object 3000 instance data, along with its Object Property 3100 instance data, any data on child Object 3000 instances within it, and any Reference 1630 data between Sources 4400 that are within the new Object 3000 instance and its associated Targets 4500 (this is discussed further on in the Data-binding 1600 system). From that point on, the Routing 1450 mechanism within Client system 1400 may take over. In Step (1A), Routing 1450 system will utilize the data from Step (1) sent from Server 100, and (1B), use the name of the Class 2000 instance (from within the data from (1)), that is to be instantiated (i.e., “ScreenButton”, “ScreenText”, etc.). Using this class name, the associated JavaScript class code (2900UI), which may be the Value side of ScreenClassMap 1480, will be retrieved from ScreenClassMap 1480. Afterwards, in Step (1C), the constructor New(1400UI_n) instance from the retrieved JavaScript class code will be called with the new Object Key 3002 and JSON data from (1) as parameters of this constructor. As said before, the New (1400UI_n) may be the constructor method of the said client-side class to create any awUI or awPage object instance. Then in Step (1D), the Routing system 1450 will route to this New(1400UI_n) constructor and run it. This New(1400UI_n) constructor will then utilize that data from (1) and use it to instantiate the associated awUI icon, along with any children awUI objects (if the awUI is a complex type of “ScreenTable”, for instance will contain “ScreenColumn” children objects), and References 1630 (Discussed in data-binding 1600 system), which were all a part of the data from Server 100 response (1). More on the exact processes the New(1400UI_n) constructor goes through to render the awUI will be discussed in detail in latter sections. This would complete the routing and rendering process of the new awUI, making it ready for Web Client 1200 interaction. After understanding the base process of how Object 3000 instances can be rendered as awUI icons, the same mechanism also applies to building ScreenNormal or ScreenPopup awPages. In some embodiments, the initial trigger in this case would be a call to show an existing ScreenNormal or ScreenPopup Object 3000 instance, which can be triggered by a WebClient 1200 or a script. This is a common use case that would occur whenever Web Clients 1200 are navigating between ScreenNormal awPages or opening ScreenPopup awPages. This feature allows Web Clients 1200 to view and utilize different screens, workspaces, and applications. This process may be triggered anytime a Web Client 1200 runs the “Show” Object Property 3100 “method” instance of a ScreenNormal or a ScreenPopup Object 3000 instance. In some embodiments, the Routing system 1450 may be responsible for processing the data that may be sent back from Server 100 regarding the associated ScreenNormal or ScreenPopup Object 3000 instance the Web Client 1200 may be requesting, into a usable and interactive ScreenNormal or ScreenPopup awPage (more on awPages details are in subsequent sections). Server 100 will again process and package the associated screen data (comprising of JSON data on the requested Screen or ScreenPopup Object 3000 instances, any child Object 3000 instances within it, and any data-binding information between Sources 4400 that are within the Screen and Targets 4500, i.e., Reference 1630 data, discussed further on in the Data-binding 1600 system), sending it back through the RPC 1299 response to get processed by the client-side 1400 system. Routing will again use the name of the Class 2000 instance (from within the JSON data), that is to be instantiated, in this case “ScreenNormal” or “ScreenPopup”. Using the class name, the associated JavaScript class code (2900UI) from ScreenClassMap 1480 will be retrieved and afterwards route to the constructor New(1400UI_n) instance for “ScreenNormal” or “ScreenPopup”. Then, the New(1400UI_n) constructor will utilize the JSON data and use it to instantiate the associated screen awPage, along with any children awUI objects and References 1630 (Discussed in data-binding 1600 system) that were all a part of the data from Server 100 response. This would complete the rendering of the new Screen awPage making it ready for Web Client 1200 interaction.

FIG. 13B case 2 demonstrates a subsequent process which, in some embodiments, may be handled by the Routing 1450 mechanism and is as essential as case 1 for responsive Client 1200 interaction with awUIs. This case, in some embodiments, starts with a Web Client 1200 or a script that triggers a deletion of an existing Object 3000 instance under a ScreenNormal or ScreenPopup Object 3000 instance who's associated awPage a Web Client 1200 may be viewing. In this case, the deletion would get processed within Server 100 and Database 500 (if Original Screen, not Orphan) first, then when the associated ScreenNormal or ScreenPopup Update method gets called, Server 100 would process that RPC 1299 request and send the RPC 1299 response with associated data back to Client system 1400 for processing. The data may include the Key 3002 of the Object 3000 instance that was deleted. Then in Step (2A), the Router 1450 system may utilize the class name of the awUI instance that is to be removed (i.e., “ScreenButton”, “ScreenText”, etc.). In some embodiments, through the class name, (2B) the Router system 1450 will then retrieve the associated JavaScript class code (2900UI) from ScreenClassMap 1480. Then in Step (2C), the associated destructor function Remove (1400UI_r) from the retrieved JavaScript class code may be called, passing in the key (See FIG. 14A 1400UIb) of the awUI that needs to be removed from Client system 1400 memory. Afterwards in Step (2D), the Routing mechanism 1450 will route to the said (Remove (1400UI_r)) and through that function, the associated awUI will be retrieved from ScreenIconMap 1490 based on Key 3002, and properly deleted from Client system 1400 memory (along with any children awUI objects and References 1630 (discussed in data-biding 1600 system), and finally, its associated entry will be removed from ScreenIconMap. The same mechanism also applies to removing awPages from Client system 1400 memory. Before any new ScreenNormal awPage instance can be built by the Routing 1450 mechanism and get rendered for a Web Client 1200 as demonstrated by case 1, the existing ScreenNormal awPage that may be in view must be destroyed and removed from within Client system 1400 memory. This occurs every time a new screen awPage may be requested in order to avoid memory buildup within Client system 1400, and, since the platform may be server-centric, make sure the freshest Object 3000 data may be retrieved from Server 100 every time said ScreenNormals or ScreenPopups are requested. This will avoid any outdated, lingering data that may reside in Client system 1400 memory. Building on top of the case 1 example from FIG. 13B, before the new ScreenNormal awPage instance can fully be rendered for the Screen Object 3000 instance that was requested, the Routing 1450 system will be used to remove the existing ScreenNormal awPage from Client system 1400 memory first, following the same process described in case 2. In some embodiments, this process will start from Step (2A) where the Routing system 1450 will utilize the class name of the ScreenNormal awPage that is to be removed (in this case “ScreenNormal”). (2B) Through the class name, the Router 1450 system may then retrieve the associated JavaScript class code (2900UI) from ScreenClassMap 1480. Then in Step (2C), the associated destructor function Remove (1400UI_r) from the retrieved JavaScript class code may be called, passing in the key (See FIG. 14A 1400UIb) of the ScreenNormal awPage that needs to be removed from Client system 1400 memory. Afterwards in Step (2D), the Routing mechanism 1450 may route to the said (Remove (1400UI_r)) and through that function, the associated awPage instance will be retrieved from ScreenIconMap 1490 based on Key 3002, and properly deleted from Client system 1400 memory, along with any children awUI objects and References 1630 (discussed in data-biding 1600 system), and finally removed from ScreenIconMap. Note that this would not delete the actual associated ScreenNormal Object 3000 instances or any of its children Objects from Server 100 and Database 500, as Client 1200 is not requesting a deletion, they are only requesting the showing of another ScreenNormal awPage. Hence, this will remove the previous ScreenNormal's associated awPage representations from Client system 1400 memory only, without affecting the Objects 3000 instances within Server 100 that they are representing.

Finally, FIG. 13B case 3 demonstrates the process of, in some embodiments, reflecting updates on awUI icons which may be made possible through the Routing system 1450. This functionality may be essential for providing fully responsive and interactive awUI objects, ultimately promoting highly interactive, configurable, and functional screens and applications. Whenever a Value 3104 change may be triggered on an Object Property 3100 instance level, if the associated Object 3000 that the Object Property 3100 instance belongs to has a respective awUI object representation within any Web Client 1200 awPage being viewed, then a similar change must occur on that awUI representation, for the Web Client 1200 to display that reflected change from the Object Property 3100 Value. The Routing 1450 system may provide this mechanism, without which it would not be possible to see any updates reflect on awUI, without having to reload completely the screen from Server 100 again. As illustrated in FIG. 13B, case 3, the routing mechanism begins after an RPC 1299 response may be sent back from Server 100 to update a certain Object Property 3100 instance (the request could have been initiated by a Web Client 1200 or any script or script function). This response will comprise of data such as: the key 3002 and Class name 3001 of the Object 3000 instance whose Object Property 3100 instance Value 3104 was changed, the new value that the Object Property 3100 Value 3104 was changed to, and the class property name 2031 of the associated Class Property 2030 that the Object Property 3100 stems from. Afterwards in (3A), the Routing 1450 system may utilize the key 3002 sent from the data from Server 100 response and retrieve the respective awUI JavaScript object instance based on that key 3002 from ScreenIconMap 1490. This JavaScript object will contain all the existing properties of the awUI and all the functions necessary for updating those properties of awUI (as shown and described in FIG. 14A). In some embodiments, the Routing 1450 system may then, in (3C), utilize the Class Property Name 2031 (from Server 100 response data), to form the function name (by putting together the prefix ‘m”+2031) that will be called dynamically. This dynamic function name setup, with response data as parameters, may be used route to the desired awUI JavaScript object instance to process the change properly. Then, in some embodiments, in Step (3D), the Routing system 1450 may route to this associated function within that awUI class, passing it the new value (from Server 100 response data) that the associated awUI property needs to update to. As said earlier within the context of awUI objects, this will execute the business logic defined within the associated “m′+Class Property Name” function to effectively render the new value change on the awUI icon for Web Client 1200. So, for example, if the Object Property 3100 change was a ScreenButton Object 3000 that had its “BackColor” Object Property 3100 instance Value 3104 change, then the Routing system 1450 would route to the associated ScreenButton's awUI instance and run the “mBackColor” function of that awUI JavaScript Object, rendering the change in the background color of the ScreenButton awUI instance for Web Client 1200. This same process also holds true for reflecting updates on data bound awUI instances when their associated Target 4500 Object 3000 instance or Object Property 3100 instance may be changed on the Server 100 side. The Routing mechanism 1450 in this case may use the same logic to retrieve the associated “‘m’+Class Property Name” function and route to that appropriate function within the awUI JavaScript Object that may be acting as a Source 4400 to process and reflect the change. This case is discussed in more detail within the context of the following Data-binding 1600 system.

In some embodiments, the client-side Data Binding 1600 system works alongside the Server 100 side data-binding mechanism discussed prior in FIGS. 3F and 3G. The data sent back from Server 100 data-binding mechanism regarding associated Sources 4400 and Targets 4500 may be utilized within the client-side Data binding 1600 system for processing, utilization, and management of data regarding the different bindings within a ScreenNormal Object 3000 instance or a Screen Popup Object 3000 instance within Client 1400 system memory. The Data-binding 1600 system may bridge the gap between Sources 4400 and Targets 4500 within Server 100 to getting processed and becoming live, interactive data bound icons at the client-side, forming highly configurable and functioning applications. In some embodiments, the Data-binding 1600 system maintains said data-bindings within Client system 1400 memory, hence there is no need to request data from Server 100 every time Absolute 4001 or Relative 4002 paths that already exist within Client 1400 system memory are utilized. This saves traffic between Web Client 1200 and Server 100 and prevents any sort of lag for Web Clients 1200 whenever they data bind.

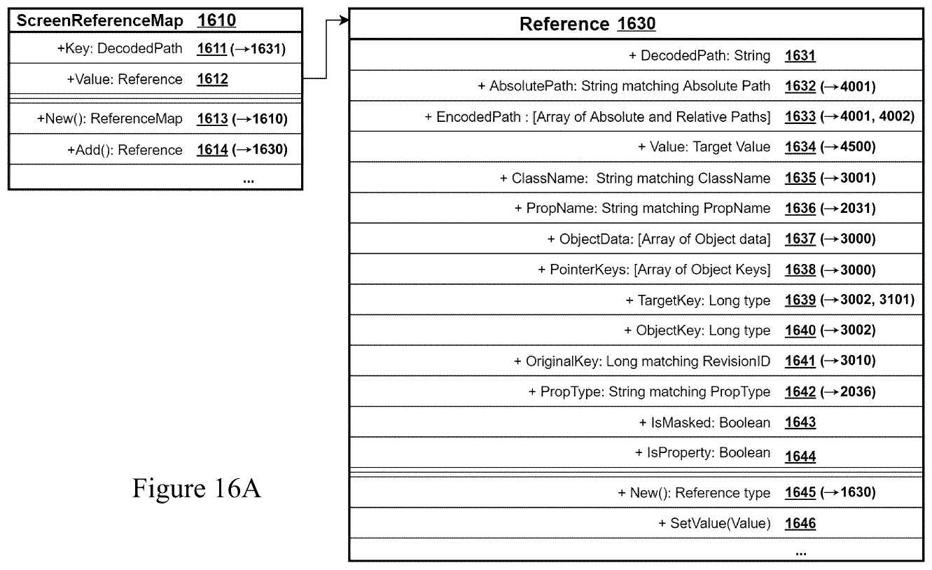

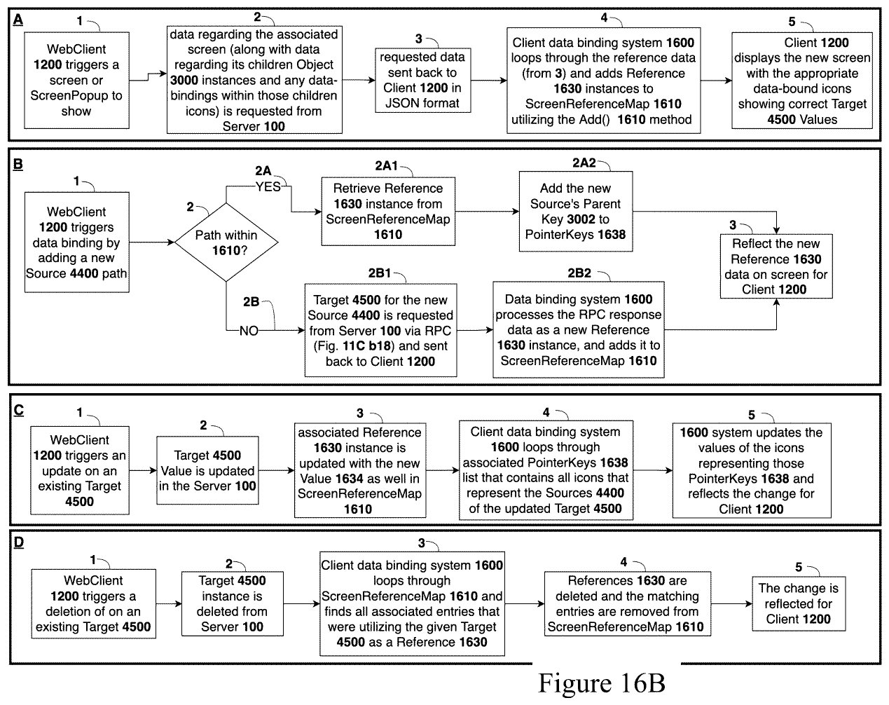

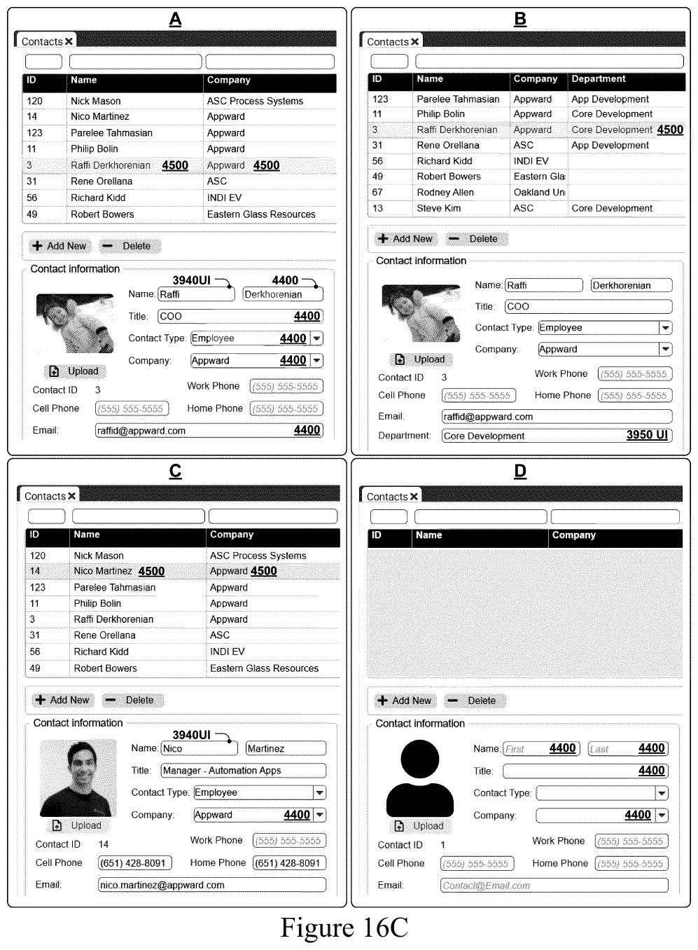

The following sections will discuss the major components comprising the said Data binding 1600 system that provide the core of data binding functionality on the client-side. One such component, as illustrated by FIG. 16A, in some embodiments, is the Reference 1630 data structure, which may be a custom JavaScript class on the client side that comprises of data binding information on Targets 4500 and their associated Sources 4400 sent from Server 100. The Data binding 1600 system creates a Reference 1630 instance for each data bound Target 4500, which then may be utilized by the Client 1400 Application System. The following is a breakdown of some of the fundamental fields of a Reference 1630 instance: 1) DecodedPath 1631 field which serves as the unique identifier for a certain data-bound Target 4500. As said previously in the discussion of data binding from FIG. 3H, a decoded Path 4000 may be one that has been evaluated within Server 100 based on a Relative Path 4002 or Absolute Path 4001 entry into a format that can uniquely identify the Target 4500 location within the object tree hierarchy of the entire Server 100 system. As said prior, Decoded Paths 1631 are in “@@!!_Key” format if parsed from a Relative Path 4002 with the key indicating the relative starting Object 3000, on the other hand they remain the same as the Absolute Path 4001 if they are parsed from an Absolute Path 4001. This Decoded Path format may be necessary to uniquely identify Targets of 4500 Relative Paths 4002 internally within Data Binding 1600 and Server 100 systems, however the end user or Web Client 1200 does not see the Decoded Path format. 2) The Encoded Path 1633 may be an array of all the different forms of Paths 4000 (Relative 4002 or Absolute 4001) that each Source 4400 may be using to point to a specific Target 4500. Some values in 1633 could be 4001 format, others 4002. The EncodedPath 1633 field keeps track within Client 1400 System memory, all the distinct Path 4000 formats the different Sources 4400 are utilizing to point to the exact same Target 4500. The EncodedPath 1633 field may be one structure that may be used to match associated awUI icon property values that are acting to the respective Reference 1630 objects within ScreenReferenceMap 1610 that they are utilizing. 3) In some embodiments, the Value 1634 of the Reference 1630 instance may be the actual end value of the Target 4500. If the Target 4500 may be an Object Property 3100 instance, then the Value 1634 will match the Value 3104 of the said Target 4500 Object Property 3100 instance. If Target 4500 is an Object 3000 instance, then Value 1634 may contain custom data regarding the Object 3000 instance (based on the Class 2000 instance that a Source 4400 stems from). 4) PointerKeys 1638 may be an array of all the parent Object 3000 instance Keys 3002 representing all the different parent objects of every Object Property 3100 instance that may be utilized as a Source 4400, pointing to the exact same Target 4500. In some embodiments, the PointerKeys 1638 may be how a Reference 1630 knows about which awUI icon instances are utilizing it. 5) The TargetKey 1639 field will match the key field of a given Target 4500 instance, if Target 4500 may be an Object 3000 instance, then TargetKey 1639 will match field 3002, if Target is an Object Property 3100, then TargetKey 1639 will match field 3101. The Reference 1630 class may also comprise some fundamental functionality used within Data binding 1600: 1) New 1645 function may be the constructor method that will generate a new Reference 1630 instance with all the necessary data points sent from Server 100. 2) SetValue 1646 method may be used to set new values to existing Targets 4500 based on changes within the Sources 4400 that are targeting them. For example, in some embodiments, this could be from a textbox (Source 4400) that may be data bound to a data table query (Target 4500) and may be used to filter the data table. When the textbox's value is changed by Web Client 1200, then this SetValue 1646 method may be used to trigger the Target 4500 (in this case the data Table query to change) and show data based on the new query for Web Client 1200.

In some embodiments, these Reference 1630 instances would not serve much purpose if they were not maintained within Client 1400 System's memory, which brings forward the next major component of Data binding 1600 system, the ScreenReferenceMap 1610 collection. Any Reference 1630 instance that gets created upon receiving data-bound Target 4500 data from Server 100, gets added to ScreenReferenceMap 1610 collection. In some embodiments, the ScreenReferenceMap 1610 may act as the client-side storage collection for the various References 1630 that are used throughout the Client 1400 System's lifecycle. This collection may be a part of Client 1400 System's memory, and it allows for quick access and retrieval of necessary Reference 1630 instances without needing to request them from Server 100 again upon use. This may optimize client data binding operations because it minimizes the need to request data from Server 100 every time data-bound Targets 4500 need to be utilized. Instead, when Client 1400 System utilizes any form of Path 4000 for data binding their icons, the client-side 1600 system will decode that path first onto the decoded path 1631 format and check if this ScreenReferenceMap 1610 collection contains the Reference 1630 associated with that path 1631, if so, then the Reference 1630 data will be retrieved and used from the 1610 map in client memory without ever needing to ping Server 100. This keeps traffic between Web Clients 1200 and Server 100 to a minimum. The ScreenReferenceMap 1610 contains all Reference 1630 instances that are utilized within the Sources 4400 belonging to a given ScreenNormal and any ScreenPopups that the Web Client 1200 may be viewing. In some embodiments, the ScreenReferenceMap 1610 collection may be refreshed with new Reference 1630 instances (and disposing of previous screen's References) whenever a Web Client 1200 navigates to a different screen (ScreenNormal class type—see below on web pages). These said Reference 1630 instances may be keyed (Key 1611) by their unique Decoded Path identifiers (matching DecodedPath field 1631) within the ScreenReferenceMap 1610. The ScreenReferenceMap 1610 may be generated once per Web Client 1200 connection with calling the New 1613 constructor method: This may create a new ScreenReferenceMap 1610 instance that stays active and maintains References 1630 throughout the Web Client 1200 lifecycle. Any Reference 1630 that should be maintained within Client 1400 System memory may be added to the ScreenReferenceMap 1610 collection using its Add 1614 method.

The following sections will detail the utilization and processes of the said Reference 1630 and ScreenReferenceMap 1610 structures. This is illustrated through FIGS. 16B and 16C. FIG. 16B diagram A breaks down the process of when and how data-bindings are loaded through the Data-binding 1600 system onto Client system 1400 memory. In some embodiments, in Step (1), a Web Client 1200 requests the showing of a ScreenNormal or a ScreenPopup Object 3000 instance. The request may be received in Step (2), where the Server 100 processes the request and packages the data to be sent back in JSON format. This data may include information on the children Object 3000 instances of the screen being requested and any data-bindings those children Objects 3000 are utilizing (More on the rendering aspect of the awPage will be discussed in latter sections within the context of web pages, this section focuses on how the data-bindings are loaded as References 1630 in Client 1400 system memory). In Step (3), the data from (2) may be received by Client 1400 System Application and in Step (4), the Data binding system 1600 will loop through this data (see FIG. 15A diagrams C1-Ck for a sample of data-bound data that the Server 100 sends back to Client 1400 system) and generate new Reference 1630 instances from it, then add those Reference 1630 instances to the ScreenReferenceMap 1610 for storage in Client 1400 system memory. Once all the received data from (2) may be processed, in Step (5) the Client 1400 system will render their newly reflected Screen or ScreenPopup awPage, with the appropriate data within their awUI icons representing the Sources 4400. This result is illustrated in FIG. 16C diagram A (note that FIG. 16C is based on the same Object 3000 instances and tree hierarchy that is depicted by FIG. 3B that is showing an application for managing contacts of a certain organization), where Object 3000 instance 3940 awUI along with all the other awUI containing Sources 4400 are data-bound to the children data field Objects 3000 instances of data Table (3911 From FIG. 3B) to display various data fields from that data Table 3911.

FIG. 16B diagram B represents the process of Web Client 1200 adding another Source 4400 within an existing ScreenNormal or ScreenPopup awPage that has already been loaded. In some embodiments, this is demonstrated through Step (1), where the Client 1400 System adds a new ScreenTextbox Object 3000 instance with a Source 4400 value (i.e., “Myparent.datContacts.Department\Value”). In Step (2), the Client-side data binding system 1600, would first check if the decoded version of the Path 4000 that was entered as the Source 4400 Value, already exists in the ScreenReferenceMap 1610 or not. To determine if the Reference 1630 already exists within Client system 1400 memory, the Data-binding system 1600 would check if the decoded Path 1631 version format (i.e., “@@!!_Key.dataContacts.Department\Value”) of the Source 4400 Value that was entered in the ScreenTextbox has an exact match with any of the ScreenReferenceMap 1610 Keys (1631). If (2A) there is a match, that means that exact Reference 1630 has already been loaded with Client system 1400 memory, hence (2A1) the associated Reference 1630 instance of the matching Key 1631 will be retrieved from ScreenReferenceMap 1610 residing in Client system 1400 memory, and in Step (2A2) the ScreenTextbox Object 3000 instance Key 3002 will be added as part of the PointerKeys 1638 array of that retrieved Reference 1630 to indicate that the textbox may be now successfully bound to its Target 4500 and that the said Target 4500 now has one more awUI icon utilizing it. However, if (2B), a match based on the decoded Path 1631 is not found within ScreenReferenceMap 1610, then (2B1) the Target 4500 data will be requested from Server 100 by issuing an RPC 1299 Message (usually “GetPropByPath” b18 from FIG. 11C) from the Client system 1400 and (2B2), the data-binding 1600 system will process the received data from (2B1) constructing a new Reference 1630 instance using the New 1613 constructor and adding the newly constructed Reference 1630 to the ScreenReferenceMap 1610 with the Reference's 1630 decoded Path 1631 field being the key 1631 that represents that Reference 1630 within ScreenReferenceMap 1610. Subsequently, in some embodiments, both branch-offs from Step (2) will ultimately lead to Step (3), where the Client 1200 will then see the associated Reference 1630 Value 1634 field, which represents the Target 4500 value (i.e., “Core Development”), get reflected within their awUI ScreenTextbox instance. This example is demonstrated in FIG. 16C, diagram B, where a newly added 3950UI (a ScreenText class type object instance awUI) may be reflecting a new Target 4500 data Field (“Department”) in this case, to represent the department of the contact that may be highlighted within the table.

FIG. 16B diagram C represents the process of Client 1200 updating a given Target 4500 value. The Client 1200 triggers this change in Step (1), usually firing an RPC 1299 Message of b19 type from FIG. 11C, which may be based on a Path of calling screen icon object instance. Because of the RPC message, in Step (2) the value of the Target 4500 may be updated on the server 100 side. Then in Step (3), after Server 100 responds back to Client 1200, on the client side, the associated Reference 1630 instance for that target would have its Value 1634 field updated to the new value that was set by Client 1200. Then in Step (4), the Client-side data binding 1600 system would loop through the associated PointerKeys 1638 of that Reference 1630 that may be associated with said Target 4500, and in Step (5), utilizing the Routing 1450 system will route to the associated UI icons (represented by the PointerKeys 1638) and update them to reflect the new Value that was set. This is illustrated by FIG. 16C diagram C, where Web Client 1200 has changed the row within the dataTable Object 3000 instance, which would change the values of all the data field Targets 4500 on the Server 100 side. This change would then propagate and be reflected by all the UI icons (3940, etc.) that were targeting the data fields in order to reflect the new target 4500 values.

FIG. 16B, diagram D illustrates this process that occurs when a Web Client 1200 triggers the deletion of an Object 3000 instance that may also be an existing Target 4500 of a data-binding. In Step (1), the request for the Target 4500 Object 3000 instance deletion may be sent to Server 100 through the “DeleteObjects” RPC (b11 From FIG. 11C) for Server 100 to process the deletion. In Step (2), the target 4500 may be deleted from Server 100, and after the RPC response may be sent back to the client system 1400, the Data binding system 1600 in Step (3) will loop through the ScreenReferenceMap 1610 and find any associated Reference 1630 matching that Target 4500 that was deleted. The Data-binding 1600 system will do this by checking each Reference 1630 within ScreenReferenceMap 1610 for a TargetKey 1639 that matches the key 3002 of the Object 3000 that was deleted. Then in Step (4), all the matching Reference 1630 instances that were found would be deleted and removed from ScreenReferenceMap 1610. Then in Step (5), Client 1200 would see the change reflected within their awUI icons that were utilizing that Reference 1630. This is illustrated by FIG. 16C, diagram D, where the deletion of the “datContacts” data Table 3911, caused all the awUI icons that were being used as Sources 4400 to no longer display the associated Target 4500 values since the Target 4500 data fields are now deleted. A similar case can also occur when the data-binding is severed by a Source 4400 deletion, rather than a Target 4500 deletion. For instance, if the ScreenTextbox awUI from the earlier example from FIG. 16C, diagram B had its Source 4400 Value 3104 deleted (i.e., changed from “Myparent.datContacts.Department\Value” to empty “ ”), or if the ScreenTextbox awUI itself was deleted, then the associated Reference 1630 instances would get updated accordingly based on the following steps: The decoded path 1631 version of the Source 4400 value that is getting deleted would be used to retrieve the associated Reference 1630 instance it is utilizing. Then the data-binding system 1600 would check that Reference's 1630 PointerKeys 1638 array and remove the associated key 1400UIb of the ScreenTextbox awUI from within the PointerKeys 1638 array, indicating that the ScreenTextbox awUI is no longer bound to its previous Target 4500. If the PointerKeys 1638 Array of the Reference 1630 is empty after the removal of the associated awUI key 1400UIb, then that means there are no longer any awUI icons utilizing the said Reference 1630, meaning nothing within the Web Client's 1200 associated awPages is pointing to the said Target 4500 binding represented by the Reference 1630. In this case, the whole Reference 1630 will be deleted from Client system 1400 memory and its associated entry removed from ScreenReferenceMap 1610, since it is no longer used. If there are other entries still in the PointerKeys 1638 array, then the Reference 1630 will remain in Client system 1400 memory as other awUI icons are still utilizing that Reference 1630.

The Data-Binding 1600 system allows for efficient processing and management of References 1630 within Client system 1400 memory, reducing traffic between the Client system 1400 and Server 100, and promoting rapid configuration and use of data-bound awUI icons. The Data-Binding 1600 system bridges the gap between Target 4500 data that gets sent from Server 100 onto processing them as Reference 1630 instances in Client system 1400 memory, allowing for Web Clients 1200 to view and manipulate said data through their bound awUI icons, ultimately empowering highly configurable, data-driven applications.

Building on the detailed definitions of the base awUIs common class 1400UI features, the Client-side Routing 1450, the Data-Binding 1600 and the RPC messaging 1500 systems, the focus here will be to show how the Client-side 1400 System application renders Web Pages served by the WebServer 1000, that contains said awUIs of any Class (2900UI) type. For clarity of discussion purposes any Appward web page will be termed awPage, which can be of one of two class types: ScreenNormal (2901 and 2901UI) and ScreenPopup (2902 and 2902UI) Class 2000 instances. There are few UI differences between these two types, which will be explained downstream, but most of their characteristics and internal system mechanisms overlap, comprising: A) Web Page (FIG. 15A) class model that has a much more complex screen icon with Class business logic at both the Server 100 and the Client system 1400 sides. As part of its internal logic, it does much more sophisticated rendering capabilities on itself, and its children, that also include features comprising: B) Screen data updating mechanism for itself and its children icons, C) Rendering of all bound data (via Paths 4000) within its containment area, D) utilizes the Screen Designer Editor tool and E) some other auxiliary tools that its children awUIs do not have.

The awPage extends the awUI data model, conceptually, because it is the implementation of more complex and larger user interface class, as shown in FIG. 15A starting with the ScreenNormal 2901UI Class 2000 instance. ScreenNormal has a lot of Class Properties (2030 instances) that give a diverse variety of web page features with dynamic widget renderings, as shown in said figure, and live data updates, comprising: 1) Starting with dimensioning and positioning a Screen (Left, Top, Width, Height, Outside Height, Outside Width, Extents/Content Width, Extents/Context Height) within a Browser Body (1415B), 2) Setting its Background Color, Border Controls (Color, Width and Radius) or Background Image, 3) Scaling, Auto scaling, and Viewport capabilities, 4) Scrolling capabilities, and 5) Grid and Snap Settings for screen design mode.

As seen in FIG. 15A, ScreenPopup (2902UI) class type further extends from the base ScreenNormal (2901UI) class by having some differentiating features that's useful for end user applications. Few notes to cover on these main differences between a ScreenPopup 2902UI web page (awPage) type and its ScreenNormal (2901UI) base counterpart: A) a ScreenNormal page covers the entire background screen of the browser body 1415B (just like standard common web sites in this field domain), unlike a ScreenPopup where the screen interface is a movable (2902UI_e3) popup, with a header area (2902UI_e2) and Caption (2902UI_e1), that can be resized (2902UI_e4), minimized (2902UI_e7), maximized (2902UI_e8) and closed (2902UI_e9—calling its destructor method for complete removal from memory); B) User can pop multiple (2902UI_e5) UI instances (“Orphan” copies—not “Original” ones) of the same Object 3000 instance of ScreenPopup type within any Client 1400 System unlike in a ScreenNormal type (because it takes the entire background real estate of any HTML Body). The advantage of allowing multiple ScreenPopups 2902UI means that the same application UI can be opened multiple times at any given time if needed within the same Web Client 1200. Now since said “Orphan” copies can also be made for ScreenNormal 2901UI types, then ACROSS Web Clients (1200) the same background screen page (same Object 3000 instance of ScreenNormal type) can be served uniquely to each end Web Client 1200 isolating all other instances and in turn users' interactions; C) Background 2901UI ScreenNormal web page can be independent of any number of currently popped ScreenPopup 2902UIs (awPages) and vice versa. The only way to remove a current awPage of ScreenNormal 2901UI type is by navigating to another awPage of ScreenNormal 2901UI type. On the other hand, a User has the option to close any given awPage instance of ScreenPopup 2902UI type at any time independent of any other ScreenPopup 2902UI instances or any background ScreenNormal 2901UI awPage type navigations; D) ScreenPopups can be anchored (2902UI_e10) as shown in FIG. 15C using a “ScreenAnchorArea” Class 2000 instance type. A “ScreenAnchorArea” Object 3000 instance, whenever found within a ScreenNormal 2901UI awPage, gathers, aligns, and contains all ScreenPopup 2902UI object instances (that have their respective anchored property 2902UI_e10 enabled) within its defined area as shown in FIG. 15C UI_ANCHOR. With anchoring, the ScreenPopup awPages are still there and active but they are grouped like a menu tab to be switched around as the user selects the application that they want to interact with in a responsive manner. Finally, one additional technical note is that each ScreenPopup needs to contain the Paths (4000) that it is using and needs for its proper functioning within the Client 1400 System. For this reason, 2902UI_e19 map holds Reference 1630 object instance Paths that any said ScreenPopup 2902UI awPage is utilizing. These said Paths (4000) are stored in 2902UI_e19 as well as the ScreenReferenceMap 1610 in order to preserve them from being wiped out of ScreenReferenceMap when background Screens are being switched, since popups along with their references must remain active and functional when background screens (ScreenNormal 2901UI types) are switched.

In this section, we will cover the base fields and structure that will enable any web page's systematic features. In FIG. 15A the data model of ScreenNormal 2901UI class is covered with the different Properties, Methods, and Events that any awPage uses to form a visual and interactive environment within a Web Client 1200. The ScreenNormal 2901UI class do has the same properties, methods and events as the base template awUI 1400UI class as was discussed before. So, properties like “Top”, “Left”, “Width”, “Height”, “OnFocus” have been left out in order not to avoid redundancy of discussion. But the ScreenNormal do has these Class Property (2030) instances and many more that are not shown in the FIG. 15A due to focusing on the main features and mechanisms that make a ScreenNormal behave like a dynamic web page with live data, even bound data, that is in sync always with the Server 100 system. These said ScreenNormal base fields are comprised of: A) The “ClassName” (2901UIa), the “Key” (2901UIb), and the “PropertyMap” (2901UId) have the same meaning and utility as it was discussed in the awUI 1400UI data structure. But it is mentioned again in here to emphasize their criticality in the said awPage's overall system; B) Children (2901UIf) represents the awUI icons that are extracted from the data response sent by WebServer 1000 back to Client 1400 system, as shown in FIG. 15B, regarding the ScreenNormal 2901UI Object's Children when an awPage is being shown. More discussion coverage downstream on this topic on how a web page, with its Children (2901UIf), is rendered within a browser. The mChildren (2901UI_mpC) call then instantiates these associated awUI icons and places them in said Children (2901UIf) map for easy access and retrieval when it is needed; C) Element (2901UIe) is the pure HTML representation of the rendered awPage, which has all the matching properties values pulled from PropertyMap (2901UId) and the matching awUI icons from Children (2901UIf). This is the final rendered HTML (Div tag element) of the awPage that covers the entire Browser Body 1415B; D) SandboxID (2901UIh) is the respective SandboxID (3009) field of the ScreenNormal Object 3000 instance at the Server 100. Useful for keeping track of which Sandbox any active screen belongs to; E) OriginalKey (2901UIi) holds the Key 3002 of the original ScreenNormal Object 3000 instance on the Server 100 side, if said Object was under a linked Sandbox Object 3000 instance; F) RevisionID (2901UIg) holds the Key 3002 of the Original ScreenNormal Object 3000 instance, if the one being rendered at the Client-side is a copy (an Orphan for example).

Now regarding business logic method calls for said 2901UI class, these methods are what renders any awPage based on the data sent, within an RPC 1299 message, from the WebServer 1000 to an actual screen visual. Through these methods also the system can process any new live changes within the existing rendered awPage dynamically based on any changed Value 3104 in the associated Object Property 3100 instances. These methods bridge the gap between the rendered awPage properties and its associated Server 100 side ScreenNormal (2901) Object Property 3100 instances, comprising: F1) New (2901UI_N) is the constructor method that gets called when a new ScreenNormal is being shown to build the associated awPage with all its awUI icons. This utilizes data sent from WebServer 1000 that contains Object Property 3100 names (2031) and values (3104) and Object 3000 instance Children information. See FIG. 15B for a sample screen data, in JSON format, sent from WebServer 1000 to a Web Client 1200. Said method uses that data to construct a fully rendered awPage matching and in sync with the ScreenNormal 2901 Object 3000 instance. Throughout the execution of this method, all the other “m” prefixed methods get called also passed with the appropriate data (as parameters) to process and render each corresponding property or screen icon awUI data point for said Web Client 1200; F2) Remove (2901UI_R) is the destructor method that will dispose of all contained children awUI objects including their internal data from the Web Client 1200 that is associated with said awPage. This is called when a screen is being switched by Web Client user to dispose of old awPage data and load a new one as part of screen navigation process flow; F3) mShow (2901UI_mpS) is the client-side method that is called within the New (2901UI_N) constructor as it is building the awPage to be displayed at the client page. This will also trigger the process to Remove (2901UI_R) the old (existing) screen data before showing the new one. This is not the same thing as the Server 100 side ScreenNormal (2901) class's “Show” method (See FIG. 3I 2902P63 from ScreenPopup's example), but it is a continuation of its response when it gets to the client front; F4) mChildren (2901UI_mpC) method called during constructor routine to build all associated children awUI object icons contained within the Children (3008) field data sent from WebServer 1000 during the showing of a new ScreenNormal (2901) Object 3000 instance. The generation of the associated awUI icons occurs through their own constructor calls. Afterwards the awUI icons get stored in Children (2901UIf) map for direct access and retrieval; F5) mTimedUpdate (2901UI_mpTi) is the method that dictates if an awPage will have dynamic data updates, or not, to continuously render any updated data from the Server 100 side. This is based on the TimedUpdate Object Property 3100 instance of said ScreenNormal (2901) Class 2000 instance. This is a powerful tool that makes awPage update automatically based on changes in their associated Object 3000 instances and Object Property 3100 instances at the backend in Server 100 that then get rendered on the frontend within said Client 1400 system's awPage; F6) mUpdatelnterval (2901UI_mpUi) is the method that dictates how often said awPage will update itself with the latest data form Server 100 (in seconds) if TimedUpdate (2901UI_mpTi) is true. This is based on the UpdateInterval Object Property 3100 instance value of said ScreenNormal (2901) Class type; F7) mUpdate (2901UI_mpU) is the method that will retrieve the latest data from the Server 100 side comprising: 7a) Object Property 3100 instance Value 3104 changes, 7b) Object 3000 instance additions, 7c) Object 3000 instance deletions, 7d) Object 3000 instance moves, and data-bound target 4500 changes. All these data points will be checked, assimilated, and sent over to Client 1400 System to update the respective awPage with the latest data from Server 100. This (update) data set is closely structured as the data set shown in FIG. 15B (when loading a new web page). And that's because when said (update) data set gets parsed and is extracted into individual items (categories), these are then iteratively complete their respective update purpose by utilizing also the Routing 1450 and Data Binding 1600 Systems with the Client 1400 System application.

Finally, regarding declared events that get triggered for said 2901UI class based on user interactions with said awPage on the Client-side system, these events comprising: E1) OnUpdate (2901UI_s1) triggers when the awPage is in process of being updated (2901UI_mpU). Using the OnUpdate Event of ScreenNormal Object Property 3100 instance, user can have custom scripting to perform additional actions on each Update call; E2) OnBeforeShow (2901UI_s2) triggers when the awPage is requested to be displayed on the frontend. Using the OnBeforeShow Event of ScreenNormal Object Property 3100 instance, user can have custom scripting to perform additional actions taken on the Server 100 side just before the new screen is sent over to be displayed at the Client end. This can be useful for example, when user wants to clean up some residual data before showing a new UI at the client-end on launch of an application; E3) OnAfterShow (2901UI_s3) triggers when the awPage has been displayed on the frontend. Using the OnAfterShow Event of ScreenNormal Object Property 3100 instance, user can have custom scripting to perform additional actions taken on the Server 100 side just after the new screen was shown at the Client end. This can be useful for example to take some client-side setup actions (resize the UI window based on browser window) after the application UI has been launched within a Web Client 1200; E4) OnClick (2901UI_s4) triggers when the awPage is being clicked on by user. Using the OnClick Event of ScreenNormal Object Property 3100 instance, user can have custom code scripting to perform additional actions at the Server 100 side to respond to a user Click, if needed.

There are a lot of other events belonging to the awPage class, to name few, such as BeforeResize, OnKeyUp, OnMouseMove, OnMouseDown, OnMouseUp, OnDoubleClick, OnWheel, OnMenu and OnFocus that give the awPage web page a richer user experience to customize logic and make smarter richer end user applications on the fly.

Next will show how a sample awPage is rendered all together, with its internal mechanisms, at the client-side 1400 system once the data is served from the Webserver 1000, starting with WebSocket 1020 Server specifically as an RPC 1299 request has been made for a new web page to be shown (e.g., “Show” Method 2902P62 called). This would be the practical case for example when a user is logging into their own workspace where the first thing they would see is their dashboard, which is typically a ScreenNormal (2901) web page (awPage) type, or when said user launches an application to take specific business operations via its UI that usually is a ScreenPopup (2902) web page (awPage) type. As shown previously, in FIG. 11B, C and D, the lifecycle of an RPC 1299 that travels to a Server 100 and back to the requesting Web Client 1200 with a response. In requesting a new web page, the commonly used B19 (“SetPropByPath”) RPC 1299 is fired (1), over the Web Client's WebSocket channel, containing the path of its target 4500 screen request, as shown in FIG. 15C. Usually, the Object Property 3100 name is called out too in the said Path (a parameter of said RPC B19), for example “Show” if the application's intention is to work with an “Orphan” copy of the original stored application interface, or “ShowOriginal” if the intention is to work directly with the original object 3000 instances. If the Property 3100 name is not mentioned, then the system defaults on calling the “Show” method of the screen class (ScreenNormal or ScreenPopup types) because “Show” returns an “Orphan” copy that has the advantage of serving the end user a private independent copy of the application 3910UI user interface to avoid any conflicts with other clients using the same app. Anyways, the RPC B19, after checking that the Path is valid (2), gets to its target 4500 screen Object 3000 instance and extracts (3) (using the “Show” method within the said Screen class declared on the Server 100 side see FIG. 3I previously discussed on how this happens dynamically within that system) all its data, including its hierarchical children data in a JSON format. See FIG. 15B as an example showing a partial data view of the “popMain” 3910 Object 3000 instance's data set (including all the required Property 3100 information and similarly its Children's data). The information from FIG. 15B as it goes through the RPC Messaging 1500 system, that parses the JSON data, and via the Routing 1450 system ends up calling first the ScreenPopup class's constructor method (2901UI_N FIG. 15A) based on Class name (3002 data field from FIG. 13B) and the ScreenNormal Class object (2901UI from ScreenClassMap 1480) to start building the awPage object instance on the front end. All the ScreenPopup's Key (2901UIb), Path (2901UIc), SandboxID (2901UIh), OriginallD (2901UIg), and PropertyMap (2901UId) fields (and more that are not shown) are set by parsing the incoming data. ScreenPopup's PropertyMap (2901UId) in turn sets all the “popMain” 3910UI object instance's dimensions and other “Property” (2036) related style and feature settings. Afterwards the system process moves on to recursively create each of its children screen icon widgets contained within it (box B in FIG. 15B representing 2901UIh) by calling dynamically (utilizing Routing 1450 system) each individual awUI icon's constructor (1400UI_N) method and go through the same process of setting each child icon's characteristics (based on its Class name 1400UIb), styling, smarts and ending with having a fully rendered ScreenPopup web page (awPage) in the end at the Web Client 1200 that the user requested. Also, from FIG. 13B are the array of bound data (C1 through Ck) information that this ScreenPopup “popMain” 3910UI contains within it. This set of bound data, after being parsed by the RPC 1500 system, will be looped over to call individually the Reference class 1630 constructor, through the Data Binding 1600 system from FIG. 16B, to create individual data bind (A) object instances that will be stored in the global Reference Map 1610. These Reference 1630 instance objects will be used to update targeted data between the Server and Screen UI as discussed before.

Now it is important to remind that Appward has dual communication modes between its Client 1400 system and the Server 100. All of the above, in serving screen objects from the Server 100 to be rendered as web pages (awPage) within the Client happen via the WebSocket 1020 Server route. Moreover, the HTTPS WebServer 1010 is still utilized in serving any Client 1400 system media contents and resources. For example, the Screen Image Profile 3952UI icon within the above-mentioned application interface 3910UI is rendered by issuing an URL request, based on one of its Object Property 3100 values (3104) having the correct full Image file path (“//Public/Contacts/Raffi.jpg”) in it, from the Client browser to the HTTPS WebServer 1010. Each of the declared Screen icon 2900UI classes on the client-side similarly have their specific business logic to request resources that meet their respective instantiated Object's awUI needs. For example, a ScreenVideo icon (if having the correct path) will issue an URL to stream video, a ScreenPDF viewer class screen icon will request (if having the correct folder/name definition) an URL for a respective PDF file to be loaded within itself, all depending on the custom application needs, etc.

At the end of the above ScreenPopup awPage object instantiation process, exiting its class constructor (2902UI_N), an application user interface (3910UI) will be rendered as shown in FIG. 15C with all its children icons (3940UI, 3936UI, 3952UI, 3970UI, etc.) that have some of their data bound to targets (4500) using the binding 1600 system. Such an interface is dynamically rendered over the persistent WebSocket communication channel (1550) and any object with its data are live and can be updated immediately through said channel. As mentioned above, all Appward web pages, whether ScreenNormal or ScreenPopup type, have their updating mechanism within its base class declaration 2901UI, the Update (2901UI_mpU) method. There are couple of ways that this Update method can be called, comprising: A) Using the “TimedUpdate” and “UpdateInterval” Object Property 3100 instances that are of “Method” (2036) type. When setup properly, these two properties have business logic within themselves to then automatically start firing RPCs (1299) using B19 to call the “update” method on that specific screen awPage object's instance. This is the automatic continuous updating approach which is great for monitoring live data that change often and fast (I/O monitoring on machinery, stock market prices, etc.); another approach is by B) using the “RunClientMethod” (FIG. 4B J2) scripting function and passing it a path (4000) targeting the specific screen awPage object's “Update” Property method. This script code can be contained say within any one of the screen icons within said awPage (e.g., within “Submit” 3937UI ScreenButton's “OnClick” Object Property 3100 instance's Event script). When this sample Object Property 3100 instance Event is triggered and the “RunQuickScript” (C10) RPC 1299 (FIG. 11C) fires and returns back: The J2 script function, that's coded within the triggered Event, will call said Screen's (awPage) “Update” Method (2901UI_mpU) that will in turn start the process of screen update mechanism from the client to the Server and back. This approach is called the event-based screen update because it is based off individual user interactions within the application's user interface.

Now the Screen Update (2901UI_mpU) mechanism is comprised of six possible data types when the response from the Server 100 is returned. Any such response can have any number of configurations of said six types within any given “Update” call within any given web page. The first three of said types is handled by the Routing 1450 system, while the last three are handled by the data binding 1600 system. The six types contained within the response data, coming from the Server 100 side, and routing (via Routing 1450 system) dynamically within “mUpdate” (2901UI_mpU) function declaration, are the following: 1) New screen icon is added to said awPage object. This type of data is processed using the Routing 1450 system as shown in FIG. 13B (1); 2) An existing screen icon Object 3000 instance is deleted. This type of data is processed using the Routing 1450 system as shown in FIG. 13B (2); 3) An existing Object Property 3100 Value is changed. This type of data is processed using the Routing 1450 system as shown in FIG. 13B (3); 4) An existing target (4500) Value is changed. This type of data is processed using the Data Binding 1600 system as shown in FIG. 16B (C); 5) A new data bound exists within the scope of said Screen. This type of data is processed using the Data Binding 1600 system as shown in FIG. 16B (B); 6) An existing data bound item was removed within the scope of said screen web page. This type of data is processed using the Data Binding 1600 system as shown in FIG. 16B (D).

Note that the main Page.html (1415) file never changes as, mentioned before, Appward's Client-side 1400 system is a single page application. So, switching between awPages (ScreenNormal types in this case) merely causes the content of one awPage Object instance to be removed from the browser HTML DOM and memory, and be replaced and rendered with a new awPage instead. When the user is switching to another web page (ScreenNornal 2901UI), we utilize the Remove (2901UI_R) destructor method to dispose of all the associated data, objects and events, regarding the current awPage that exists in Web Client 1200 memory, so the new awPage could be rendered. This process repeats every time a user is navigating through ScreenNormal 2901UI type screens. As for ScreenPopup 2902UI types because they are independent and self-contained, closing (which calls its 2902UI_R destructor method) the popup goes through the same internal memory cleanup process and removes all HTML tags (visuals) from screen display within the Client 1400 system and the Server 100 side (if they were temporary “Orphan” Object 3000 instance copies, “Original” 3000 instances are not affected by this at the Server 100).

Now that the foundational components of awPages and awUI icons have been established, it is important to note how the various awPages and awUI icons can be designed by Web Clients 1200 to develop feature rich, clean, and intuitive applications. The Screen Editor 5200 user interface is a powerful tool that can be used by Web Clients 1200 on ScreenNormal and ScreenPopup awPage instances to design the look and functionality of said screens and their respective children awUI icons. The Screen Editor 5200 interface generates an Orphan copy of the respective ScreenNormal or ScreenPopup Object 3000 instance for safe and non-intrusive configuration that does not affecting the original ScreenNormal or ScreenPopup Object 3000 instance. This provides an user interface for direct control and manipulation of every awUI object within the selected ScreenNormal or ScreenPopup awPage, which the Web Client 1200 can then choose to save their design changes back to the Original after they are done. The Screen Editor 5200 interface is displayed when entering design mode within said awPages (i.e., from the Screen Context Menu 6000 described in subsequent sections). This allows for rapid, on-the-fly screen and functionality configurations by Web Clients 1200. The Screen Editor comprises of some of the system files (FIG. 12B #6 “ScreenDesignerClass.js” and #10 “ScreenEditor.js”), similar to Object Editor that every Web Client 1200 gets served and has loaded within their browser, in order to utilize the Screen Editor 5200 interface.

In FIG. 17A, the Screen Editor 5200 is illustrated along with all its components that make designing screens a possibility. These components are comprising: 1) A menu 5220 toolset comprising of a) Add/Paste (adds an Object 3000 instance of the Class 2000 instance chosen in the Class Selection 5210 dropdown. If Copy is selected in the menu, then it will paste the copied Object 3000 instance tagged in client memory instead of adding. Add will utilize the “AddObjectByClass” RPC (b2 from FIG. 11C) while Copy will utilize the “CopyObjects” RPC (b8 from FIG. 11C) to add the Object 3000 instance to Server 100 and the associated awUI instance to Client system 1400 memory. b) Child menu option for Adding or Pasting, the Object 3000 instance in memory as a Child of the currently selected Object 3000 instance, shown within the tree 5240 area, c) Delete menu option deletes the currently selected Object 3000 instance along with all its Children, except if it is the ScreenNormal or ScreenPopup that is selected, deletions of the main ScreenNormal or ScreenPopup are not allowed in design mode. This will utilize the “DeleteObjects” RPC (b11 from FIG. 11C), which will remove the selected Objects from Server 100 and their associated awUI instances from Client system 1400 memory (not affecting the database 500 since as said these are Orphan copies). d) A subsequent menu 5220b that allows for manual or autosaving of changes Clients 1200 make in design mode; 2) A Class Selection 5210 dropdown menu which allows selecting a Class 2000 instance to add a new respective Object 3000 instance from at the selected node position within the tree 5240; 3) A Tree Hierarchy 5240 view that displays the Parent to Child relationships in a tree format for the given screen Object 3000 instance that is in design mode, along with all its children Object 3000 instances. This allows the Web Client 1200 to select via their mouse an awUI instance icon within their ScreenNormal or ScreenPopup and immediately see the actual tree hierarchy position of the associated Object 3000 instance. This promotes a quick and efficient way of locating where an icon is within the grander tree hierarchy, more on this discussed in FIG. 17B; 4) A tabular view 5230, showing the details on the Object Property 3100 instances contained within the selected Object 3000 instance that is selected within the Tree hierarchy 5240. The associated Object Properties 3100 are displayed with their Values 3104, which allows for rapid editing of every Object Property 3100 for the selected object instance, with the changes immediately getting reflect on the Object's associated awUI instance within the ScreenNormal or ScreenPopup awPage. All the fields within this table 5230 are the same as in the Object Editor's 3200 Table View 3230 (Refer to Object Editor section for more details on the various fields); 5) An awUI instance addition area 5250. When Web Clients 1200 select an awUI instance from this 5250 selection area, an associated Object 3000 instance based on the Class 2000 instance of what was selected will be created and added in Server 100 memory, along with its corresponding awUI rendered within Client system 1400 memory. The Web Client 1200 will then see the awUI icon at their mouse position and be able to drag it over and place it within the screen for further configuration. This makes adding, sizing, and positioning of awUI icons and in turn their associated Object 3000 instance quick and effortless, which is another aspect that promotes rapid, on-the-fly application development; 6) Class name area 5201, which shows the Class 2000 instance name of the selected Object 3000 instance within the tree 5240; 7) Path 5202 from of the selected Object 3000 instance within tree 5240 that displays the absolute Path 4001 of the selected Object 3000 instance starting from the immediate sandbox scope; 8) Object Key view 5203 that displays the Object instance key 3002 value that identifies the selected Object instance within the tree 5240 area. Note that the key 3002 value is over a billion, as said earlier within the context of Objects 3000, this indicates that the Object 3000 instance is an Orphan; 9) Help 3205 area displays help text on the selected Object 3000 instance or their respective Object Property 3100 instance. The content for this Help area is similar to Object Editor help area 3205, which is coming from the respective Class Property 2030 instance “Help” 2041 field.

FIG. 17B demonstrates how a ScreenNormal or a ScreenPopup awPage looks when a Web Client 1200 enters design mode, triggering the Screen Editor 5200 interface. FIG. 17B illustrates the associated ScreenPopup Object 3000 instance “popMain” within the contacts application from FIG. 3H, this time in design mode. This means that the illustrated “popMain” 5910 Object 3000 instance in FIG. 17B is an Orphan copy of the original “popMain” 3910 Object 3000 instance from FIG. 3H. FIG. 17B shows that Client 1200 has selected in this case the awUI instance within the ScreenPopup that is associated with the “tblContacts” 5936 Object 3000 instance. The selection is illustrated by the dotted borders that appear around the selected “tblContacts” awUI, this is true for all awUI selections in design mode to indicate which awUI instance is actively selected by Web Client 1200. This selection in turn causes the design interface to select and highlight the associated “tblContacts” 5936 Object 3000 instance within the Screen Editor 5200 Tree Hierarchy 5240. Whenever an awUI icon instance is selected by the Web Clients 1200 from within their screen, the corresponding Object 3000 instance gets selected within the Screen Editor 5200 displays (Tree hierarchy 5240 to show the Object 3000 instance and Properties Table 5230 to show the associated Object Properties 3100), this makes the rendered awUI instances be fully in sync with the Object 3000 data from Server 100 that they represent. Also, as illustrated by key 3002 field, the selected Object 3000 instance key 3002 is over a billion, hence indicating the selected Object 3000 instance is not an Original Object. This indicates to the Web Client 1200 that they are designing on a copy and not the original screen, to prevent any unwarranted changes, until they decide to save their design changes. Subsequently, note that the Web Client's 1200 mouse pointer From FIG. 17B (1) is changed to indicate a “move” action as it is hovered over the ScreenTable awUI instance. This allows for Web Clients 1200 to directly move the awUI icon within their screen and position it as necessary. This would in turn alter the related Object Properties 3100 of the Orphan copy, in this case, changing the “Left” 5936p2 and “Top” 5936p3 properties (through calling “ChangeObjectPropValue” RPC (b5 from FIG. 11C)) that track the position of “tblContacts” 5936 instance within its parent Screen Object 3000 instance. Similarly, the Web Client 1200 can resize the awUI icon by dragging the edges of the “tblContacts” awUI. In this case, the table would alter the “Width” and “Height” Object Property 3100 instance Values of the associated “tblContact” Object 3000 instance. The reverse also holds true, Clients 1200 can directly manipulate values from the Screen Editor 5200 Properties Table 5230, and see the associated changes get reflected within the respective awUI instances within their Screen. Note also the grid (from FIG. 17B (2)) is formed when the ScreenEditor 5200 interface is activated. This is to allow for easy positioning and alignment of icons with one another, allowing end users or developers to build clean, neat, and intuitive applications. Other functionality that the ScreenEditor 5200 interface provides is: direct copies or deletions from the awUI icon itself through a right click context menu or other hot keys (“Delete” for deletions, etc.), selection of multiple awUI icons at the same time with the ability to resize, move, copy, or delete the selected group of awUI icons, the ability to save and load awUI icons, and the ability for Web Clients 1200 to open and edit any sort of scripts that is within their ScreenNormal or ScreenPopup awPage directly in design mode and have them save back to the Original instance after they exit design mode. All the functionality described for the Screen Editor 5200 interface ultimately promotes rapid and smooth configuration of awUI instances, optimizing the time it takes for Web Clients 1200 to get from a blank screen to having developed a fully functional application. End SD VG]

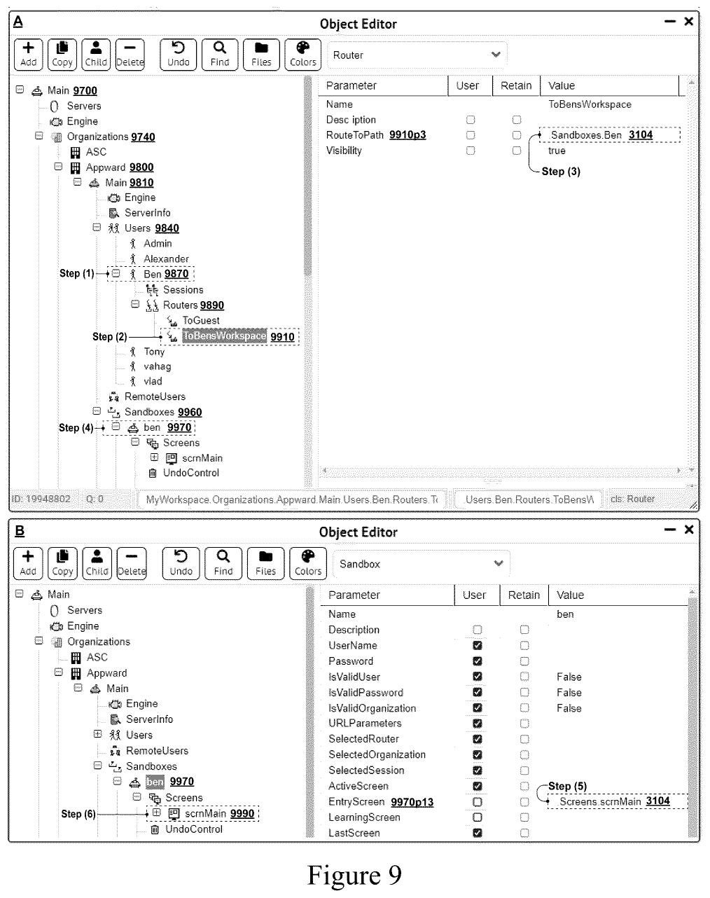

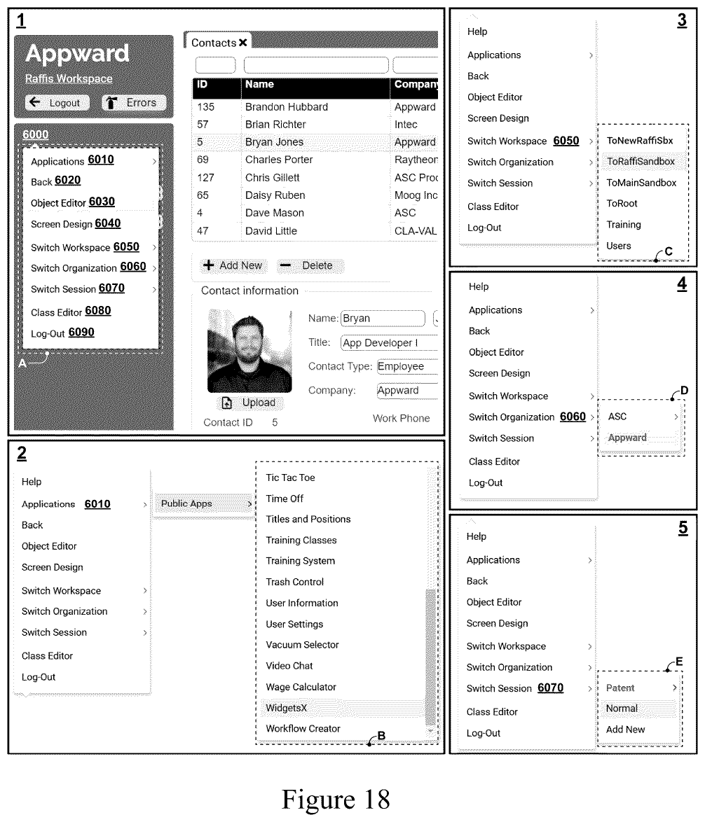

An independent part of the architecture within a given ScreenNormal or ScreenPopup awPage is its context menu 6000 (from FIG. 18 diagram 1A) that is shown when a Web Client 1200 is right clicking within the ScreenNormal or ScreenPopup awPage instances. This context menu 6000 provides some of the most commonly used menu items for fast and easy access for the Client 1200. This empowers Clients 1200 to quickly navigate between different web pages, workspaces, and applications, bring up editors, and perform other common tasks all with only a few clicks. FIG. 18 diagram 1A demonstrates context menu 6000, with the utilities of the available menu items described, comprising: 1) “Applications” menu item 6010 provides a list of the Object 3000 instances of Class 2000 instance “Application” that the specific logged in Client 1200 has been given access to. This menu item provides easy entry into any permitted application. Essentially this is a custom list of applications that the Web Client 1200 has access to, as illustrated in FIG. 18 diagram 2B; 2) “Back” menu item 6020 will take the Web Client 1200 back to the previous ScreenNormal awPage they were viewing before switching to their current ScreenNormal awPage. This makes backtracking between web pages fast and easy, promoting quick navigation. This menu-item is linked to the associated ScreenNormal Object 3000 instance's “Back” Object Property 3100 “method”, which will execute when this menu item is selected; 3) “Object Editor” menu item 6030 will trigger the Object Editor 3200 interface to open if it is not opened, or close if it was already opened. Refer to Object Editor 3200 discussion for more details on Object Editor; 4) “Screen Design” menu item 6040 will trigger the Screen Editor 5200 interface to open if it is not already open, create an Orphan copy of the associated ScreenNormal or ScreenPopup awPage and place it in design mode for that Web Client 1200. If the Screen Editor 5200 interface was open already, then it will trigger it to close, upon which the Web Client 1200 would be asked to either save or discard their design changes. Refer to Screen Editor 5200 discussion for more details on the Screen Editor interface; 5) “Switch Workspace” menu item 6050 shows a list of Sandbox environments available to the logged in Web Client 1200, as illustrated by FIG. 18 diagram 3C. After selecting an item in this menu, the user would be routed to that selected workspace (Refer back to FIG. 9 and its associated discussions for more information on routing to workspace environments); 6) “Switch Organization” menu item 6060 shows a list of the different organization for the logged in Web Client 1200, as illustrated by FIG. 18 diagram 4D. Certain admin users may be granted access to multiple Organizations; hence they would have the ability to switch between them through this menu item (Refer back to FIG. 9 and its associated discussions for more information on organizations); 7) “Switch Session” menu item 6070 shows a list of the different sessions for the logged in user, as illustrated by FIG. 18 diagram 5E. If a session is selected, then the Object Property 3100 IsClientOnly 3106 Values for that selected session would be loaded from Database 500 and reflected for Web Client 1200 (For more information on IsClientOnly 3106 values, refer back to the discussions of Object Property 3100); 8) “Class Editor” menu item 6080 will trigger the Class Editor 2200 interface to open if it is not opened, or close if it was already opened (Refer to Class Editor 2200 discussions for more information on Class Editor); 9) “Log-Out” 6090 menu item will log-out the currently logged in user and route the Web Client 1200 back to their organization's associated login Screen Normal awPage. Ultimately, the context menu 6000 brings in various components of the platform under one convenient menu, providing various powerful features of the platform for quick access and utilization by Web Clients 1200.

### Appward's Database Storage and Retrieval Mechanism

The core purpose of the Database 500 system is that it serves as the data storage and retrieval mechanism for any data, definitions, and configurations comprising of the four base classes: Classes 2000 instances, Class Properties 2030 instances, Objects 3000 instances, and Object Properties 3100 instances within Server 100. This system level Database 500 is modeled after these base class structures in Server 100 in order to mirror their respective properties and relationships that exist within Server 100 onto Database 500. This is essential for both effectively storing any changes made on these instances within Server 100 onto Database 500 and retrieving the most up to date data on these instances from Database 500 onto Server 100 for continuous data persistency. The changes on the instances of 2000, 2030, 3000, 3100 in Server 100 comprise of any of the following interactions: Class 2000 and Class Property 2030 instance additions, deletions, movements, or changes to any of the following Class 2000 instance 2001-2009 fields or Class Property instance 2030 fields 2031-2051. Original Object 3000 instance additions, deletions, or movements and Original Object Property 3100 instance Value 3104 changes, etc. Any of these changes made in Server 100 system will have its exact corresponding action taken within Database 500 System through the use of Stored Procedures 940 (discussed in subsequent sections) and storing these changes onto the associated tables within Database 500 (discussed in subsequent sections). This makes the systems fully in sync together at all times, allowing for the persistency of data over time and efficient communication. There are several definitions embodied in this mechanism that allow for communication, storage, and retrieval between Server 100 and Database 500 discussed below.

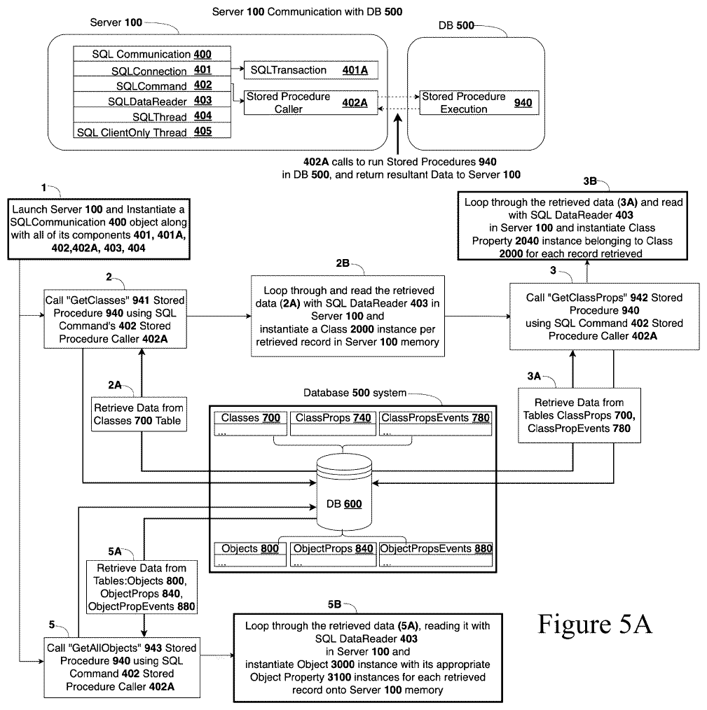

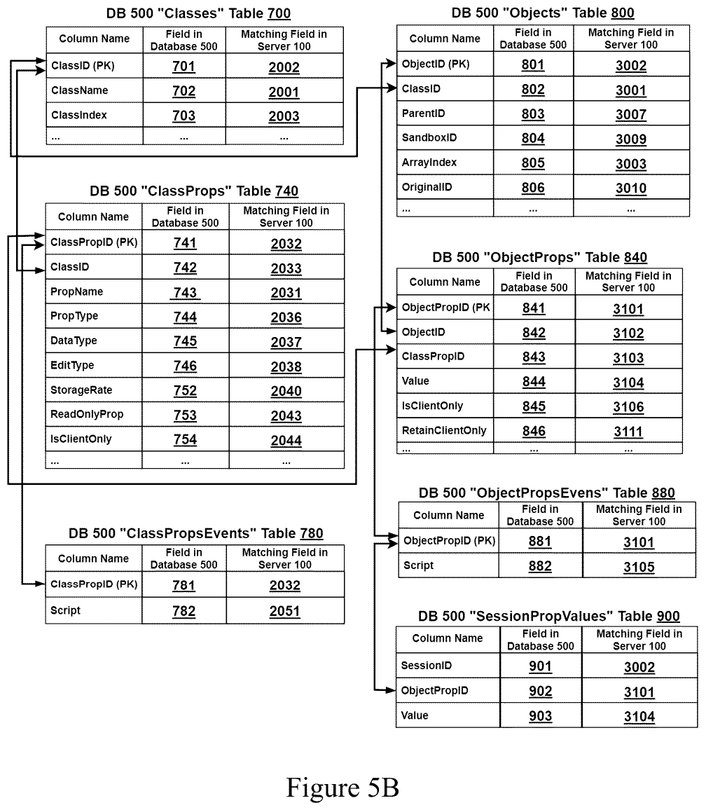

Appward uses a robust connection between Server 100 and Database 500 to read and write data in real time. Internally, Server 100 uses a SQL Communication Interface 400 (See FIG. 5A for the details and role of SQL Communication 400 and its components) which opens a unique connection between the two (Server 100 and Database 500) for continuous reading and writing of data based on demand. As said before, the SQL Communication 400 is crucial to be established first in the launch process of Server 100, since without it, Server 100 would not be able to function as none of the Classes 2000 instances, Class Properties 2030 instances, Objects 3000 instances, and Object Properties 3100 instances could be requested and loaded onto Server 100 memory for use by Web Clients 1200. Furthermore, this SQL Communication 400 offers several useful components and functions that Server 100 utilizes to read/write from and to Database 500. Said components are comprising of #1) SQL Connection 401, #2) SQL Command 402, #3) SQL DataReader 403, #4) SQL Thread 404, and #5) SQL ClientOnly Thread 405 with their roles detailed below:

#1) SQL Communication 400 uses a built in SQL Connection 401 .NET library class within Server 100 which establishes the initial connection between Server 100 and Database 500. After a successful connection is made, it stays persistent throughout the lifetime of Server 100 to allow continuous, safe, asynchronous, multi-threaded reads and writes to and from Database 500. SQL Connection 401 also provides the advantage of SQL Transactions 401A, which offer safer data writing with the ability to rollback an action in case of errors, ultimately preventing corruption of data and preserving database integrity in Database 500 to be in sync with data in Server 100.

#2) SQL Command 402 is another .NET library class that is used within Server 100 and it provides the functionality of utilizing Stored Procedure Calls 402A, which is the process of calling Stored Procedures 940 that reside in Database 500 from within Server 100. Stored Procedures 940 are custom functions within Database 500 that serve to perform operations comprising of: reading, updating, inserting, and removing on the respective database tables in Database 500 Tables (discussed in subsequent sections).

#3) SQL DataReader 403 is used for reading of retrieved data from Database 500 within Server 100. SQL DataReader 403 is used within Server 100 after a Stored Procedure 940 has executed in Database 500 to read and process any resultant data returned from that execution.

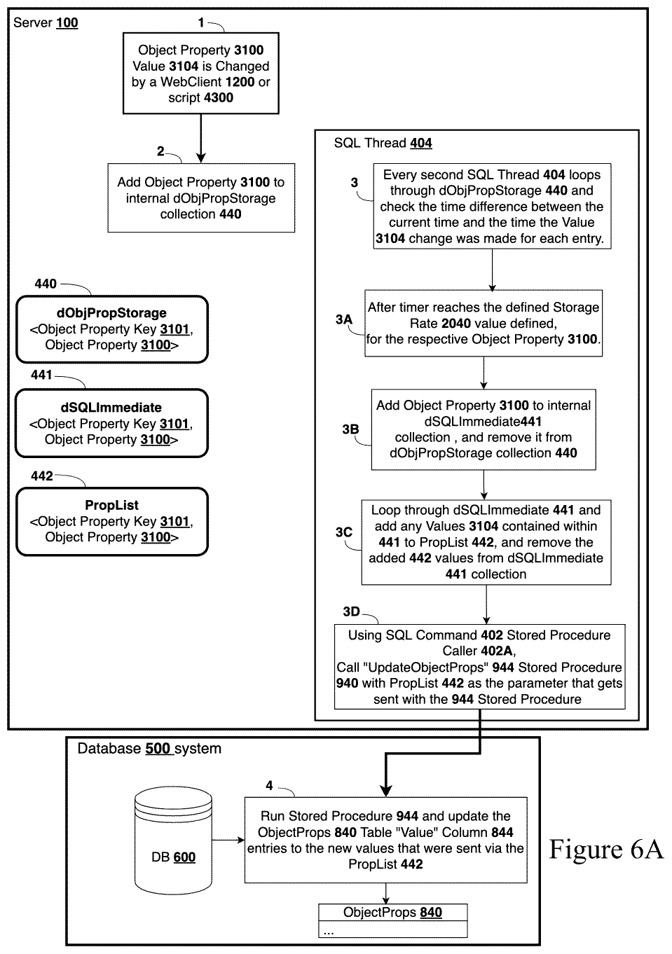

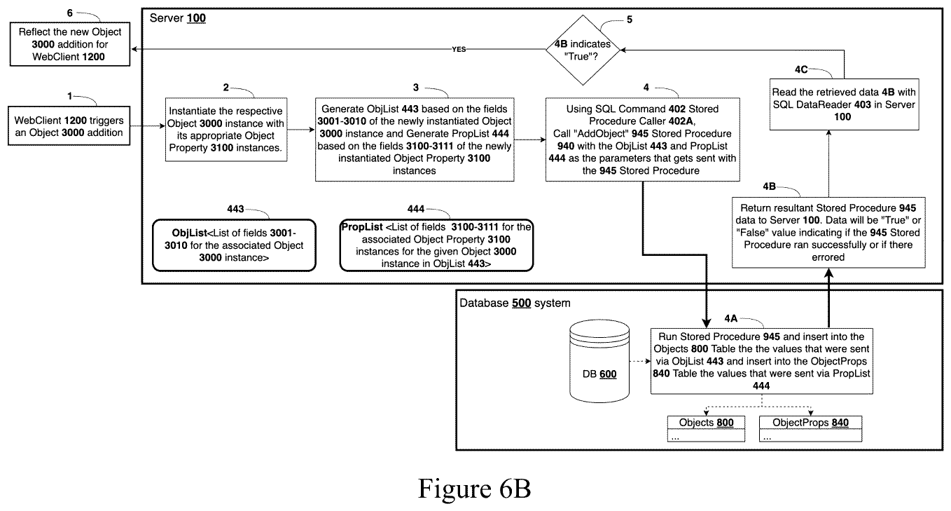

#4) SQL Thread 404 is a custom thread designed for exclusively writing Object Property 3100 instance Value 3104 changes (only used for Values 3104 that are not marked as “True” for IsClientOnly 3106 field) from Server 100 to Database 500 in a smart and continuous methodology. The role and benefits of this will be discussed in subsequent sections (See FIG. 6A for more details).

#5) Similarly to 404, SQL ClientOnly Thread 405 is a custom thread designed for exclusively writing Object Property 3100 instance Value 3104 changes that are marked as “True” for IsClientOnly 3106 field and for RetainClientOnly 3111 field, from Server 100 to Database 500 in a smart and continuous methodology. The role and benefits of this will be discussed in subsequent sections.

Before diving into the processes and details of how these components are utilized, it is fundamental to first understand the table structures within Database 500, their relationships, and how they reflect as closely as possible the data for Classes 2000 instances, Class Properties 2030 instances, Objects 3000 instances, and Object Properties 3100 instances in Server 100 memory.

FIG. 5B demonstrates #1) The foundational tables: Classes 700 Table, ClassProps 740 Table, ClassPropEvents 780 Table, Objects 500 Table, ObjectProps 840 Table, ObjectPropEvents 880 Table, and SessionPropValues 900 Table, which are necessary for the preservation of any Class 2000, Class Property 2030, Object 3000, and Object Property 3100 instance data. #2) The structure of said tables and how they closely match the associated structures within Server 100 to keep the two systems (Server 100 and Database 500) be fully in sync

From FIG. 5B, the Classes 700 Table holds all necessary data to define each definition of Class 2000 in Server 100. Each record or Classes 700 Table row, represents a single Class 2000 definition that's keyed with a Primary Key (PK) in order to not allow duplicates and promote uniqueness. The design pattern for this table reflects as closely as possible the fundamental fields (between 2000-2009) in Class 2000 in order to be able to efficiently and intuitively process, store, and retrieve respective data changes pertaining to any Class 2000 instance.

The ClassProps 740 Table holds all necessary data to define each Class Property 2030 in server 100. Each record (ClassProps 740 Table row) represents a single Class Property 2030 which is also keyed with a Primary Key (PK). The design pattern for this table is associated as closely as possible the fundamental fields (2031-2051) in Class Property 2030. The ClassProps 740 Table has a relationship with the Classes 700 Table via their respective shared ClassID 701 and 742 columns. This allows for the data in the tables to tie in together with their PKs and it is used when Class 2000 instances are instantiated during Server 100 launch, to retrieve the associated ClassProps 740 Table records based on the ClassID 742 field and instantiate every associated ClassProperty 2030 instance in Server 100 for the given Class 2000 instance. This structure allows for Server 100 to retrieve and form a fully functional Class 2000 instance with its own Class Property 2030 instances and business logic ready for use.

The ClassPropEvents 780 Table shares the same ClassPropID 781 as the ClassPropID 741 in the ClassProps 740 Table. This ensures that each record in ClassPropEvents 780 Table is linked to a ClassProp record within ClassProps 740 Table. ClassPropEvents 782 Table field holds the data that is retrieved onto ClassProp 2030 instance's “OnChange” 2051 field, See FIG. 5B. As said before and demonstrated by FIG. 2F, the “OnChange” 2051 field is used within Server 100 to allow for custom scripting and flexibility of a Class Property 2030 instance whenever an associated Object Property 3100 instance that is associated with that Class Property 2030 instance has its Value 3104 changed.

From FIG. 5B, the Objects related Tables 800, 840, 880 work in a similar fashion. The figure shows the Objects 800 Table, which holds all necessary data to define each definition of an Object 3000 instance in Server 100. Each record, Objects 800 Table row, represents a single Object 3000 definition that's keyed with a Primary Key (PK) in order to not allow duplicates and promote uniqueness. The design pattern for this table reflects the fields (between 3001-3010) in Object 3000 in order to be able to efficiently process, store, and retrieve respective data changes pertaining to any Object 3000 instance. The Objects 800 Table has relationships that are crucial to the fundamental structure and behavior of Object 3000 instances within Server 100. For example, the Objects 800 Table has a relationship with the Classes 700 Table via their shared ClassID 701 and 802 columns values. This is crucial as this is how the link between an Object 3000 instance and the associated Class 2000 instance the Object 3000 stems from is stored. For example, as it was explained in a previous section when discussing the Object 3000 data model, every Object 3000 instance references only one Class 2000 instance in Server 100, hence each record in Objects 800 Table links to one and only one ClassID 701 in Database 500 to match this reality in Server 100. Also, as said before, all Object 3000 instances are hierarchical in nature residing within a tree-like hierarchy, the Objects 800 Table ParentID 803 column is how this hierarchical nature is stored and retrieved. This column is crucial for Server 100 to form the correct hierarchy of Object 3000 instances, generate the correct child Object 3000 instances under the correct parent Object 3000 instances, and in turn form Object 3000 instance Paths 4000 that are heavily used in data binding within workspaces and applications. The SandboxID 804 column is crucial as well since, as said before, Object 3000 instances in Server 100 are contained within a Sandbox defining the scope and access level of its children. Hence, storing SandboxID 804 in Database 500 is essential in ensuring an Object 3000 cannot reach outside of its Sandbox scope. As said prior, Object 3000 instance of Class 2000 Sandbox have the capability of being shared or linked them at other locations within the Server 100 Object tree structure. The OriginalID 806 column value that gets stored in Database 500 is how the Server 100 differentiates between a regular Object 3000 instance and linked Object 3000 instance, whenever it is instantiating an Object 3000 instance. This is also essential in order to have applications be sharable. The “ArrayIndex” 805 is essential for defining the relative position of the Object 3000 instance in Server 100 within its 3000 Parent relative to its 3000 siblings.

Subsequently, the ObjectProps 840 Table holds all necessary data to define each Object Property 3100 in Server 100. Each record ObjectProps 840 Table row represents a single Object Property 3100 instance which is also keyed with a PrimaryKey (PK). The design pattern for this table mirrors as closely as possible the fields (between 3101-3111) in Object Property 3100. The ObjectProps 840 Table has a relationship with the Objects 700 Table via their respective shared ObjectID 842 and 801. Each Object Property 3100 instance must belong to an Object 3000 instance within Server 100 in order to have functioning business logic. And storing this link within Database 500 ensures that all Object Property 3100 instances will get matched with their appropriate Object 3000 instances whenever they get instantiated in Server 100. The ObjectProps 840 Table ClassPropID 843 column must also match with a ClassProps 740 Table ClassPropID 741 column since, like the relationship between Object 3000 instances referencing only one Class 2000 instance, Object Property 3100 instances can only be linked to one Class Property 2030 instance.

The ObjectPropEvents 880 Table references the same ObjectPropID 881 as the ObjectPropID 841 in the ObjectProps 840 Table. This ensures that each record in ObjectPropEvents 880 Table is linked to a record within ObjectProps 840 Table. ObjectPropEvents 880 Table field 882 holds the data for the ObjectProp 3100 instance's “OnChange” 3105 field. As mentioned previously, the ObjectProp 3100 “OnChange” 3105 field is used within Server 100 to allow for custom scripting and flexibility of an ObjectProperty 3100 instance that has its Value 3104 changed.

The SessionPropValues 900 Table of Database 500 is similar to the ObjectProps 840 Table in that they both store the data for Object Property 3100 instance Values 3104. As said earlier, the IsClientOnly 3106 field of each Object Property 3100 instance allows for unique custom values to be utilized per each connected Web Client 1200. This means that if an Object Property 3100 instance is marked as IsClientOnly 3106 equals “True”, then the Value 3104 field for that Object Property 3100 will be different for each distinct Session 1106 that a Client 1200 is logged in with. If IsClientOnly 3106 is marked as “False”, then all connected Clients 1200 will see and use the same Value 3104 for that given Object Property 3100 instance. This IsClientOnly 3106 field provides efficient and scalable customization features for each Object Property 3100 instance Value 3104 within Server 100. This makes it possible for different Clients 1200 to utilize the same Object Property 3104 instances, yet see and interact with different Values 3104 that are specific for each connected Client 1200. As said before, the data for these custom Values 3104 fields are held within “ClientValues” 3107 dictionary that is within each Object Property 3100 instance in Server 100 memory. In order to store these unique values, Server 100 utilizes the SessionPropValues 900 Table of Database 500 for reading and writing of these custom Values 3104. The Value 903 Column holds the custom values from “ClientValues” 3107 based on each different Session 1106 Object 3000 instance they pair with. As said, the Session 1106 Object 3000 instance is a special type of Object 3000 instance that is tagged along each Client Connection 1100. Both Server 100 and Database 500 use this Session 1106 Object 3000 instance Key 3002 in order to store these custom client values to Database 500. Within Database 500 SessionPropValues 900 Table, this is represented by the SessionID 901 column which determines what Session 1106 Object 3000 instance Key 3101 the given Value 903 is meant for. It is noteworthy to mention that while the ClientValues 3107 collection within the Server 100 is keyed by Client Connection Key 1107, however within Database 500 SessionPropValues 900 table, those associated Values from ClientValues 3107 are stored by SessionID 901, not Client Connection Key 1107. This is because Client Connection Keys 1107 are not Original Object 3000 instances by design, hence they never get stored in Database 500.

The ObjectPropID 902 within the SessionPropValues 900 Table references the same ObjectPropID 841 in the ObjectProps 840 Table, that is also the matching Key 3101 field of the Object Property 3100 instance. This relationship provides an efficient way of linking multiple Session specific ObjectPropID 902 records to one single record within the ObjectProps 840 table, without needing to repeat any of the other columns from ObjectProps 840 Table in the SessionPropValues 900 Table. On the Server 100 side, this translates onto an Object Property 3100 instance that has IsClientOnly 3106 field as “True”, having multiple different values (“ClientValues” 3107) for the different Clients 1200 that are using it. This is fundamental for enabling a rich customization experience for Clients 1200. As seen in FIG. 5B, the SessionPropValues 900 Table does not have a Primary Key PK, meaning that either the SessionID 901 column or the ObjectPropID 902 column can repeat, however both cannot repeat. This makes sense since the same Session 1106 can have many Object Property 3100 Values 3104 associated with it, and the same Object Property 3100 instance can be associated with multiple Sessions 1106. Again, this gives Clients 1200 the ability to customize their Object Property 3100 Values 3104 and store them, without affecting how another Client 1200 is seeing and utilizing those Object Properties 3100. This provides for powerful customization and configuration, allowing users to read and write custom data that is unique to them for the same Object Property 3100 instance.

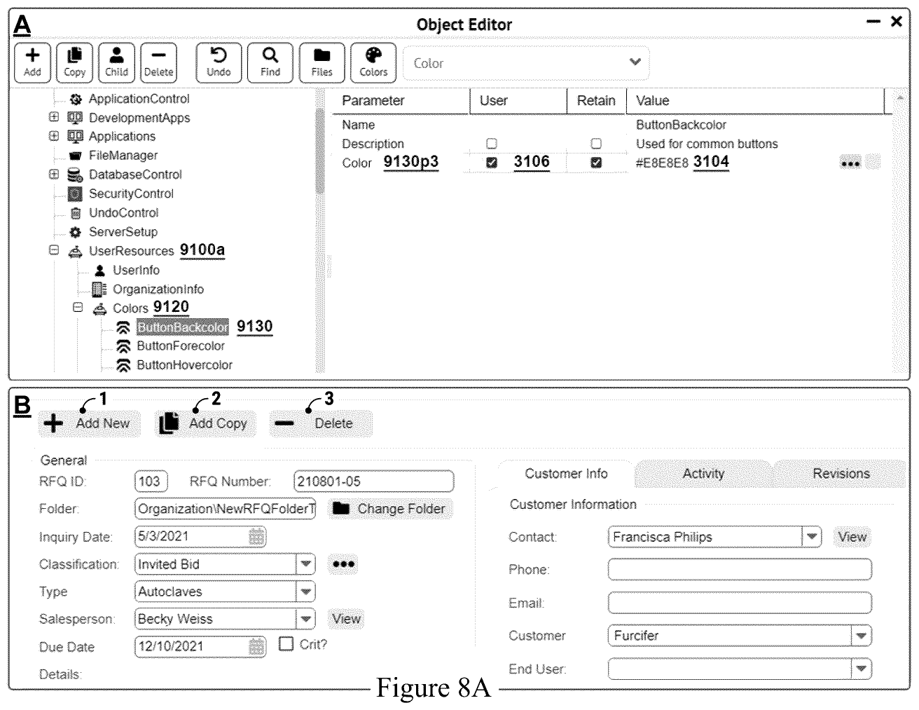

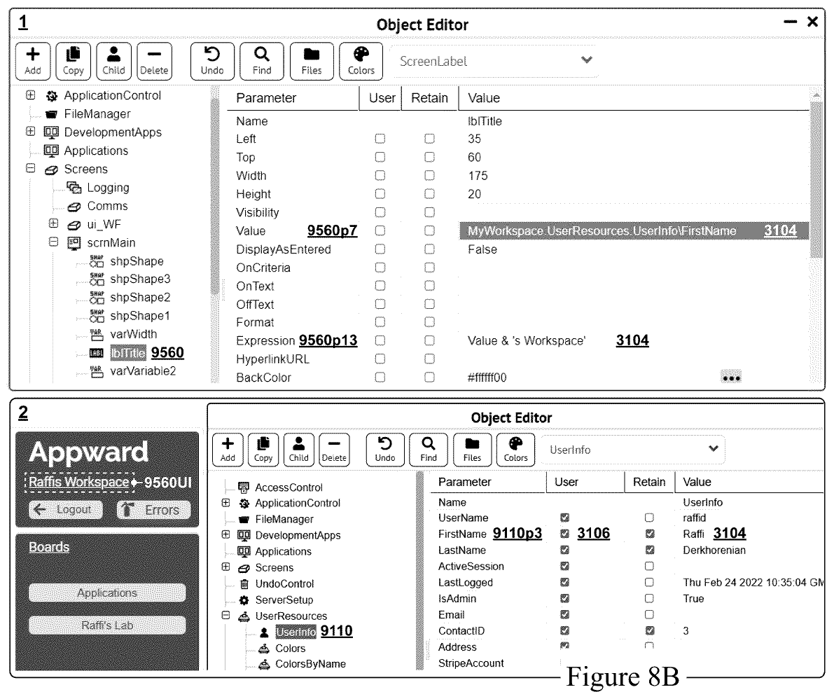

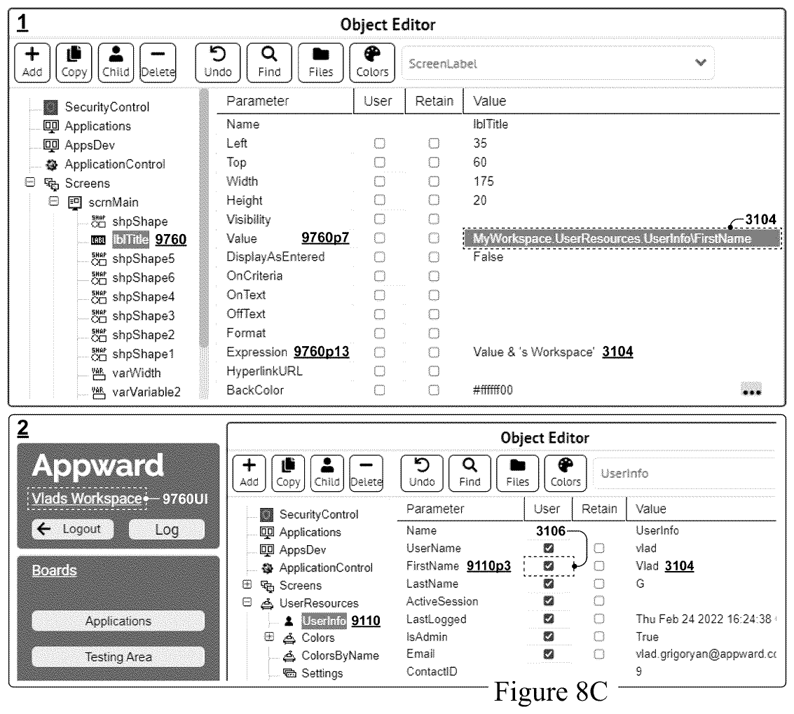

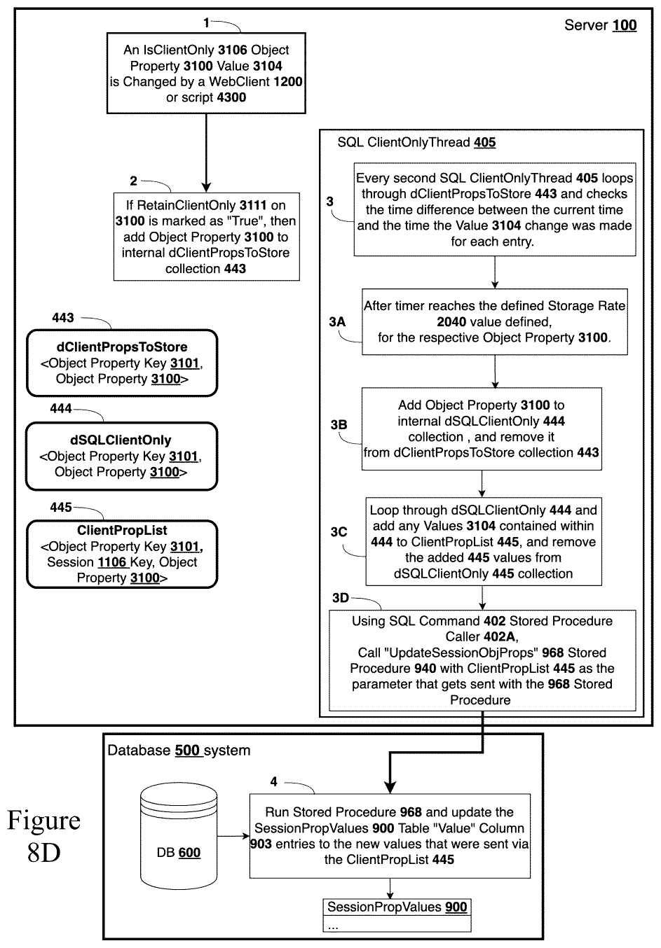

Various use cases and results for this customization can be seen in FIGS. 8A, 8B, and 8C. In FIG. 8A diagram A, the Object Editor 3200 is depicted with one of the Color Object 3000 instances “ButtonBackColor” 9130. Note that this Object 3100 instance 9130 is a child of the UserResources 9100a Object instance. As said before the UserResources 9100a Object instance is linked from the original UserResources 9100 Object and shared throughout multiple Clients 1200 and applications. This means that any change done within the UserResources 9100a Object instance and on any of its Object Property 3100 instances and Children objects will affect all Client 1200s utilizing 9100a, or other links of it. However, the figure shows that the associated Color Object Property 3100 instance 9130p3 is marked as IsClientOnly 3106, meaning that any change in this 9130p3 Value 3104 will only affect the associated Client 1200 that is making the change and store it to their associated SessionID 901 in the SessionPropValues 900 Table, without affecting the Value 3104 that other Clients 1200 see. This way, the specific Client 1200 can customize this 9130p3 Value 3104 to match any other color value of their choice and see the changes reflected within any data bound (by Paths 4000) Object 3000 instance that is using this 9130p3 Value 3104 (in this case Object 3000 instances 1, 2, 3 from FIG. 8A diagram B). In diagram B, the “BackColor” Object Property 3100 Value 3104 in the case of these Object 3000 instances 1, 2, 3 is data bound to the ButtonBackColor 9130 Color 9130p3 Object Property Value 3104, hence their background colors reflect the Value 3104 defined in 9130p3. Similarly, this customization technique can be used across all other Object Property 3000 instances to provide granular and scalable customization for Clients 1200. With this functionality at hand, Clients 1200 can fully customize the look and feel of their applications, catering it to their preferences without affecting how other Client 1200s see and utilize those same applications.

FIGS. 8B and 8C demonstrate a similar example, showing that not only styling customization is possible through IsClientOnly 3106 Values 3104, but also data customization. In FIG. 8B diagram 1, an Object 3000 instance of Class 2000 instance of “ScreenLabel” is illustrated as 9560, along with its Object Property 3100 instances. The Source 4400 “Value” 9560p7 is utilizing a Path 4000 to point to a target 4500 Object Property 3100 instance, in this case “FirstName” Object Property 3100 instance of the “UserInfo” Object 3000 instance 9110. In FIG. 8B diagram 2, that “UserInfo” 9110 Object 3000 instance is illustrated, and it displays the logged in Client 1200 information. The 9110p3 Object Property 3100 instance Value 3104 shows the “FirstName” of the logged in Client 1200, in this case “Raffi”. This illustrates that Client 1200 is utilizing a Path 4000 to point to a target 4500 Object Property 9110p3 Value 3104, which holds the “FirstName” of said logged in Client 1200, and the said target Object Property 9110p3 has its IsClientOnly 3106 set as “True”. Hence, the Client 1200, through the 9560 instance UI will see their own “FirstName” get reflected. (As a side note, the full text in the 9560 UI that is reflected, “Raffi's Workspace”, is formed with the use of an “Expression” 9560p13 Object Property 3100 in FIG. 8B diagram 1, which is used in this case to append certain text “'s Workspace” to the 9560p7 Value 3104 that was pulled from the 9110p3 Value 3104).

Subsequently, FIG. 8C illustrates a different Client 1200 that is using a similar setup to display their own client information. Similarly, in FIG. 8C diagram 1, an Object 3000 instance of Class 2000 instance of “ScreenLabel” is illustrated as 9760, with the Source 4400 “Value” 9760p7 utilizing a Path 4000 to point to the same “FirstName” Target 4500 Object Property 3100 instance of the “UserInfo” Object 3000 instance 9110 from FIG. 8B diagram 2. FIG. 8C diagram 2 illustrates that the same Object Property 3100 instance 9110p3 that was showing a Value 3104 of “Raffi”, is showing a different Value 3104 for another logged in Client 1200, in this case “Vlad”. Again, this ultimately allows Clients 1200 to customize data for themselves through the same Object Property 3100 instances and store those customizations to the SessionPropValues 900 table, leading to a custom and distinct experience for each Client 1200. This illustrates that not only Clients 1200 can customize direct 3104 Values, but they can also have Target 4500 end Values 2104 of Object Property 3100 instances that are targeted by Paths 4000, also be Client 1200 specific.

After establishing an understanding of the table structures in Database 500, the next section will detail how the SQL Communication 400 instance and its components can interact with the tables in Database 500 given the Server 100 launch example that was generally described earlier FIG. 1. Now, starting with FIG. 5A, the process will begin to detail the Server 100 launch, focusing more closely on the Database 500 interactions that includes the retrieval and processing of the table data from FIG. 5B.

From the starting point in FIG. 5A, the SQL Communication 400 instance is established first with all its components, as said before, this is necessary for establishing the initial connection to the Database 500 and being able to read and write data onwards. After successfully creating the SQL Communication 400 instance, step (2) will utilize the SQL Command 402 Stored Procedure caller 402A and call the following Stored Procedure 940 “GetClasses” 941, which is a custom function that resides within Database 500. This 941 Stored Procedure as indicated by its name, will retrieve all the data residing within the Classes 700 Table from Database 500 onto Server 100. This is indicated by Step (2A). Afterwards in (2B), within Server 100, SQL Communication 400 utilizes its SQL DataReader 403 to loop through and read the retrieved Data and instantiate a Class 2000 instance within Server 100 memory from every single record that was retrieved from Classes 700 Table. (3) As part of the instantiation process of a Class 2000 instance within Server 100, another call using 402A is used to run another Stored Procedure 940 “GetClassProps” 942. A parameter will also be sent with 942 matching the value of Class 2000 Instance Key 2002 field. (3A) This will now retrieve all the data from the ClassProps 740 Table that has a ClassID 701 matching the Class 2000 Key 2002 parameter that was sent, and it will also retrieve any records matching the ClassPropID 781 from the ClassPropEvents 780 Table. Next, (3B) Server 100 will loop through the retrieved data from (3A) reading it via SQL DataReader 403 and instantiate a Class Property 2040 instance with the data from (3A) associating it with the Class 2000 instance using the ClassProperty 2030 ParentKey 2033 field. After completing these loops, Server 100 will have generated all the necessary Class 2000 and ClassProp 2030 instances in memory.

Next Server 100 will load the Object 3000 and Object Property 3100 instances. Step (5) will again utilize the SQL Command 402 Stored Procedure caller 402A and call the following Stored Procedure 940 “GetAllObjects” 943 within Database 500. As indicated by Step (5A), this 943 Stored Procedure will return Data from Objects 800, ObjectProps 840, and ObjectPropEvents 880 tables from Database 500 with the one call onto Server 100. Afterwards in (5B), within Server 100, SQL Communication 400 instance utilizes its SQL DataReader 403 again to loop through and read the retrieved Data and instantiate an Object 3000 instance within Server 100 memory from every single record that was retrieved from Objects 800 Table. The instantiation process of the Object 3000 instance will also use the data that was retrieved from (5A Table 840 data) to immediately instantiate the associated Object Property 3100 instance with their appropriate “OnChange” 3105 scripts from (5A Table 880 data). After completing the (5B) loop and instantiating all Object 3000 instances, Server 100 will have completed generating all the Object 3000 and Object Property 3100 instances in memory. The Server 100 is now one step closer to becoming fully operational and having Web Clients 1200 connect and use the system.

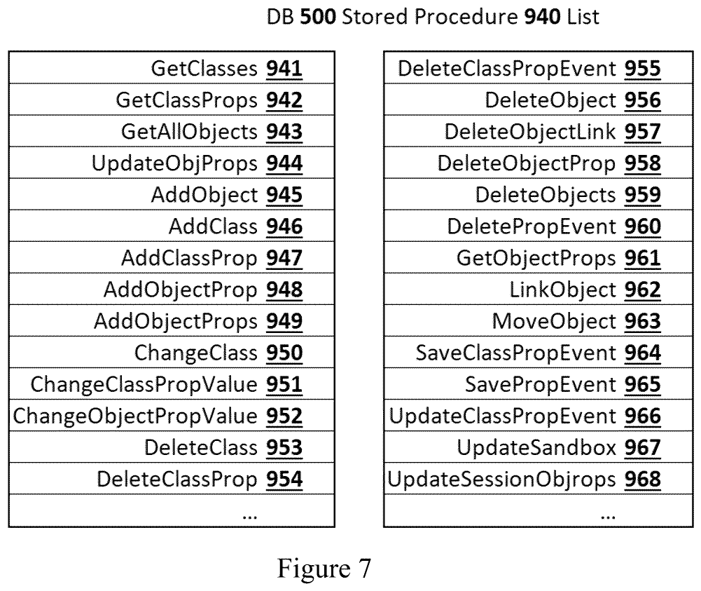

After Server 100 is fully launched and operational, Stored Procedures 940 continue to be vastly used within Server 100 system for performing a variety of operations within Database 500 system. Stored Procedures 940 are crucial for ensuring fully functional behavior on all fronts, preserving Database 500 integrity, and keeping the systems in sync (Server 100, Database 500, and connected Clients 1200) to promote real-time application development and usage. Take the case in FIG. 6B, which displays the process of one of the core events of adding a new Object 3000 instance by a Web Client 1200. As said before in FIG. 3H, the Web Client 1200 can use the Object Editor's 3200 toolset 3220 “Add” option to add a desired Original Object 3000 within their Object 3000 Tree hierarchy. Continuing from this, FIG. 6B details the processes that occur within Server 100 and Database 500 after this event is triggered. The request will first be sent to Server 100 (2) which will construct the associated Original Object 3000 instance along with all its respective Object Property 3100 instances onto Server 100 memory. At this point, Server 100 has the Object 3000 instance in memory, however the cycle is not complete until the associated Object 3000 and Object Property 3100 instance fields have their data written to their reflected tables within Database 500 (See FIG. 5B for the list of tables and their relationships). (3) To do this, Server 100 will generate two special lists: ObjList 443 which will contain the data from the fields (3001-3010) of the newly added Object 3000 instance, and PropList 444, which will contain the data for the (3100-3111) fields of the associated Object Property 3100 instances for those Object 3000 instances. (4) Afterwards, Server 100 will again use SQL Command 402 Stored Procedure Caller 402A in order to call the “AddObject” 945 Stored Procedure 940 with the ObjList 443 and PropList 444 that were generated as the parameters that get sent with this 945 Stored Procedure call. (4A) Database 500 will run the 945 Stored Procedure and execute the associated code defined within it. This will insert into the Objects 800 Table the values that were sent via ObjList 443 and insert into the ObjectProps 840 Table the values that were sent via PropList 444. (4B) The database will then return resultant Stored Procedure 945 data to Server 100 for post processing. (4C) The data that is returned will be read by SQL DataReader 403 and it will contain a “True” or “False” value indicating if the storage of the Object 3000 data via the 945 Stored Procedure call ran successfully or if it failed within Database 500. If it failed, the SQL Transaction 401A would allow for rolling back the changes in Database 500 to ensure data integrity and prevent any corruption. (5) If storage was successful, then data regarding the new Object 3000 instance will be (6) sent back to the Web Client 1200 to be reflected within their Object Editor 3200 Tree hierarchy, fully functional and ready for use. Similarly, this is how all other Stored Procedures 940 work (See FIG. 7 for a list of the most widely used Stored Procedures 940) to allow for complex code execution within Database 500 based on requests from Server 100. This again ensures consistency and continuous preservation of data, leading to smooth, on-the-fly configuration, development, and usability by Clients 1200.

Additionally, it is also worth mentioning the continuous way Object Property 3100 instance Value 3104 changes get stored to Database 500. The way this is done is different than the previous example in FIG. 6B since it uses a separate SQL Thread 404 to store the Value 3104 changes, rather than processing the storage directly via the Web Client 1200 thread that triggered it. The reason for this is that connected Clients 1200 and scripts 4300 alike will be generating a considerable amount of Value 3104 changes during their lifecycles. Storing all these changes one at a time to Database 500 would consume time and slow down Server 100 and overall smoothness of the systems. Since this is a high frequency task, a separate thread SQL Thread 404, that is not intertwined with any Client 1200 thread and is purely dedicated to this task, is utilized. This optimizes efficiency and provides custom traffic control when writing Object Property 3100 Value 3104 values to Database 500. This leads to a seamless experience with no hang-ups for Clients 1200. This process is demonstrated in FIG. 6A. (1) An Object Property 3100 Value 3104 is Changed by a Web Client 1200 or Script 4300. (2) For Server 100 to process the change, it first adds the respective Object Property 3100 instance onto an internal dObjPropStorage 440 collection. This 440 collection is used to track newly changed Object Property 3100 instance Values 3104 that have not yet been stored to Database 500 ObjectProps 840 table. Once the Object Property 3100 instance is added to the dObjPropStorage 440 collection, the Web Client 1200 thread no longer executes any subsequent actions regarding the storage of the Value 3104 change, the rest of the process is handled by the SQL Thread 404. (3) This SQL Thread 404 is running once every second within the lifetime of Server 100 and checking dObjPropStorage 440 for new entries that contain Object Property 3100 Value 3104 changes, in order to process them for storage if their respective Class Property 2030 Storage timers 2040 are reached. This will contain entries from the WebClient 1200 that just made the change, and all other entries from all other Clients 1200 and Scripts 4300 that are yet to be stored in Database 500. (3A) Since the Storage Rate 2040 defined by the Class Property 2030 instance for the Object Property 3100 is what controls the traffic of how fast the Object Property 3100 Value 3104 change gets stored to Database 500, the logic within SQL Thread 404 compares the difference between the current time that the SQL Thread 404 is running the check and the time that the Object Property 3100 was added to dObjPropStorage 440, if that time difference is greater than the Storage Rate 2040, then continue onto (3B). (3B) Will add the Object Property 3100 to another internal dSQLImmediate 441 collection to process storage immediately, and remove it from dObjPropStorage 440 collection. (3C) The values collected in dSQLImmediate 441 will be looped through and added to a PropList 442, while also being removed from dSQLImmediate 441 collection. The PropList 442 is in a format that the Database 500 can understand, and it consists of all the Object Property 3100 keys 3101 and their associated new Values 3104. The Object Property 3100 keys 3101 that get sent in PropList 442 will match the PK in ObjectProps Table 840, enabling the mechanism to perform an efficient, one-shot update of the records in ObjectProps Table 840, as demonstrated in the following steps. (3D) Using SQL Command 402 Stored Procedure Caller 402A, Server 100 will call “UpdateObjectProps” 944 Stored Procedure 940 with the generated PropList 442 as the parameter that gets sent along with the 944 Stored Procedure. (4) Now on the Database 500 side, the 944 Stored Procedure code will execute and update the ObjectProps 840 Table “Value” Column 844 entries to the new values that were sent via the PropList 442. This is essentially a bulk update of different records within the ObjectProps 840 Table that match the Object Property 3100 keys 3101 sent by PropList 442, meaning multiple Object Property 3100 instance Value 3104 changes are being stored at the same time. This promotes efficiency and a continuously seamless experience for Clients 1200. The SQL Thread 404 will then go back to (3) to continue the same process all over for the next batch of Object Property 3100 instance Value 3104 changes. Note that the SQL Thread 404 only stores Object Property 3100 Values 3104 that are not marked as IsClientOnly 3106 being “True”. For Object Properties 3100 with IsClientOnly 3106 as “True”, a similar thread, SQL ClientOnly Thread 405 is utilized to store the Object Property 3100 Values to the SessionPropValues 900 Table. FIG. 8D, demonstrates the SQL ClientOnly Thread 405 process.

In FIG. 8D, (1) An Object Property 3100 Value 3104 that is marked as IsClientOnly 3106 being “True is changed by a Web Client 1200 or Script 4300. (2) Server 100 will first check if that associated Object Property 3100 has the RetainClientOnly 3111 field marked as “True”, if so it will add the respective Object Property 3100 instance onto an internal dClientPropsToStore 443 collection, if RetainClientOnly 3111 is “False”, then that IsClientOnly 3106 Object Property 3100 value change will not be stored. The 443 collection is constantly used to track newly changed Object Property 3100 instance Values 3104 that have not yet been stored to Database 500 SessionPropValues 900 table. Once the Object Property 3100 instance is added to the dClientPropsToStore 443 collection, the Client 1200 thread no longer executes anything further, the rest is then handled by the SQL ClientOnly Thread 405. (3) This SQL ClientOnly Thread 405 is running every second within the lifetime of Server 100 and checking dClientPropsToStore 443 for new entries that contain Object Property 3100 Value 3104 changes, in order to process them for storage if their respective Class Property 2030 Storage timers 2040 are reached. This dClientPropsToStore 443 will contain updated IsClientOnly 3106 Values from the WebClient 1200 that just made the change, and any other entries from other Clients 1200 and Scripts 4300 that are yet to be stored in Database 500 SessionPropValues 900 Table. (3A) Similarly to the 404 thread, the logic within SQL ClientOnly Thread 405 checks if the difference between the current time that the SQL ClientOnly Thread 405 is running the check and the time that the Object Property 3100 was added to dClientPropsToStore 443 is greater than the Storage Rate 2040. If so (3B), add the Object Property 3100 to another internal dSQLClientOnly 444 collection to process storage, and remove it from the current dClientPropsToStore 443 collection. (3C) The values collected in dSQLClientOnly 444 will be looped through and added to a ClientPropList 445, while also being removed from dSQLClientOnly 444 collection. The ClientPropList 445 is in a form that the Database 500 can understand, and it consists of all the Object Property 3100 keys 3101 and their associated new Values 3104, along with the client Sessions 1106 (From FIG. 10B) they belong to. The Session 1106 keys that gets sent in ClientPropList 445 will match the 901 “SessionID” column within the SessionPropValues 900 table and the Object Property 3100 keys 3101 will match the 902 “ObjectPropID” column, enabling the mechanism to locate the appropriate records and perform an efficient, one-shot update of those records in SessionPropValues 900 Table, as demonstrated in the following steps. (3D) Using SQL Command 402 Stored Procedure Caller 402A, Server 100 will call “UpdateSessionObjProps” 968 Stored Procedure 940 with the generated ClientPropList 445 as the parameter that gets sent along with the 968 Stored Procedure. (4) Now on the Database 500 side, the 968 Stored Procedure code will execute and update the SessionPropValues 900 Table “Value” Column 903 entries to the new values that were sent via the ClientPropList 445. This is essentially a bulk update of different records within the SessionPropValues 900 Table that stores IsClientOnly 3106 Value changes from multiple Object Properties 3100 belonging to multiple clients at the same time. This promotes efficiency and a seamless experience for connected Clients 1200. The SQL ClientOnly Thread 405 will then go back to (3) to continue the same process all over for the next batch of IsClientOnly 3106 Object Property 3100 instance Value 3104 changes.

### Organization and Login Routing:

As said previously, applications, users, and workspaces all have their respective organizations that they belong under. An ‘Organization’ is a type of Object 3000 instance that stems from a Class 2000 instance of “Organization”. These Organization Object 3000 instances represent the distinct companies that are registered as customers. Organizations are fundamental in ensuring containment of workspaces, users, and applications within the specific organization itself and preventing any unwarranted cross contamination of data between itself and other organizations. This distinction creates a self-sufficient environment for an organization and its users. A breakdown of the organization hierarchy and the routing mechanism it provides can be seen in FIG. 9, discussed below.

FIG. 9, diagram A, illustrates the highest-level object tree hierarchy and the various children Object 3000 instances within it. The very top-level “Main” Sandbox Object 9700 is the root level Object 3000 instance, there are no other parent Object 3000 instances above it in the hierarchy. Under 9700, there is a 9740 Object 3000 instance that is of Class 2000 instance “Organizations”. The core purpose of this 9740 Organizations Object is to act as a container object for holding all the Organization Object 3000 instances (which are of Class 2000 instance “Organization”) below it. Notice the first child of the Organization 9800 Object 3000 instance is a “Main” 9810 Sandbox Object 3000 instance. This is true for all Organization Object 3000 instances. Since this first child of an organization is always a Sandbox, the associated functionality discussed earlier of Sandbox containment, scoping, and securities is once more utilized here to contain all the children Object 3000 instances (including any scripts and Object Property 3100 instances), preventing any child from reaching above past this “Main” 9810 Sandbox. This promotes the self-sufficient, independent environments that Organization Object 3000 instances represent.

Expanding further down the tree from FIG. 9 diagram A, some of the Children Object 3000 instances that are a part of every Organization Object 3000 instance are displayed: Users 9840 and Sandboxes 9960. Users 9840 Object 3000 instance encapsulates all the Object 3000 instances of Class 2000 instance “User”. User Object 3000 instances represent all the distinct users that are a part of a given Organization, like an employee or a customer or a contact of said Organization, every connected Web Client 1200 belongs to a respective User Object 3000 instance, which gives them controlled access to their respective said Organizations they belong to. Each User Object 3000 instance in turn has a “Routers” 9890 Object 3000 instance of Class 2000 instance “Routers”. A “Routers” Object can contain a set of Object 3000 instances of Class 2000 instance “Router”. Router Class 2000 instance type Object 3000 instances are used within Server 100 to navigate Clients 1200 to their respective workspaces. This is the business logic, characteristic behavior defined within the “Router” Class 2000 instance type. Workspaces are essentially Sandbox Object 3000 instances that have Router Object 3000 instances pointing to them in order to provide the functionality that allows for Clients 1200 to log into a Sandbox Object 3000 and utilize it as a workspace. These workspaces are usually located under the “Sandboxes” 9960 Object 3000 instance.

The described Object 3000 tree hierarchy, the business logic embedded within the “Organization”, “User”, “Router”, and “Sandbox” Class 2000 instances and their respective Object 3000 relationships, provide the core, fundamental functionality of how Server 100 navigates any Web Client 1200 to their associated workspace whenever the Web Client 1200 is requesting to login. For example, when a Web Client 1200 is attempting to login, they would first enter their username (i.e., “Ben”), password, and router name (i.e., “ToBensWorkspace”) to login with (Note the organization name will be automatically pulled from the domain URL, such as “myaccount.appward.com/Appward” so Web Clients 1200 would not need to specify that). FIG. 9, diagram A breaks down the process that occurs within Server 100 whenever such login requests are received as follows: Server 100 would first look for a “User” Object 3000 matching the username specified by Web Client 1200 within the associated Organization. This is represented by step (1) in FIG. 9 diagram A. After the User Object 3000 instance 9870 “Ben” is found, in step (2) Server 100 will look for any associated Router Object 3000 instances matching the router name that Web Client 1200 specified, in this case it would find Router 9910 Object name “ToBensWorkspace”. Next in step (3), in order to analyze what workspace needs to be logged into, the Router Object's “RouteToPath” 9910p3 Object Property 3100 Value 3104 will be used. This Value 3104 is used as a Source 4400 to indicate the Path 4000 of the Sandbox Object 3000 instance to log into. From Step (4), this would be the Sandbox Object 3000 instance 9970 named “ben”.

Again, all the logic that Server 100 executes are part of the embedded business logic of said Class 2000 instances “Organization”, “User”, “Router”, and “Sandbox”. Hence, after retrieving the target 4500 Sandbox Object 3000 instance 9970 through the “RouteToPath” Object Property 3100, the process continues onto FIG. 9, diagram B. In diagram B, step (5) will use a subsequent targeting via Paths 4000 to now identify the Screen Object 3000 instance that needs to be displayed for Client 1200 upon entry into Sandbox 9970. This utilizes the “EntryScreen” 9970p13 Object Property 3100 instance, whose Value 3104 is used as a Source 4400 to indicate, as illustrated by step (6), the Target 4500 Screen Object 3000 to display. In this case the Target 4500 is Screen Object 3000 instance 9990.

Routing to a Sandbox is how Web Clients 1200 are logged into their own workspaces or other workspaces of their choosing that they have been granted access to. Routers working together with sandboxes is crucial in providing the functionality of logging into any workspace, switching workspaces, and logging out of an existing Sandbox or workspace. This approach is granular as it allows for a User Object 3000 instance to have different Router Object 3000 instances set up, all pointing to different Sandbox Objects that they can access, leading to quick and easy access to each targeted workspace. Routers are also scalable, since Web Clients 1200 that are administrators can simply add another Router Object 3000 instance under an associated User Object 3000 instance and configure the “RouteToPath” Object 3100 Property in order to grant said user access to log into another workspace, based on the needs of the user and organization.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

### INDUSTRIAL APPLICABILITY

This invention may be industrially applied to the development, manufacture, and use of enterprise software for collaboration, productivity, and organization through a real time platform that may be readily customized with new software objects depending on the end user's needs and job function within an enterprise.

What is claimed is:

1. A computer program product comprising a non-transitory computer-readable medium having instructions tangibly embodied thereon that, when executed by a computer, perform operations for creating a custom object-oriented application program, the operations comprising:
delivering at least one object-oriented application program to a client, using a server, a database, and a network;
executing the object-oriented application program, using the server;
in response to user input, transferring at least one software object from the client to the server, using a persistent bi-directional network communications link between the client and the server; and
dynamically modifying the executing object-oriented application program into the custom object-oriented application program by instantiating the at least one transferred software object into a run time memory of the server in substantially real time.

2. The computer program product of claim 1, wherein the delivered object-oriented application program comprises at least one previously modified software object.

3. The computer program product of claim 2, wherein the delivered object-oriented application program entirely comprises previously modified software objects.

4. The computer program product of claim 1, wherein the network comprises at least one of the internet and a local network.

5. The computer program product of claim 1, wherein the operations further comprise rendering results of the executing operation using a browser on the client.

6. The computer program product of claim 1, wherein the persistent bi-directional network communications link comprises a WebSocket communication channel.

7. The computer program product of claim 6, wherein the operations further comprise simultaneously operating an HTTPS communication channel with a WebSocket communication channel.

8. The computer program product of claim 1, wherein the server further comprises:
a web server component that creates, stores, maintains, modifies, and delivers a structured hierarchy of the at least one software object;
a customizable class component that defines class properties, methods, and events of the at least one software object;
an object-identification and data binding component that identifies software objects with absolute and relative path translations to platform objects;
a containment component that groups structured children objects within sandbox objects;
a linking component that points to the sandbox objects as linked references;
a scripting engine component with parallel-processed business logic, interconnected with the object-identification and data binding component, that manipulates and interacts with the at least one software object;
a multi-threaded processing component with configurable tasker objects that performs time-interval and sequenced execution of the methods of the at least one software object; and
a routing component with router object components that directs a user to a user-area sandbox.

9. The computer program product of claim 8, wherein the client further comprises:
a communication component that performs bi-directional transfer of the at least one software object between the server and the client for dynamic rendering in a browser;
a rendering component that dynamically renders and re-renders a persistent web page; and
a configuration editor component interconnected with the persistent web page that performs on-the-fly creation and modification of the at least one software object, a structured hierarchy, contents and features of the persistent web page, and the scripting engine component.

10. The computer program product of claim 1, wherein the database further comprises an object storage and retrieval component that loads class definitions and the at least one software object.

11. A method for creating a custom object-oriented application program, comprising:
delivering at least one object-oriented application program to a client, using a server, a database, and a network;
executing the object-oriented application program, using the server;
in response to user input, transferring at least one software object from the client to the server, using a persistent bi-directional network communications link between the client and the server; and
dynamically modifying the executing object-oriented application program into the custom object-oriented application program by instantiating the at least one transferred software object into a run time memory of the server in substantially real time.

12. The method of claim 11, further comprising rendering results of the executing using a browser on the client.

13. The method of claim 11, wherein the persistent bi-directional network communications link comprises a WebSocket communication channel.

14. The method of claim 13, further comprising simultaneously operating an HTTPS communication channel with the WebSocket communication channel.

15. A system for creating a custom object-oriented application program, comprising:
a client;
a server;
a database;
a network;
a persistent bi-directional network communications link between the client and the server;
at least one object-oriented application program; and
at least one software object;
wherein the server, the database, and the network deliver the object-oriented application program to the client;
wherein the server executes the object-oriented application program;
wherein, in response to user input, the network communications link transfers the at least one software object from the client to the server; and
wherein the server instantiates the transferred software object into a run time memory of the server in substantially real time, to dynamically modify the executing object-oriented application program into the custom object-oriented application program.

16. The system of claim 15, wherein the delivered object-oriented application program comprises at least one previously modified software object.

17. The system of claim 15, wherein the delivered object-oriented application program entirely comprises previously modified software objects.

18. The system of claim 15, wherein the network comprises at least one of the internet and a local network.

19. A system for dynamic, real-time creation of custom web applications, comprising:
a server interconnected with a client and a database, wherein the server comprises:
a web server for creation, storage, maintenance, and delivery of a structured hierarchy of at least one software object;
a customizable class component for definition of class properties, methods, and events of the at least one software object;
an object-identification and data binding component for identification of objects with absolute and relative path translations to platform objects;
a containment component for grouping of structured children objects within a sandbox object;
a linking component for copying of the sandbox objects as linked references;
a scripting engine with parallel-processed business logic interconnected with the object-identification and data binding component for manipulation and interaction with the software object properties;
a multi-threaded processing component with configurable tasker objects for performance of time-interval and sequenced execution of the methods of the at least one software object; and
a routing component with router objects for direction to a user-area sandbox; and
wherein the client comprises:
a communication component for bi-directional transfer of the at least one software object between the web server and a client browser for dynamic rendering;
a rendering component for dynamic rendering and re-rendering of a persistent web page; and
a configuration editor interconnected with the persistent web page for performance of on-the-fly creation and modification of the at least one software object, the structured hierarchy, contents and features of the persistent web page, and the scripting engine; and
wherein the database comprises an object storage and retrieval component for loading of class definitions and the at least one software object.

20. A method for dynamic, real-time creation of custom web applications, comprising:
interconnecting a server with a client and a database, wherein the server:
creates, stores, maintains, and delivers a structured hierarchy of at least one software object, using a web server;
defines class properties, methods, and events of the at least one software object, using a customizable class component;
identifies objects with absolute and relative path translations to platform objects, using an object-identification and data binding component;
groups structured children objects within a sandbox object, using a containment component;
copies the sandbox objects as linked references, using a linking component;
manipulates and interacts with the software object properties, using a scripting engine with parallel-processed business logic interconnected with the object-identification and data binding component;
performs time-interval and sequenced execution of the methods of the at least one software object, using a multi-threaded processing component with configurable tasker objects; and
directs router objects to a user-area sandbox, using a routing component; and
wherein the client:
bi-directionally transfers the at least one software object between the web server and a client browser for dynamic rendering, using a communication component;
dynamically renders and re-renders a persistent web page, using a rendering component; and
performs on-the-fly creation and modification of the at least one software object, the structured hierarchy, contents and features of the persistent web page, and the scripting engine, using a configuration editor interconnected with the persistent web page; and
wherein the database loads the class definitions and the at least one software object, using an object storage and retrieval component.
